(19) United States
(12) Patent Application Publication
(10) Pub. No.: US 2025/0352902 A1
(43) Pub. Date: Nov. 20, 2025

(54) DISPLAY APPARATUS AND CONTROL METHOD

(71) Applicant: VIDAA (NETHERLANDS) INTERNATIONAL HOLDINGS B.V., Duiven (NL)

(72) Inventors: Huazhu MA, Qingdao (CN); Baiping LI, Qingdao (CN); Luming ZENG, Qingdao (CN); Chang LOU, Qingdao (CN)

(21) Appl. No.: 19/288,081

(22) Filed: Aug. 1, 2025

Related U.S. Application Data
(63) Continuation of application No. PCT/EP2024/081207, filed on Nov. 5, 2024.

(30) Foreign Application Priority Data
Nov. 7, 2023 (CN) 202311473668.3
Dec. 26, 2023 (CN) 202311810099.7
Feb. 26, 2024 (CN) 202410208430.6

(51) Int. Cl. A63F 13/537; A63F 13/40; G06F 3/023

(52) U.S. Cl. CPC A63F 13/537; A63F 13/40; G06F 3/0236

(57) ABSTRACT

The present disclosure provides a display apparatus and a control method. In the method, the focus interface is obtained in response to the text input command, and the first click event is listened if the focus interface is the application interface, where the first click event is used to switch the focus interface to the text input interface, and the first click time is generated by the focus switching key of the external device. Based on the first click event, the second click event generated by the non-focus switching key and sent from the external device is obtained, and the text data is generated and displayed based on the second click event.

### CROSS-REFERENCE TO RELATED APPLICATIONS

The present disclosure is a continuation application of PCT/EP2024/081207 filed on Nov. 5, 2024, which claims priorities to Chinese patent applications No. 202311473668.3 filed on Nov. 7, 2023, No. 202311810099.7 filed on Dec. 26, 2023, No. 202410208430.6 filed on Feb. 26, 2024, the entire contents of which are incorporated herein by reference.

### TECHNICAL FIELD

The present disclosure relates to the technical field of display apparatuses, and in particular to a display apparatus and a control method.

### BACKGROUND

The large screen display of the display apparatus provides the user with a more exquisite visual experience, and the user can watch the video and play the game through the display apparatus. When the user plays the game, in order to improve the convenience of game operation, the game can be played through external devices, such as gamepad, keyboard, etc., so as to facilitate the user's handheld operation.

When the user needs to input text in the game scene, a soft keyboard will pop up in the display apparatus, and the user can switch the focus of the game scene to the soft keyboard via a remote control to complete the input of text. However, since there is no key pressing restriction on the external device, the external device can still control the switching of the focus between the game scene and the soft keyboard, some users are prone to mistakenly switch the focus on the soft keyboard to the game scene via the external device, resulting in the focus being switched before the user completes the input of text, which affects the efficiency of the user's text input in the game scene.

### SUMMARY

Embodiments of the present disclosure can provide a display apparatus, including: a display, configured to display an image from broadcast system or network and/or a user interface, where the user interface can include an application interface and a text input interface; a device interface, configured to be connected with an external device, where the external device can include a first key which is configured to be able to switch a focus on the display and a second key which is configured to be not able to switch the focus on the display; and at least one processor, in connection with the display and the device interface and configured to execute computer instructions to cause the display apparatus to perform: in response to a text input command, obtaining a focus interface, where the focus interface is a user interface on which a focus is currently located; based on that the focus interface is the application interface, listening to a first click event, where the first click event can be used to switch the focus interface to the text input interface, and the first click event can be generated by the first key of the external device; obtaining a second click event from the external device based on the first click event, where the second click event can be generated by the second key; generating text data based on the second click event; and controlling the display to show the text data on the application interface.

Embodiments of the present disclosure can provide a control method for a display apparatus, including: in response to a text input command, obtaining a focus interface, where the focus interface can be a user interface on which a focus is currently located, where the user interface can be shown on a display of a display apparatus, and the user interface can include an application interface and a text input interface; based on that the focus interface is the application interface, listening to a first click event, where the first click event can be used to switch the focus interface to the text input interface, the first click event can be generated by a first key of an external device, the external device can be connected with a device interface of the display apparatus, and the external device comprises a first key which is configured to be able to switch a focus on the display and a second key which is configured to be not able to switch the focus on the display; obtaining a second click event sent from the external device based on the first click event, where the second click event can be generated by a second key; generating text data based on the second click event; and controlling the display to show the text data on the application interface.

### BRIEF DESCRIPTION OF FIGURES

FIG. 1 is a schematic diagram of a use scenario of a display apparatus according to some embodiments of the present disclosure.

FIG. 2 is a schematic diagram of a hardware configuration of a display apparatus according to some embodiments of the present disclosure.

FIG. 3 is a block diagram of a hardware configuration of a control device according to some embodiments of the present disclosure.

FIG. 4 is a schematic diagram of a software configuration of a display apparatus according to some embodiments of the present disclosure.

FIG. 5 is a schematic diagram of a connection state of a display apparatus with an external device according to some embodiments of the present disclosure.

FIG. 6 is a schematic diagram of a method flow of displaying an application interface in a display apparatus according to some embodiments of the present disclosure.

FIG. 7 is a schematic diagram of a flow of generating a listening command in a display apparatus according to some embodiments of the present disclosure.

FIG. 8 is a schematic diagram of a flow of performing click data classification in a display apparatus according to some embodiments of the present disclosure.

FIG. 9 is a schematic diagram of a key control of an external device and a scene change of an application interface according to some embodiments of the present disclosure.

FIG. 10 is a flowchart of calculating a frame duration difference based on a frame duration threshold according to some embodiments of the present disclosure.

FIG. 11 is a flowchart of a change of page refresh rate when a running memory changes according to some embodiments of the present disclosure.

FIG. 12 is a schematic diagram of a time duration distribution of displaying a frame of a target application interface according to some embodiments of the present disclosure.

FIG. 13 is a schematic diagram of performing a page refresh during displaying a target application interface according to some embodiments of the present disclosure.

FIG. 14 is a schematic diagram of a flow of reading and writing click data in a display apparatus according to some embodiments of the present disclosure.

FIG. 15 is a flowchart of listening when newly adding an external device according to some embodiments of the present disclosure.

FIG. 16 is a flowchart of listening when removing an external device according to some embodiments of the present disclosure.

FIG. 17 is a flowchart of performing a focus interface switching in a display apparatus according to some embodiments of the present disclosure.

FIG. 18 is a schematic diagram of a display position of a text input interface within an application interface according to some embodiments of the present disclosure.

FIG. 19 is a schematic diagram of a flow of switching a focus interface based on a focus switching key according to some embodiments of the present disclosure.

FIG. 20 is a schematic diagram of generating a second click event according to some embodiments of the present disclosure.

FIG. 21 is a schematic diagram of a text input interface according to some embodiments of the present disclosure.

FIG. 22 is a flowchart of generating text data based on a number of clicks and an order of clicks according to some embodiments of the present disclosure.

FIG. 23 is a schematic diagram of focus switching after completing text input according to some embodiments of the present disclosure.

FIG. 24 is a flowchart of switching conversion logic based on a display state of a pop-up window according to some embodiments of the present disclosure.

FIG. 25 is a schematic diagram of a system architecture for responding to control of a gamepad according to some embodiments of the present disclosure.

FIG. 26 is a flowchart for responding to control of a game device by a display apparatus according to some embodiments of the present disclosure.

FIG. 27 is a flowchart for responding to control of a gamepad by a display apparatus when running a webpage game according to some embodiments of the present disclosure.

FIG. 28 is a flowchart for responding to control of a gamepad by a display apparatus when running a third-party game application according to some embodiments of the present disclosure.

FIG. 29 is a flowchart for responding to control of a game device by a display apparatus according to some embodiments of the present disclosure.

FIG. 30 is a flowchart for responding to control of a gamepad by a display apparatus when running a webpage game according to some embodiments of the present disclosure.

FIG. 31 is a flowchart for responding to control of a gamepad by a display apparatus when running a third-party game application according to some embodiments of the present disclosure.

FIG. 32 is a flowchart of a display apparatus converting control information via a system service according to some embodiments of the present disclosure.

FIG. 33 is a schematic diagram of a preset coordinate system according to some embodiments of the present disclosure.

FIG. 34 is a flowchart of a display apparatus determining a state key value of a first arrow key by a system service according to some embodiments of the present disclosure.

FIG. 35 is a schematic diagram of a preset coordinate system according to some embodiments of the present disclosure.

FIG. 36 is a flowchart of determining whether a first region corresponds to a second region by a system service in a display apparatus according to some embodiments of the present disclosure.

FIG. 37 is a schematic diagram of a preset coordinate system according to some embodiments of the present disclosure.

FIG. 38 is a schematic diagram of a preset coordinate system according to some embodiments of the present disclosure.

FIG. 39 is a flowchart of responding via a system service to control information based on a key input from a gamepad according to some embodiments of the present disclosure.

FIG. 40 is a flowchart of customizing a function of a ordinary key in a gamepad according to some embodiments of the present disclosure.

FIG. 41 is an interaction diagram of customizing a function of a ordinary key in a gamepad according to some embodiments of the present disclosure.

FIG. 42 is a schematic diagram of a software system of a television according to some embodiments of the present disclosure.

FIG. 43 is a schematic diagram of a display method according to some embodiments of the present disclosure.

FIG. 44 is a schematic diagram of another display method according to some embodiments of the present disclosure.

FIG. 45 is a schematic diagram of a first coordinate system according to some embodiments of the present disclosure.

FIG. 46 is a schematic diagram of yet another display method according to some embodiments of the present disclosure.

FIG. 47 is a schematic diagram of yet another first coordinate system according to some embodiments of the present disclosure.

FIG. 48 is a schematic diagram of a plurality of gamepads sending trigger commands according to some embodiments of the present disclosure.

FIG. 49 is a schematic diagram of yet another display method according to some embodiments of the present disclosure.

FIG. 50 is a schematic diagram of yet another first coordinate system according to some embodiments of the present disclosure.

FIG. 51 is a schematic diagram of yet another display method according to some embodiments of the present disclosure.

FIG. 52 is a schematic diagram of yet another display method according to some embodiments of the present disclosure.

### DETAILED DESCRIPTION

In order to make the purpose and embodiments of the present disclosure clearer, the exemplary embodiments of the present disclosure will be described clearly and completely in the following in combination with the accompanying drawings in the exemplary embodiments of the present disclosure, and it is clear that the exemplary embodiments described are only a portion of the embodiments of the present disclosure, and not all of the embodiments.

It should be noted that the brief descriptions of terms in the present disclosure are intended only to facilitate the understanding of the embodiments described next, and are not intended to limit the embodiments of the present disclosure. Unless otherwise indicated, these terms should be understood in their ordinary and usual meaning.

The terms “first”, “second”, “third”, etc., in the specification and claims of the present disclosure and in the drawings are used to distinguish similar or like objects or entities, and do not necessarily imply a particular order or sequence unless otherwise indicated. It should be understood that the terms so used are interchangeable in appropriate cases.

The terms “including” and “having”, and any variations thereof, are intended to cover, but are not exclusive of, inclusion, e.g., a product or device that includes a range of components need not be limited to all of the components that are clearly listed but can include other components that are not clearly listed or that are inherent to those products or devices.

The terminal devices according to embodiments of the present disclosure can have a variety of implementation forms, e.g., can be a television, a laser projection device, a monitor, an electronic bulletin board, an electronic table, and the like.

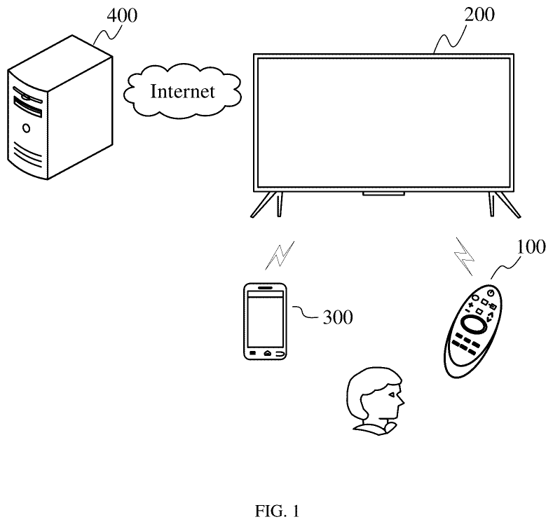

FIG. 1 is a schematic diagram of an operation scene of a terminal device and a control device according to some embodiments of the present disclosure. As shown in FIG. 1, a user can operate the display apparatus 200 via the terminal device 300 or the control device 100.

In some embodiments, the control device 100 can be a remote control. The communication between the remote control and the display apparatus 200 can include infrared protocol communication or Bluetooth protocol communication, and other short-range communication manners to control the display apparatus 200 by wireless or wired manners. The user can control the display apparatus 200 by inputting user commands via keys, voice input, control panel input, and the like of the remote control.

In some embodiments, a terminal device 300 (e.g., a cell phone, a tablet, a computer, a laptop, etc.) can also be used to control the display apparatus 200. For example, an application running on the terminal device 300 can be used to control the display apparatus 200.

In some embodiments, instead of receiving commands using the terminal device 300 or the control device 100 described above, the display apparatus 200 can receive control from the user via touch or gestures, etc.

In some embodiments, the display apparatus 200 can also be controlled by means other than the control device 100 and the terminal device 300. For example, the user's voice command control can be received directly by a module configured inside the display apparatus 200 for obtaining voice commands, or the user's voice command control can be received by a voice terminal device provided outside the display apparatus 200.

In some embodiments, the display apparatus 200 can be also in data communication with the server 400. The display apparatus 200 can be allowed to connect for communication over a local area network (LAN), a wireless local area network (WLAN), and other networks. The server 400 can can provide various contents and interactions to the display apparatus 200. The server 400 can be a cluster or multiple clusters and can include one or more classes of servers.

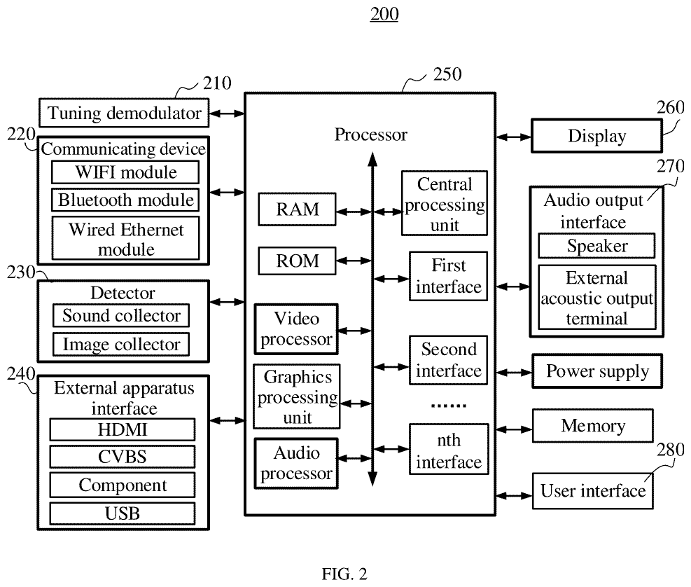

As shown in FIG. 2, the display apparatus 200 can include at least one of a tuning demodulator 210, a communicating device 220, a detector 230, a device interface 240, at least one processor 250, a display 260, an audio output interface 270, a memory, a power supply, or a user interface.

In some embodiments, the at least one processor 250 can include a video processor, an audio processor, a graphics processor, a random access memory (RAM), a read only memory (ROM), a first interface to an nth interface for input/output, and the like.

The display 260 can include the following components: a display component for displaying a picture; a driver component for driving image display; a component for receiving an image signal output from the at least one processor 250 for displaying video content, image content, and a menu manipulation interface, a component for a user operating a user interface (UI), and the like.

The display 260 can be a liquid crystal display, an organic light-emitting display (OLED), and a projection display, and can also be a projection device and a projection screen.

The communicating device 220 is a component for communicating with an external device or server 400 according to various communication protocol types. For example, the communicating device can include at least one of a Wifi module, a Bluetooth module, a wired Ethernet module and other network communication protocol chips or near field communication protocol chips, or an infrared receiver. The display apparatus 200 can establish sending and receiving of control signals and data signals with the control device 100 or the server 400 via the communicating device 220.

A user interface that can be used to receive control signals from the control device 100 (e.g., an infrared remote control, etc.).

The detector 230 can be used to acquire signals from the external environment or from interaction with the outside. For example, the detector 230 can include a light receiver that is a sensor for collecting the intensity of ambient light. Alternatively, the detector 230 can include an image collector, such as a camera, which can be used to collect an external environmental scene, an attribute of the user, or a gesture of the user interaction. Alternatively, the detector 230 can include a sound collector, such as a microphone, etc., which can be used to receive an external sound or a voice command from the user.

The external device interface 240 can include, but is not limited to, any one or more of the following: a high-definition multimedia interface (HDMI), an analog or data high-definition component input interface (component), a composite video blanking and synchronization (CVBS) input interface, a universal serial bus (USB) input interface, an RGB port, or the like. It can also be a composite input/output interface formed by the plurality of interfaces described above.

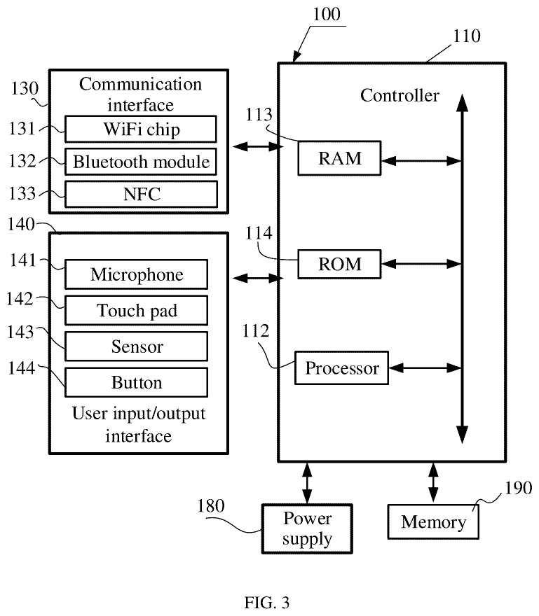

FIG. 3 is a block diagram of a hardware configuration of the control device of FIG. 1 according to some embodiments of the present disclosure. As shown in FIG. 3, the control device 100 can include at least one processor 110, a communication interface 130, a user input/output interface, a memory, and a power supply.

The control device 100 can be configured to control the display apparatus 200, as well as to receive input operation commands from the user, and to convert the operation commands into commands that the display apparatus 200 can recognize and respond to, acting as an interaction intermediary between the user and the display apparatus 200.

In some embodiments, the control device 100 can be an intelligent device. For example, the control device 100 can be installed with various applications to control the display apparatus 200 according to user requirements.

In some embodiments, as shown in FIG. 1, a mobile terminal 300 or other intelligent electronic devices, which can be installed with applications for manipulating the display apparatus 200, can serve a similar function of the control device 100.

The at least one processor 110 can include a first processor 112, RAM 113, ROM 114, a communication interface 130, and a communication bus. The at least one processor 110 can be used to control the operation and manipulation of the control device 100, as well as communication collaboration between internal components and external and internal data processing functions.

The communication interface 130, under the control of the at least one processor 110, enables to communicate control signals and data signals with the display apparatus 200. The communication interface 130 can include at least one of a WiFi chip 131, a Bluetooth module 132, a near field communication (NFC) module 133, or other near-field communication modules.

For the user input/output interface 140, the input interface can include at least one of a microphone 141, a touchpad 142, a sensor 143 a key 144, or other input interfaces.

In some embodiments, the control device 100 can include at least one of the communication interface 130 or the input/output interface 140. The control device 100 can be configured with a communication interface 130, e.g., a module such as WiFi, Bluetooth, NFC, etc., to send user input commands, encoded via a WiFi protocol, or a Bluetooth protocol, or an NFC protocol, to the display apparatus 200.

The memory 190 can be configured for storing various operating programs, data, and applications that drive and control the control device 100 under the control of the at least one processor. The memory 190, can store various types of control signal commands input by the user.

The power supply 180 can be configured for providing operational power support for various components of the control device 100 under the control of the at least one processor.

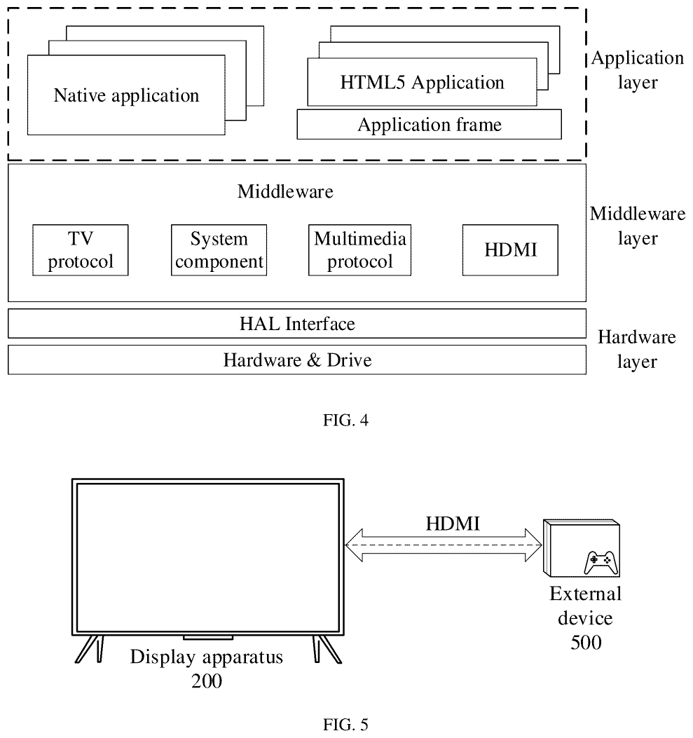

FIG. 4 is a schematic diagram of the software configuration of the display apparatus in FIG. 1 according to some embodiments of the present disclosure. In some embodiments, the system of the display apparatus 200 can be divided into three layers, from top to bottom being an application layer, a middleware layer, and a hardware layer.

The application layer can mainly contain commonly used applications on the television, and an application framework, where the commonly used applications can be mainly applications developed based on a browser, e.g., HTML5 APPs, and native applications (Native APPs).

The application framework can be a complete program model, with all the basic functions required by standard application software, such as: file access, data exchange, etc., as well as the use interface (toolbars, status bar, menus, dialog boxes) of these functions.

The native applications (Native APPs) can support online or offline, message push or local resource access.

The middleware layer can include middleware such as various television protocols, multimedia protocols, and system components. The middleware can use the basic services (functions) provided by the system software to connect various parts or different applications of the application system on the network, which can achieve the purpose of resource sharing and function sharing.

The hardware layer can mainly include a hardware abstraction layer (HAL) interface, hardware and driver. The HAL interface is a unified interface for connecting all television chips, and the specific logic is realized by each chip. The driver can mainly include: audio driver, display driver, Bluetooth driver, camera driver, WIFI driver, USB driver, HDMI driver, sensor driver (such as fingerprint sensor, temperature sensor, pressure sensor, etc.), and power driver.

According to some embodiments of the present disclosure, the display apparatus 200 connected with the external device 500 can mean establishing a communication connection, and the display apparatus 200 and the external device 500 establishing the communication connection can serve as a receiving end (Sink end) and a sending end (source end), respectively. The external device can be a hardware device connected with the display apparatus 200. A plurality of interfaces with different functions can be set up in the device interface 240 according to the functions, and the external device can be connected with the display apparatus 200 through the interface to realize various functions, such as inputting text, images, audio, video, and the like, displaying images, text, and the like, printing files, pictures, and the like, storing data, files, and the like, as well as realizing remote communication, information sharing, and the like through a network connection.

For example, the external device 500 can be a game device, which is capable of outputting video data and audio data in real time for the gaming process during the user's use of the game device, and sending the video data and audio data to the display apparatus 200 in order to output the video data and audio data as a video picture and sound through the display apparatus 200. In this way, the game device can serve as the sending end, and the display apparatus 200 can serve as the receiving end.

Between the sending end and the receiving end, a communication connection can be realized through a specific interface so as to transfer data. For this purpose, data interfaces of the same interface specification and function should be provided on both the sending end and the receiving end. For example, as shown in FIG. 5, high definition multimedia interfaces (HDMI) can be provided on both the display apparatus 200 and the external device 500. In the use scenario, the user can plug the two ends of the HDMI interface data cable into the display apparatus 200 and the external device 500 respectively, and after starting the external device 500 and the display apparatus 200, set the signal source of the display apparatus 200 to be the HDMI interface, so as to realize the data transmission between the display apparatus 200 and the external device 500.

It should be noted that in order to realize the communication connection between the display apparatus 200 and the external device 500, other connection manners can be used between the display apparatus 200 and the external device 500. The specific connection manner can be a wired connection manner, such as digital visual interface (DVI), video graphics array (VGA), universal serial bus (USB), etc.; or it can be a wireless connection manner, such as a wireless local area network (WLAN), a Bluetooth connection, an infrared connection, and so on. Different communication connection manners can use different information transfer protocols. For example, when the connection is realized using the HDMI interface, the HDMI protocol can be used for data transmission.

The display apparatus 200 can have a larger display screen compared to the computer device and the terminal device, and the user can run an application through the display apparatus 200 to use the corresponding application function in the large screen to obtain better visual effects. For example, the user can watch videos, play games, and the like through the display apparatus 200.

When the display apparatus 200 is in the startup state, the display 260 can present a user interface, which is a medium interface for interaction and information exchange between the application or the operating system and the user, and which realizes the conversion between the internal form of information and the form acceptable to the user. A common presentation form of user interface is the graphic user interface (GUI), which is a user interface related to computer operations and displayed graphically. It can be an interface element such as an icon, a window, a control, etc. displayed in the display of the display apparatus, where the control can include an icons, a button, a menu, a tab, a text box, a dialog box, a status bar, a navigation bar, a widget, and other visual interface elements.

Application icons can be displayed on the user interface, and the application icons can be used to represent applications in the user interface, where different application icons corresponding to different applications. In some embodiments, there are different categories of applications, such as entertainment applications and functional applications, etc. The entertainment applications can include game applications, audio and video players, social platforms, short video platforms, etc., and the functional applications can include payment applications, electronic maps, cameras, video recorders, etc. The user can remotely click the application icon via the control device 100 to launch the corresponding application.

The control device 100 can start and run the corresponding application by controlling the focus in the display apparatus 200, and the user can control the position of the focus through the arrow keys on the control device 100 so that the focus is located at the application icon, thereby starting the corresponding application and using the application functions of the application in the application interface.

However, since the number of focuses can be only one, for some applications that require to frequently click keys, such as game applications, the user needs to move the focus in sequence by the control device 100 based on the order of the clicks and finish clicking the corresponding keys on the control device 100, which results in a large amount of time being wasted by the control device 100 during the movement of the focus, restricting the convenience of the control device 100.

To this end, the display apparatus 200 can also include the device interface 240, and the device interface 240 can include, but is not limited to, any one or more of the following: a high-definition multimedia interface (HDMI), an analog or data high-definition component input interface (component), a composite video input interface (CVBS), a USB input interface (USB), an RGB port, and the like. It can also be a composite input/output interface formed by more than one of the above interfaces.

The display apparatus 200 can be connected with the external device 500 via the device interface 240. In some embodiments, the external device 500 can also be a control device, and the control device can be used to send corresponding commands to the display apparatus 200 via corresponding control components such as keys, joysticks, and the like, instead of the control device 100, so as to perform functional operations within the application interface.

Depending on the functions realized, the external device 500 can be divided into an input device, an imaging device, an external storage device, and the like. The input device can include a gamepad, a keyboard, a mouse, a touch screen, a handwriting board, etc., and the input device can send operation commands to the display apparatus 200 through components such as keys, joysticks, or a touch screen, etc. The imaging device can include a video recorder, a projector, etc., and can play the media data specified by the display apparatus 200 through data transmission, and the external storage device can include a USB flash disk, a mobile hard disk drive, etc., and can transmit data to or obtain data from the display apparatus 200.

When the display apparatus 200 runs an application, the user can execute operations within the application interface through the external device 500. Taking a game scene as an example, the user can control the virtual characters as well as the virtual scene within the game through the gamepad. The structural design of the gamepad as well as the positional settings of the keys can be more closely adapted to the grip of the hand, so that the user does not have to repeatedly switch and move the focus in the game, thereby reducing the operation difficulty of the gamepad, and making the user's gaming process smoother.

However, for some of the display apparatuses 200, which only support a specific model of the external device 500, when the user plays the game through the other external device 500, the problem such as frame loss and lagging will occur due to incompatibility of versions or hardware configurations, etc., which will reduce the smoothness of the game process.

In order to solve the problem of frame loss caused by incompatible versions or hardware configurations, etc., of some of the external devices 500, a display apparatus 200 according to some embodiments of the present disclosure can include a device interface 240, at least one processor 250, and a display 260. The display 260 can be used to display a browser-based user interface, where the user interface can include a plurality of application icons since the user interface can include a plurality of application interfaces. The browser can be an application for displaying webpages, and the plurality of applications as described above can be included in the browser-based user interface. The display apparatus 200 can run the application selected in the user interface based on a user's selection command to display the application interface in the user interface.

The device interface 240 can be used to connect the external device 500, where the external device 500 can be used to send operation commands to the application interface. Thus, in some embodiments, the external device 500 shall be an input device, i.e., a hardware device such as a gamepad, a keyboard or a mouse. Taking the gamepad as an example, correspondingly, the user can send operation commands in the application interface of the game application via the gamepad. For ease of description, in some embodiments, the application interface of the game application is defined as a game interface. The game interface can include a virtual character and a virtual scene, where the game interface can be switched to a first-person perspective or a third-person perspective according to game types. In order to facilitate manipulating the virtual character and the virtual scene, a plurality of keys can be provided on the gamepad, and when the user clicks the keys, the external device 500 can generate click data and send the click data to the display apparatus 200 to respond to an operation command corresponding to the click data.

The following first explains a data interaction process between the external device 500 and the display apparatus 200. In some embodiments, the application layer of the display apparatus 200 can include an input subsystem, which can manage the click data sent from all of the external devices 500 that are connected with the display apparatus 200 via the device interface 240, and drive, based on the click data, an application interface on the display apparatus 200.

The input subsystem can include a core layer (Input core), a device driver layer (Driver), and an event management layer (Event handler). The device driver layer can perform read/write access to the external devices 500 connected with the display apparatus 200, and interrupt a response through hardware to obtain a permission to get the uploaded data of the external devices 500. The user can manipulate the application interface displayed by the display 260 through the external device 500. When the user clicks a key on the external device 500 or uses a touch function on the external device 500, the external device 500 can generate corresponding click data according to the user's operation, and the device driver layer can obtain the click data by accessing the external device 500, or the external device 500 can also upload the click data to the device driver layer in real time when generating the click data.

After acquiring the click data, the device driver layer can upload the click data to the core layer, in which a plurality of general interfaces can be provided, and the core layer can provide common functions to the event management layer and the device driver layer through the general interfaces, thereby accomplishing registration and release between the device driver layer and the external device 500, as well as, accomplishing data transmission between the device driver layer and the event management layer, and transmitting the click data to the event management layer.

After obtaining the click data, the event management layer can process the input event corresponding to the click data and interact in the user space, thereby generating a new application interface based on the click data and replacing the original application interface based on the new application interface.

According to embodiments of the present disclosure, the at least one processor can be configured to execute computer instructions to cause the display apparatus to perform steps in the method according to embodiments of the present disclosure.

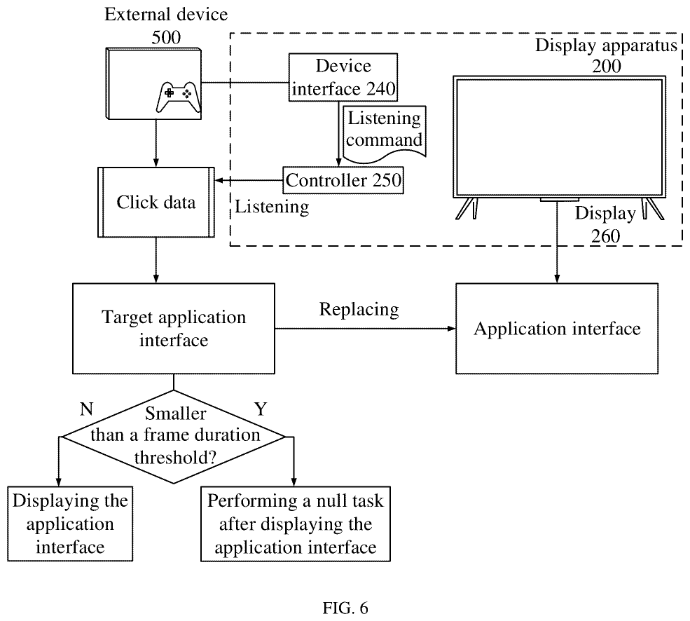

Based on the above data interaction process, the at least one processor 250 can be configured to execute a browser-based data displaying method for an external device. FIG. 6 is a schematic diagram of a browser-based data displaying method for an external device according to embodiments of the present disclosure. Referring to FIG. 6, the method can include the following steps.

S101: generating a listening command when the external device is connected with the device interface.

The at least one processor 250 can continuously monitor the device interface 240, and when the external device 500 is connected with the device interface 240. The external device 500 can send click data to the display apparatus 200 through the device interface 240, at which time the listening command can be generated to listen to the click data generated by the external device 500.

Since both the external device 500 and the control device 100 can send click data to the display apparatus 200, in order to alleviate duplication of click data or confusion of click data, when the external device 500 is connected with the device interface 240, the at least one processor 250 can control the display 260 to display a prompt pop-up window, which can generate two options based on the external device 500 and the control device 100. A user can select a primary device that sends a command to the display apparatus 200 based on the options in the prompt pop-up window. For example, when the external device 500 is the primary device, the at least one processor 250 can stop listening to the click data sent from the control device 100 in order to temporarily cancel the operation control for the display apparatus 200 by the control device 100.

Based on the above embodiments, after the external device 500 is disconnected from the device interface 240, the at least one processor 250 can generate a resume command to resume operation control for the display apparatus 200 by the control device 100 and continue to listen to the click data from the control device 100.

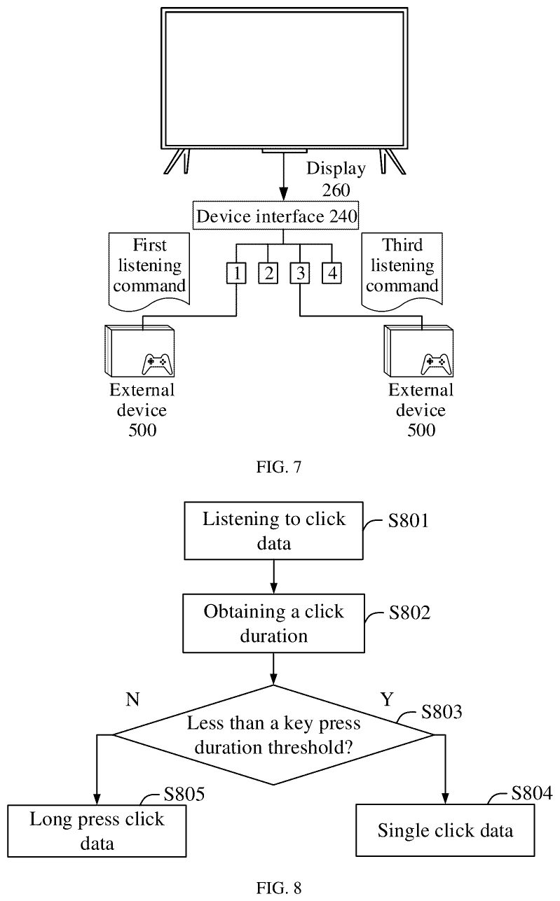

In some embodiments, the device interface 240 can include a plurality of sub-interfaces, each of which can be connected with the external device 500, and the device interface 240 can be connected with a plurality of external devices 500 meanwhile. Thus, the at least one processor 250 can generate a plurality of listening commands for the plurality of external devices 500 separately based on the number of sub-interfaces and the locations of the interfaces. For example, as shown in FIG. 7, the device interface 240 can include four sub-interfaces, respectively a first interface, a second interface, a third interface, and a fourth interface. When the first interface and the third interface are connected with the external device 500, the at least one processor 250 can generate a first listening command based on the first interface and a third listening command based on the third interface, improving the accuracy of listening to the external device 500.

Among the connected external devices 500, there can also be non-input devices, such as imaging devices, external storage devices, audio control devices, etc., and these non-input devices are unable to actively send click data to the display apparatus 200. Thus, the at least one processor 250 can detect the attributes of the external devices 500, and for the external device 500 with the attribute of the non-input device, there is no need to generate a listening command, reducing the power consumption of the display apparatus 200, and improving the operational efficiency of the display apparatus 200.

S201: based on the listening command, listening to the click data sent from the external device.

The at least one processor 250 can listen to the specified external device 500 based on the listening command. The external device 500 can generate a key operation event when a key is clicked, and generate corresponding click data based on the key operation event. The user can single-click the key and long-press the key, and thus, the at least one processor 250 can listen to the click data for the above two cases.

In order to distinguish between the single click data and the long press click data, as shown in FIG. 8, the at least one processor 250 can be configured to execute computer instructions to cause the display apparatus to perform the following steps. S801, listening to click data; S802, obtaining a click duration; S803, determining whether the click duration is less than a key press duration threshold; if so, the flow goes to step S804, otherwise, the flow goes to step S805; S804, determining that the click data is single click data; and S805, determining that the click data is long press click data. For example, the key press duration threshold is set, and the acquired key press duration of the click data is compared with the key press duration threshold. For example, when the key press duration is less than or equal to 500 ms, the at least one processor 250 can determine that the click data is single click data, and when the key press duration is greater than 500 ms, the at least one processor 250 can determine that the click data is long press click data. The at least one processor 250 can generate different interfaces based on different types of clicked keys.

S301: generating a target application interface based on the click data, and, replacing a currently displayed application interface based on the target application interface.

After obtaining the click data, the at least one processor 250 can generate a target application interface based on the click data, and the target application interface is an application interface that the at least one processor 250 can regenerate based on the application interface currently displayed by the display 260 and the click data. Taking a three-dimensional (3D) game interface as an example, a virtual character located in a virtual scene can be included in the game interface, and the user can control a moving direction of the virtual character within the virtual scene via an arrow key on a gamepad.

In some embodiments, the at least one processor 250 can obtain a conversion logic for a target application, the conversion logic being used to convert the keys on the gamepad to operation commands within the target application. For example, the gamepad can be provided with arrow keys such as “up”, “down”, “left”, and “right”, and the at least one processor 250 can convert the click data into action tasks to which the target application can respond based on the conversion logic, thereby realizing a change in the application interface through key press control.

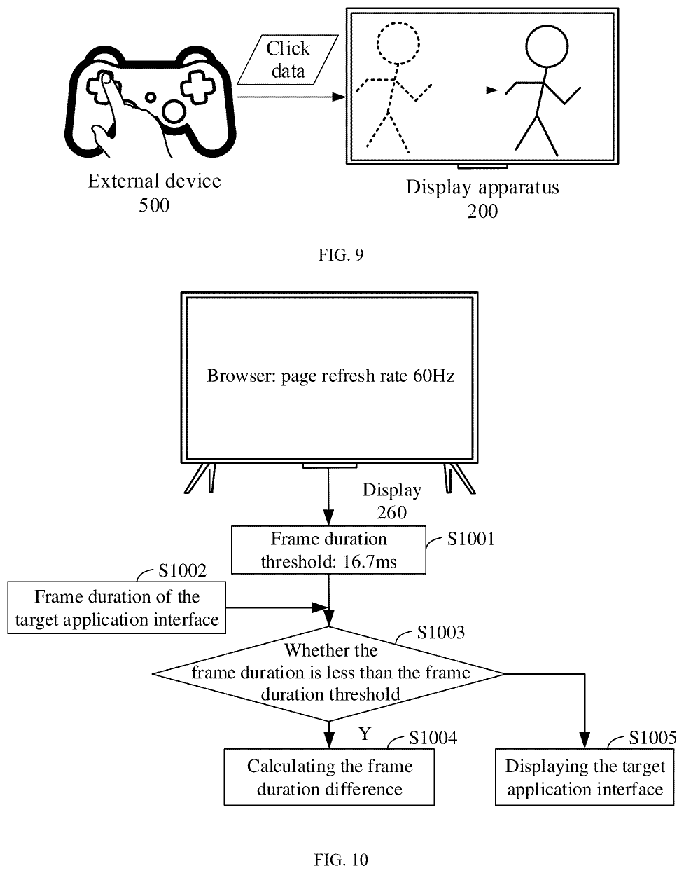

Exemplarily, referring to FIG. 9, when the user clicks the “up” key on the gamepad, the at least one processor 250 can receive the click data generated by the gamepad and generate, based on the click data, an action task that indicates the virtual character to move forward in the current direction. In response to the action task, the at least one processor 250 can obtain a current position of the virtual character in the game interface according to the currently displayed game interface, calculate a position of the virtual character after the movement according to the action task, and generate a target game interface according to the virtual character located at the position, and ultimately control the display 260 to show the target game interface, so as to complete the logical conversion of the click data.

The moving distance of the virtual character can be related to the length of the key press duration, and the longer the length of the key press duration is, the larger the moving distance of the virtual character is. In some embodiments, the at least one processor 250 can also obtain the key press duration of the click data, generate a moving distance of the virtual character based on the moving speed of the virtual character in the conversion logic, and obtain a current position of the virtual character and a changed virtual scene after the movement based on the moving distance, thereby generating the target application interface. The multi-frame continuous target application interface can display the virtual character with dynamic effects on a browser.

In order to render a more vivid game picture, the virtual character can include additional movement actions in the process of moving, such as swinging the arms and lifting the legs while running. The at least one processor 250 can synchronize the movement actions of the virtual character to be added to the target application interface when rendering the target application interface, so as to enhance the rendering effect of the virtual character while running, and to improve the interface picture accuracy.

S401: base on that a frame duration of the target application interface is less than a frame duration threshold, calculating a frame duration difference.

After generating the target application interface, the at least one processor 250 can control the display 260 to display multiple consecutive frames of the target application interfaces on the browser. In some embodiments, the at least one processor 250 can detecting the frame duration of the target application interface, where the frame duration is a displaying duration of the target application interface. In order to determine the frame loss and lagging problem of the browser, the at least one processor 250 can set a frame duration threshold, where the frame duration threshold is a single frame duration calculated based on a current page refresh rate of the browser.

It should be noted that the page refresh rate is a number of frames per second of the picture displayed by the display. For example, if the browser refreshes the application interface 60 times per second when the page refresh rate is 60 Hz, the length of a single refresh, i.e., the length of a single frame, is 16.7 ms.

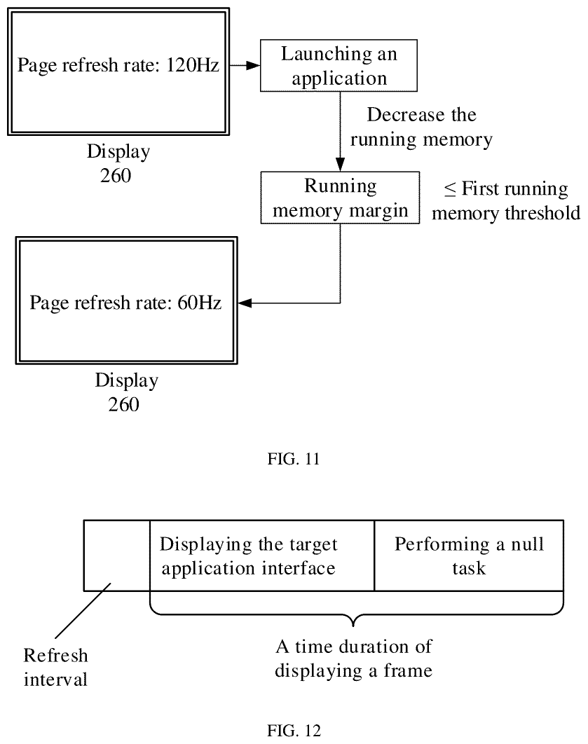

FIG. 10 is a flowchart of calculating the frame duration difference according to the embodiment of the present disclosure. Referring to FIG. 10, the method of calculating the frame duration difference can include the following steps. S1001, obtaining a frame duration threshold: 16.7 ms; S1002, obtaining a frame duration of the target application interface; S1003, determining whether the frame duration is less than the frame duration threshold; if so, the flow goes to S1004, otherwise, the flow goes to S1005; S1004, calculating the frame duration difference; S1005, displaying the target application interface. For example, when the frame duration is less than the frame duration threshold, after the display 260 completes displaying the target application interface based on the browser, there is a certain amount of time remaining in the frame, and the problem such as frame loss and lag can occur during the remaining time. The at least one processor 250 can calculate a frame duration difference based on the frame duration and the frame duration threshold, for example, when the frame duration of the target application interface is 5 ms, the frame duration difference is 16.7 ms−5 ms=11.7 ms.

In some embodiments, the at least one processor 250 can adaptively adjust the page refresh rate of the browser based on the running memory margin of the display apparatus 200. The display apparatus 200 can be provided with a fixed amount of running memory, the running memory being the application memories that can be running simultaneously meanwhile. The different applications can occupy different amounts of running memory while running.

In the event that the running memory is insufficient to support the current page refresh rate of the browser, the at least one processor 250 can reduce the page refresh rate based on the running memory margin to release some of the running memory for running the application. When the display apparatus 200 finishes running the application, the at least one processor 250 can clean up the running process of the application to release the running memory. When the running memory margin is sufficient to support a high page refresh rate, the at least one processor 250 can adaptively adjust the page refresh rate to adjust the picture stability of the application interface.

The running memory margin can be positively proportional to the page refresh rate of the browser, and the larger the running memory margin is, the higher the page refresh rate is. Therefore, the at least one processor 250 can determine the page refresh rate of the browser based on the running memory margin. For example, the page refresh rate can be set to 60 Hz, 120 Hz, and 240 Hz, and the higher the page refresh rate is, the larger the required running memory margin is.

To facilitate switching the page refresh rate of the browser, the at least one processor 250 can set at least two running memory thresholds. For ease of presentation, in embodiments of the present disclosure, the two running memory thresholds can be defined as a first running memory threshold and a second running memory threshold, where the first running memory threshold is smaller than the second running memory threshold.

When the running memory margin of the display apparatus 200 is less than or equal to the first running memory threshold, the at least one processor 250 can switch the page refresh rate of the browser to 60 Hz. When the running memory margin is greater than the first running memory threshold and less than or equal to the second running memory threshold, the at least one processor 250 can switch the page refresh rate of the browser to 120 Hz. When the running memory margin is greater than the second running memory threshold, the at least one processor 250 can switch the page refresh rate of the browser to 240 Hz.

FIG. 11 is a flowchart a change of the page refresh rate according to embodiments of the present disclosure. Referring to FIG. 11, the at least one processor 250 can automatically switch the page refresh rate of the browser when the running memory margin changes. For Example, when the page refresh rate of the browser is 120 Hz, the display apparatus 200 can launch a new application, and the running memory margin can decrease due to the running of the application. When the running memory margin is reduced to less than or equal to the first running memory threshold, the at least one processor 250 can automatically switch the page refresh rate of the browser from 120 Hz to 60 Hz, thereby adaptively adjusting the page refresh rate of the browser and improving the interface displaying stability.

It should be noted that the page refresh rate of the browser can be set according to the display precision and screen size of the display apparatus 200. For example, for a large-sized display apparatus 200, the maximum page refresh rate can be greater than 240 Hz, and for a small-sized display apparatus 200, the minimum page refresh rate can be 30 Hz. In the embodiments of the present disclosure, the page refresh rate set for the browser is not specifically limited.

S501: controlling the display to show the target application interface based on the browser, and, performing a null task based on the frame duration difference, the null task being a task to be executed during an idle time.

During presenting continuous target application interfaces on the display, the at least one processor 250 needs to repeatedly generate new target application interfaces based on click data and a callback function. The execution interval of the callback function can be the same as the frame duration threshold, i.e., the callback function can be executed once after each frame of the application interface is displayed, so as to obtain the click data again and generate a new application interface based on the click data.

FIG. 12 is a schematic diagram of a time duration distribution of displaying a frame of picture in the display apparatus according to some embodiments of the present disclosure. Referring to FIG. 12, when the frame duration is less than the frame duration threshold, the display 260 can first complete displaying the target application interface within the time duration of one frame, and in the remaining time of this frame, since there is no newly added display content, the at least one processor 250 can start executing the callback function according to the time at which the target application interface completes the displaying, which leads to the problem of losing frames, lagging, and so on and reduces the picture accuracy of the target application interface.

Thus, after obtaining the frame duration difference, the at least one processor 250 can control the display 260 to display the target application interface based on the browser, and if the frame duration of the target application interface is less than the frame duration threshold, a null task can be executed based on the frame duration difference after completing the displaying of the target application interface, the null task being a task executed during an idle time. The null task can alleviate the problem of frame loss and lagging caused by the execution of the callback function immediately after the displaying of the target application interface is completed, and improve the picture accuracy of the target application interface. Moreover, the callback function can alleviate the problem of not being able to respond to other displaying task with higher priority due to occupying the main process during the remaining time.

In some embodiments, the at least one processor 250 can set a refresh duration of the click data and set a refresh interval between two adjacent frames of the target application interfaces, the refresh duration being a time duration for obtaining the click data after generating the target application interface. After the at least one processor 250 controls the display 260 to display the target application interface, during the refresh interval, the at least one processor 250 can again acquire the click data uploaded by the external device 500 to generate the next frame of the target application interface based on the new click data.

In order to improve the displaying accuracy of the target application interface, when the frame duration difference is greater than the refresh duration, the at least one processor 250 can calculate a time duration multiple of the frame duration difference and the refresh duration. For example, when the frame duration difference is 11.7 ms and the refresh duration is 4 ms, the frame duration difference can contain 2 refresh durations, and the time duration multiple is 2.

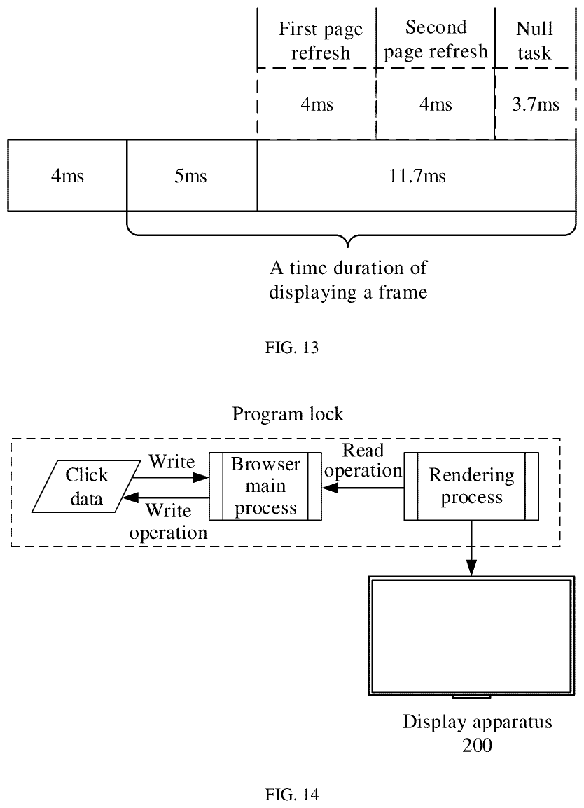

After obtaining the time duration multiple, the at least one processor 250 can, according to the refresh method shown in FIG. 13, control the browser to perform a page refresh for the target application interface based on the time duration multiple. In this process, within the refresh time duration, the at least one processor 250 can again obtain the click data corresponding to the application interface of the current frame, and perform a picture adjustment to the target application interface based on the click data to refresh the target application interface to improve the picture accuracy. As shown in FIG. 13, after completing the page refresh for the target application interface, 3.7 ms remains, and 3.7 ms is not sufficient to complete a refresh, so the at least one processor 250 can perform a null task in the remaining 3.7 ms.

In order to facilitate managing the click data uploaded by the external device 500, in some embodiments, the display apparatus 200 can further include an external device management module. The external device management module can establish a communication connection with an event processing layer, so as to obtain the click data uploaded by the event processing layer, and perform data transmission of the click data through a read/write operation process. The external device management module can include a browser main process and a rendering process, the browser main process can generate a write operation process, and the write operation process can be used to write the click data. The rendering process can generate a read operation process, and the read operation process can be used to read the click data.

After the external device management module obtains the click data, it is necessary to transmit the click data to a corresponding page of the browser and generate a target application interface on the page. In the above process, at least one processor 250 can transmit the data through the read-write operation process.

However, when performing the read/write operation on the click data via the read/write operation process, the read and write operation processes can access the click data meanwhile, resulting in data crossover and data overwriting of the click data during transmission, which leads to a chaotic transmission of the click data and a problem of disorganized data. For this reason, in some embodiments, the read operation process and the write operation process can be generated separately to perform the read operation and the write operation on the click data sequentially. FIG. 14 is a schematic diagram of a flow of performing the read and write operations in the display apparatus according to some embodiments of the present disclosure. Referring to FIG. 14, the browser main process can generate a write operation process to perform writing on the click data, so as to write the click data to the browser main process, and during the writing process, the write operation process can call the write function for writing.

After writing the click data to the browser main process, the at least one processor 250 can generate a read operation process through the rendering process to perform a read on the click data written to the browser main process to obtain the transmitted data. In the writing process, the read operation process can call the read function for writing. By executing the read and write operation processes separately, the running pressure on the central processing unit (CPU), memory, and network resources of the display apparatus 200 can be reduced, and the running performance of the display apparatus 200 can be improved.

After the browser acquires the transmitted data, in order to accurately realize the conversion between the keys and the display effects, the at least one processor 250 can, based on the conversion logic, convert the transmitted data into action tasks that the target application can respond to, e.g., the action tasks such as controlling the movement direction, attacking, defending, etc., of the virtual character in the virtual scene. The at least one processor 250 can, through the rendering process, render and generate the target application interface based on the current application interface and based on the action tasks obtained from the converting of the transmitted data. In some embodiments, the at least one processor 250 can also set a process order of the read operation process and the write operation process in the read/write operation process to cyclically perform the read operation and the write operation on the click data based on the process order. In order to reduce process conflicts between the read operation process and the write operation process, the at least one processor 250 can create a program lock according to the process order, and the browser main process and the rendering process can carry out an atomic operation through the program lock, and the atomic operation can ensure synchronization of execution in a multi-process environment. For example, during the execution of a read operation on the click data, the atomic operation can ensure synchronous execution of the read operation process and the write operation process, or synchronous cancellation of the read operation process and the write operation process. Based on the process order, the at least one processor 250 can control the read and write operation processes to perform the read operation process and the write operation process alternately on the click data based on the process order by means of the program lock to complete the data transmission of the click data, which improves the consistency and integrity of the click data transmission.

When the user operates the game interface through the external device 500, the user can individually click a key, click a plurality of keys in combination, or press and hold one or more keys by the external device 500 to trigger the corresponding game effected by. The data amount of the click data is positively proportional to the number of keys clicked and the time duration of the clicking on the keys, that is, the more the number of keys clicked and the longer the time duration of the clicking on the keys are, the larger the data amount of the generated click data is.

For clicking a single key, the data amount of the click data can be small, and at least one processor 250 can generate one read operation process to complete this click data transmission. When a plurality of keys are clicked, the data amount of the generated click data is larger than the data amount of the clicking on the single key, and the read operation process can decrease according to the increase in the data amount, resulting in a poor transmission efficiency of the click data. For this reason, the at least one processor 250 can decompose the click data into a plurality of data segments and perform read operations on the data segments through multiple read operation processes, thereby completing the read operation on the click data and improving the transmission efficiency of the click data.

It should be noted that the transmission speed of the read/write operation process is related to the processing performance of the display apparatus 200 having different processing performances. The processing performances can include the performances of a central processor, a graphics processor, a memory and a flash memory, etc. The central processor can process the commands and data received by the display apparatus 200, the graphics processor (e.g., graphics processing unit (GPU)) can perform the rendering and outputting of the user interface, and the memory and the flash memory can store the application, the operating system and user data, etc. The at least one processor 250 can decompose the click data based on the processing performance of the display apparatus 200. For example, the at least one processor 250 can perform the data decomposition when the read and write speeds of the click data at a current processing performance is less than or equal to a speed threshold. The speed threshold can be set based on an average processing speed of the display apparatus 200 at this processing performance.

After decomposing the click data, the at least one processor 250 can perform read and write operations on the data segments sequentially based on the process order. In some embodiments, the at least one processor 250 can decompose the click data based on different attributes, e.g., a generation time, a key type, or an optimal processing speed of the read/write operation process. After decomposing the click data, the at least one processor 250 can cyclically generate the read and write operation processes based on the process order to transfer the data segments.

To alleviate data disorganization due to transmission conflicts between data segments, the at least one processor 250 can execute a next read/write operation process after the current read/write operation process is completed. Taking the execution order of executing the write operation process first and then the read operation process as an example, during the execution of the read and write operations on the data segments, the at least one processor 250 can obtain the process progress of the previous read and write operation processes.

In some embodiments of the present disclosure, the read operation process can be located after the write operation process. Therefore, the at least one processor 250, after detecting the completion of the read operation process, can determine that the last read/write operation process has been completed, can execute the write operation process of the current read and write operation processes on the data segment to write the data segment to the rendering process, and can execute the read operation process of the current read and write operation processes through the rendering process to read the data segment to the browser, and then can execute the next read and write operation processes. The transmission of the click data is completed after all data segments have been transmitted. If the at least one processor 250 detects that the last read/write operation process is not completed, it can execute a delay program for the current read/write operation process, wait for the completion of the last read/write operation process, and then execute the current read/write operation process, so as to ensure the sequential transmission of the click data and to reduce the consumption of the system resources across processes.

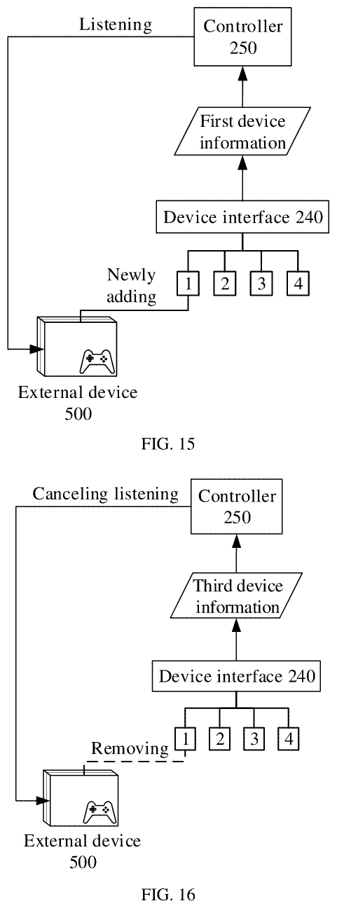

In some embodiments, the external device management module can also record a device management state of the external device 500, and can obtain the device management state when the at least one processor 250 generates a listening command. The device management state can include a device addition state and a device change state. The device addition state is switched when the external device 500 is newly added to the device interface 240 to indicate that the display apparatus 200 establishes a connection with the new external device 500. When the device management state is the device addition state, as shown in FIG. 15, the at least one processor 250 can control the device interface 240 to obtain first device information, where the first device information is device information of the newly added external device 500. In order to listen to the click data sent from the newly added external device 500, the at least one processor 250 can generate a listen command based on the first device information to perform listening to the newly added external device 500.

When the device management state is the device change state, it can mean that the external device 500 currently in connection with the device interface 240 is changed to a newly added external device 500. In this way, the at least one processor 250 can control the device interface 240 to obtain the second device information, the second device information being the device information of the to-be-changed external device 500. The at least one processor 250 can, based on the second device information, generate a listening command to perform listening to the newly added external device 500.

In some embodiments, as shown in FIG. 16, the device management state can also include a device removal state. When the device management state is the device removal state, it can mean that the external device 500 originally connected the device interface 240 has been removed, and the listening to the external device 500 can be canceled. The at least one processor 250 can obtain third device information based on the device interface 240, the third device information being device information of the to-be-removed external device 500, and can generate a cancel listening command based on the third device information. The cancel listening command can be used to cancel listening to the to-be-removed excluded device 500 to reduce power consumption of the display apparatus 200 and improve operational efficiency.

Since some applications can support simultaneous operations by multiple people, the device interface 240 can be simultaneously connected with multiple external devices 500 corresponding to the number of operating users, and the external device management module can record the device management state of each external device 500 connected with each sub-interface in the device interface 240, so as to listen to the click data uploaded by each external device 500, and improve the accuracy of the data transmission.

In some embodiments, the user can input text within the application interface, e.g., comments and barrages on a movie or television work in a video playback interface, text naming a virtual character in a game interface, a record of a game archive, or, a scene of player-player interaction. When the user needs to enter text within the application interface, the at least one processor 250 can pop up a virtual keyboard at a specified location of the user interface, and the user can switch the focus from the application interface to the virtual keyboard via the control device 100, so as to complete the input of text in the virtual keyboard.

Since the at least one processor 250 does not restrict key pressing on the external device 500 when the virtual keyboard is popped up, the external device 500 can still input corresponding operation commands to the application interface by pressing keys, resulting in chaotic data input. Taking the game interface as an example, when the external device 500 is a keyboard, the at least one processor 250 can control a forward direction, a backward direction, a left direction and a right direction by means of keys “W”, “S”, “A”, and “D”, respectively. However, when the virtual keyboard is popped up, the user is required to input text via letters on the keyboard, and when the process of inputting the text can include the abovementioned four arrow keys, the operation of the game conflicts with the input of the text. For example, when the key “W” is clicked, the key “W” is clicked, and the key “W” is clicked. For example, when the key “W” is clicked, the virtual character can move forward in the virtual scene, and meanwhile, the character corresponding to “W” is also input into the text input box in the virtual keyboard.

When the external device 500 is a gamepad, the external device 500 can also switch the focus between the game interface and the virtual keyboard by using the arrow keys. Therefore, some users are prone to mistakenly switch the focus on the virtual keyboard to the game interface through the external device 500, resulting in the focus being switched before the user has finished the text input, which affects the efficiency of the user's text input in the game interface.

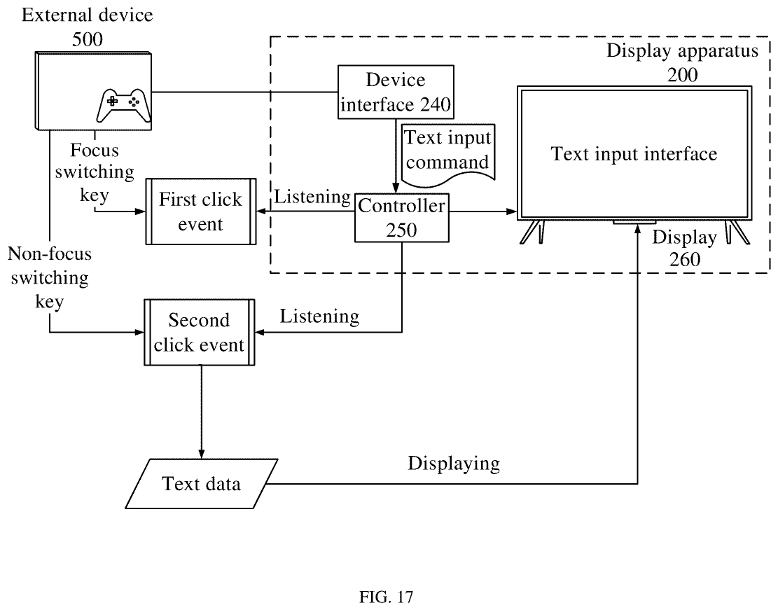

In order to improve the efficiency of the user's text input in the application interface, in some embodiments, the at least one processor 250 is further configured to perform a control method. FIG. 17 is a flowchart of a control method according to embodiments of the present disclosure. Referring to FIG. 17, the method can include the following.

S102: in response to a text input command, obtaining a focus interface.

The user interface can include a plurality of application interfaces, and the application interfaces can be switched to one another through the focus. Among the plurality of application interfaces, the user interface or the application interface in which the focus is currently located is a focus interface, and the user can send a corresponding operation command into the focus interface through the external device 500. The at least one processor 250, in response to the operation command, and generates a target application interface according to the focus interface.

When the user needs to enter text in the application interface, the at least one processor 250 can, in response to the text input command sent from the user via the external device 500, obtain the focus interface. The application interface can include a text input option, and the user can generate a text input command when the user clicks on the text input option via the external device 500. The at least one processor 250, in response to the text input command, can generate a text input interface in an upper layer of the application interface, thereby inputting corresponding text content within the text input interface.

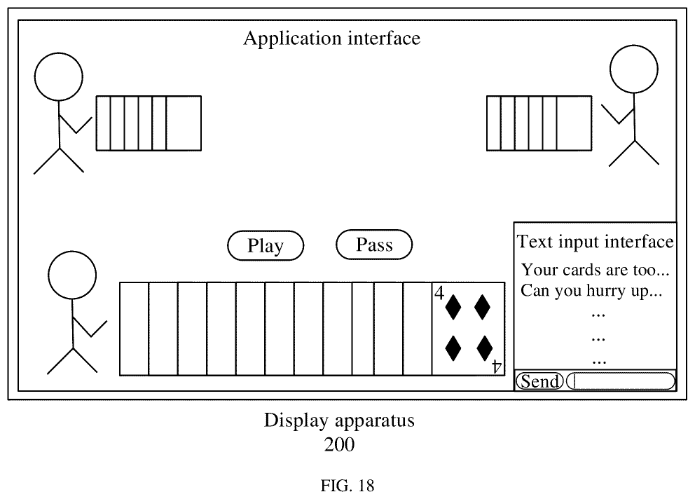

In some embodiments, in order to reduce the shading of the text input interface to the application interface, the at least one processor 250 can generate the text input interface at a preset ratio according to the screen size, and set the generation position of the text input interface at an edge of the application interface. As shown in FIG. 18, and the at least one processor 250 can set the generation position of the text input interface at the lower right of the application interface, thereby minimize the shading of the text input interface to the application interface, so that the user can edit the text content according to the display content on the application interface.

It should be noted that the preset ratio is a default ratio set according to the screen size of the display apparatus 200, and the at least one processor 250 can automatically adjust the display size of the text input interface when switching between different display apparatuses, or, the user can adjust the preset ratio according to the optimal input size. In order to ensure the efficiency of text input, the size of the text input interface should ensure that the user can see the characters within the interface. Therefore, the at least one processor 250 can also perform a zoom-in operation or a zoom-out operation on the text input interface according to the corresponding operation command, so as to facilitate the user to adjust the size of the interface in real time during the text input, so as to enable the user to input the text in the optimal size to enhance the comfort of the user.

S202: based on that the focus interface is an application interface, listening to a first click event.

The focus interface can be constantly switched between application interfaces, and between the application interface and the text input interface. However, the application interface can perform corresponding application operation based on the click data. Taking the game interface as an example, when the focus interface is a game interface, the click data of the external device 500 is converted into a game operation within the game interface, and since the game interface does not display a text input interface, the at least one processor 250 is unable to directly input text data on the application interface based on the click data.

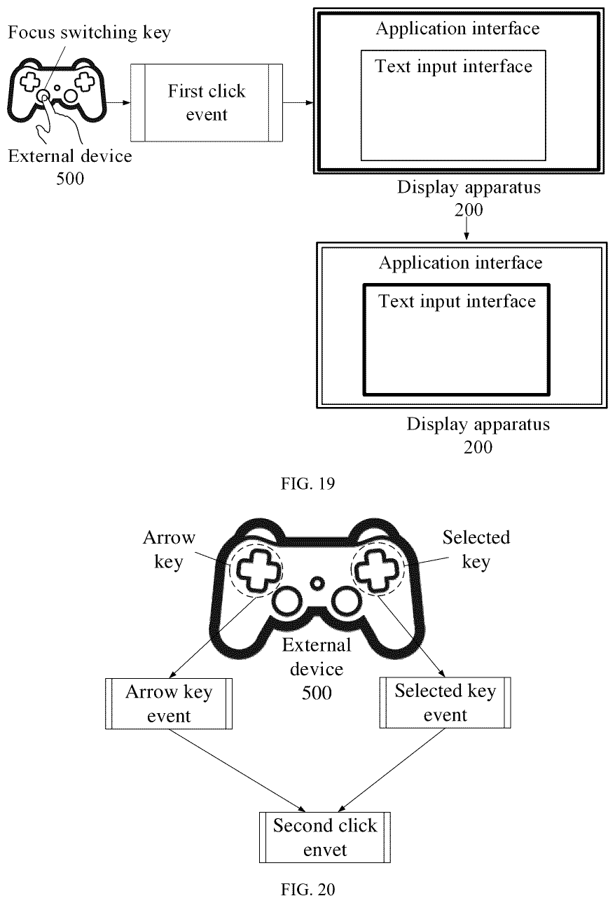

In order to realize the switching of focus, the external device 500 can include a focus switching key (i.e., a first key which is configured to be able to switch a focus on the display) and a non-focus switching key (i.e., a second key which is configured to be not able to switch the focus on the display), where the focus switching key can be used to switch the focus between interfaces. As shown in FIG. 19, by clicking the focus switching key once, the external device 500 can generate a first click event, and the at least one processor 250 can, in response to the first click event, cause the focus interface to be switched from the application interface to the text input interface, and then click the focus switching key again to cause the focus interface to be switched from the text input interface back to the application interface again.

The non-focus switching key can be used to generate click data, and after generating the click data, the at least one processor 250 can generate different conversion logics at different interfaces so as to convert the click data into data adapted to the corresponding interface. For example, in a text input interface, the click data can be converted to text data according to a first conversion logic; and in an application interface, the click data can be converted to application data according to a second conversion logic.

In some embodiments, a default conversion logic can be provided between the click data generated by the keys in the external device 500 and the application, and the at least one processor 250 can convert the click data to application data or text data according to the default conversion logic. In order to adapt to a personal habit of using the keys, the user can modify the conversion logic of the keys in the application interface to improve the user's ease of operation. Taking the modification of the second conversion logic as an example, the gamepad is provided with key A and key B, where the function of key A in the game interface is to control the attack of the virtual character, and the function of key B in the game interface is to control the jump of the virtual character. The user can, according to the personal usage habits, switch the corresponding functions of key A and key B, so that the click data generated by key A is converted to the jump data of the virtual character, and the click data generated by key B is converted to the attack data of the virtual character.

Based on the above embodiments, the focus switching key can be not fixed, and the user can also modify the focus switching key according to the key usage habits. The external device 500 can be provided the focus switching key alone, or a key on the external device 500 can be set as the focus switching key, for example, by setting the key A as the focus switching key, then the first click event can be generated by the key A.

If the focus interface is an application interface, the at least one processor 250 can input the corresponding text content when the focus is switched from the application interface to the text input interface. Therefore, the at least one processor 250 can listen to the first click event, the first click event is generated by the focus switching key of the external device 500, and the first click event can switch the focus interface to the text input interface.

In some embodiments, when the focus interface is an application interface, the at least one processor 250 can hide the text input interface, or, perform a minimization operation on the text input interface to reduce the shading to the application interface. After listening to the first click event, the focus interface is the text input interface, and the at least one processor 250 can display the text input interface or, or perform a maximizing operation on the text input interface to enable the user to clearly input text data based on the characters within the text input interface.

S302: obtaining a second click event from the external device based on the first click event.

After listening to the first click event, the at least one processor 250 can switch the focus interface to the text input interface, and the user can enter text data in the text input interface via the non-focus switching key on the external device 500. In this way, the at least one processor 250 can listen to a second click event, and the second click event is generated by the non-focus switching key.

The at least one processor 250 can support a variety of input manners, which vary depending on the types of the external devices 500. Exemplarily, the external device 500 can be a keyboard that can include a plurality of character keys that can correspond to characters in the text input interface, i.e., one character key corresponds to one character in the text input interface, and thus the second click event generated by the keyboard can be directly converted to character data for generating text data.

The external device 500 can also be a gamepad as shown in FIG. 20. Referring to FIG. 20, the gamepad can include selected keys in addition to arrow keys such as “up”, “down”, “left” and “right”. The selected keys can perform confirmation and cancel options, and therefore, the number of selected keys should be at least two. During inputting text data, the user needs to select the to-be-inputted character in the text input interface by clicking on the arrow keys, and select the character according to the selected keys to generate the character data. Therefore, at least one processor 250 can generate a second click event according to the arrow key event and the selected key event.

In some embodiments, the user can mistakenly click during inputting the text data, resulting in the input of a wrong character For this reason, a delete key can also be included on the external device 500, and when the user clicks the delete key, the external device 500 can generate a delete click event, and the at least one processor 250 can also obtain the delete click event sent from the external device 500. The delete click event can delete a recent second click event listened to by the at least one processor 250 to delete the wrong character entered from the user by mistakenly clicking to improve the accuracy of the text data input.

S402: generating text data based on the second click event, and controlling the display to show the text data on the application interface.

The at least one processor 250 can generate click data based on the second click event and convert the click data to text data according to the first conversion logic. In some embodiments, in order to improve the conversion efficiency between the click data and the text data, before obtaining the click data, the user can perform manual configuration for the keys on the external device 500 via the at least one processor 250 according to the first conversion logic, and after completing the configuration, the configuration relationship can be mapped to the click data when the keys on the external device 500 are clicked, so as to directly obtain text data, which improves the conversion efficiency of the data keys.

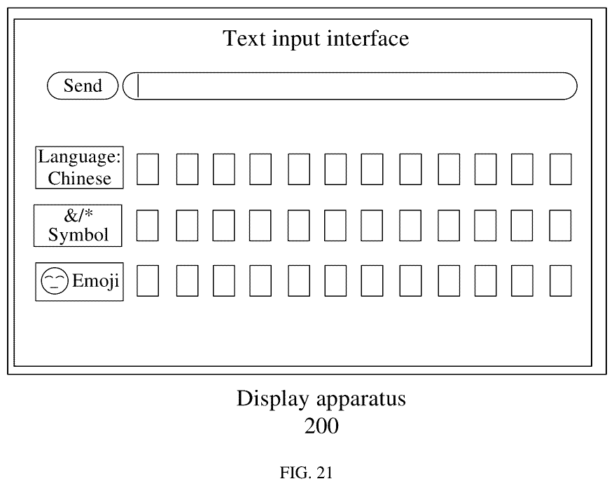

In order to adapt to users of different operating languages, as shown in FIG. 21, the text input interface can also include a language switching option, and the at least one processor 250 can switch the language on the text input interface based on a language switching event, the language switching event being the second click event of clicking the language switching option. The at least one processor 250 can set an initial language of the display apparatus 200 before switching the language, where the initial language can be determined based on a positioning location of the display apparatus 200. For example, if the positioning location is located in China, the at least one processor 250 can set the default language of the display apparatus 200 to Chinese.

When the language of the display apparatus 200 is switched, the first conversion logic of the click data can also change based on the switched language. For example, if the default language is Chinese, the at least one processor 250 can convert the click data to text data according to the conversion logic of Chinese, and when the language is switched to English, the at least one processor 250 can change to convert the click data to text data according to the conversion logic of English, thereby adapting to text data in different languages.

In some embodiments, the text input interface can include a virtual keyboard pop-up window, the virtual keyboard pop-up window is an interface similar to a physical keyboard, the virtual keyboard pop-up window can include a plurality of character keys, the character keys can be in a virtual key region, and the character keys can be arranged in the virtual keyboard pop-up window in a particular input mode, e.g., “9-key input” or “26-key input”, etc. The virtual keyboard pop-up window can also include input method options, which allow the user to select the corresponding input method. The input method can include the input language, such as Chinese (Simplified), Chinese (Traditional), or English, etc., and can include the input mode, such as five-stroke input, Pinyin input, or handwriting input, etc. The user can edit text data that can include different languages by switching between input method options to improve the linguistic breadth of text input.

The input method options can also include emoji input, and the at least one processor 250 can generate corresponding emoji data based on the second click event in the emoji list interface and control the display 260 to display the emoji data in the text box of the virtual keyboard pop-up window. The emoji list interface can include emoji images stored in the input method system or emoji images stored by the user in the target application, and the emoji images can include a static image and a dynamic image. The at least one processor 250 can, based on the second click event responsive to the input method option, switch between text input and emoji input, thereby generating text data for a combination of text and emoji images.

The character keys are capable of generating character data for composing the text data. The user, when inputting the click data via the external device 500, can click the corresponding keys on the external device 500 to generate the second click event based on the position of the character keys in the virtual keyboard pop-up window. In this way, the second click event can be used to characterize the character data generated by clicking the selected character key, and the text data can include a text composed of a plurality pieces of character data. For example, the English word “in” is composed of two English letters, “i” and “n”, and the at least one processor 250 can generate the English word “in” based on the second click event triggered by clicking “i” and the second click event triggered by clicking “n”.

The character data needs to be generated sequentially according to the spelling order of the text data, and in order to reduce the deviation of the generated text content caused by the wrong generation order of the character data, the at least one processor 250 can obtain the number and order of clicks on the non-focus switching key according to the second click events.

In order to improve the efficiency of inputting the text data, the at least one processor 250 can obtain a set of second click events based on an input interval, where the input interval is a time interval between two consecutively triggered second click events during inputting the text data.

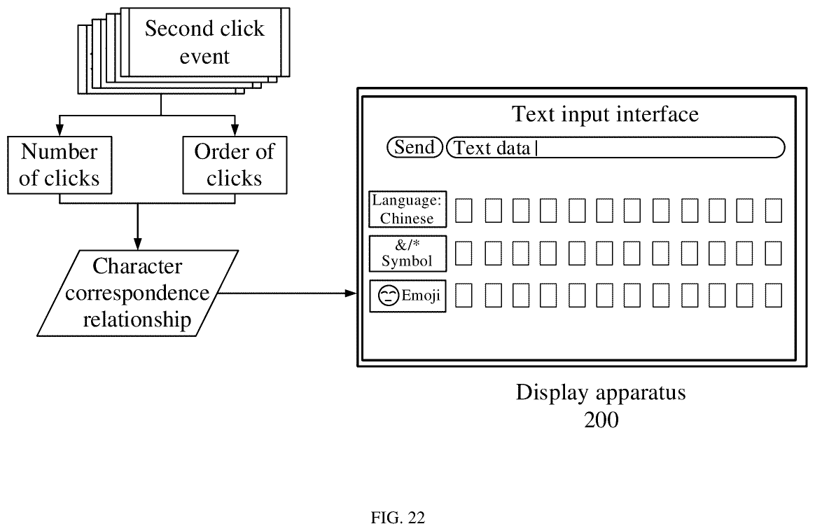

The set of second click events can include click events generated by clicking a plurality of non-focus switching keys. In some texts, the same character or letter data can be repeated due to the more complex spelling of some of the texts. Therefore, as shown in FIG. 22, the set of second click events can further include a plurality of second click events triggered by the same keys. The at least one processor 250 can obtain the number and order of clicks on the non-focus switching keys based on the second click events, and generate the text data based on the character correspondence relationship. The character correspondence relationship can be set based on the key input rule of the external device 500, and the same one key can correspond to different characters. For example, the same one key on the keyboard can correspond to two kinds of characters, and switching between different characters can be done by “switching key”. When the user releases the “switching key”, the first character data can be generated by clicking the key, and when the user long-presses the “switching key”, the second character data that is different from the first character data can be generated by clicking this key.

In some embodiments, the key input rule can also be switched by clicking the “switching key”. For example, when the “switching key” is clicked for the first time, the key input rule is switched to the uppercase input rule, and in this case, the keys on the keyboard correspond to uppercase characters; and when the “switching key” is clicked again, the key input rule is switched to the lowercase input rule and the keys on the keyboard correspond to lowercase characters, thus realizing the input of multiple kinds letters according to the “switching key” and improving the diversity of character or letter input.

The virtual keyboard pop-up window can also include a character focus, which is the focus in the virtual keyboard pop-up window and can be used to select the character key. The character focus is located at the first character key in the virtual keyboard pop-up window by default, and the at least one processor 250 can, in response to an arrow key event, obtain the number of clicks on the arrow key, and move the focus in the virtual keyboard pop-up window based on the number of clicks. During the text data input, the user can move the focus through the arrow keys of the external device 500 and select a character key where the focus is located based on the selected key, thereby generating corresponding click data, and the at least one processor 250 can convert the click data into character data according to the key input rule.

In the above process, in order to generate different character data, the second click event can be interspersed with different arrow key events and selected key events. The at least one processor 250, after receiving the second click event, can obtain a click order based on the event generation time, and based on the click order, obtain character data corresponding to the character focus based on the number of clicks on the selected key, so as to generate text data based on the character data.

After completing the input of the text data, the at least one processor 250 needs to send the text data to the application interface to complete rendering for the application interface based on the text data. The virtual keyboard pop-up window can also include a sending character or character for sending, the sending character can be used to send the text input entered from the user to the application interface. In order to reduce the problem that the user mistakenly triggers the sending character when clicking a key via the external device 500, resulting in the sending of incompletely entered text data, the sending character can be displayed at an edge of the virtual keyboard pop-up window, so as to reduce the error sending.

When the focus is on the sending character and the at least one processor 250 listens to a selected key press event, the virtual keyboard pop-up window can generate a sending event. The at least one processor 250, in response to the sending event, can render the application interface based on the text data within the text box of the virtual keyboard pop-up window. Prior to rendering, the at least one processor 250 can detect a text format, e.g., a text font, a text font size, an art font effect, etc., of the text data, and can render the application interface based on the specified text format.

During the rendering process, the at least one processor 250 can generate an application interface according to a display mode of the text data. For example, if the text data is displayed as a barrage, the at least one processor 250 can generate text data for scrolling display on the application interface. When the application interface is a video interface or a game interface, in order to reduce the shading of the text data to the interface, the at least one processor 250 can also display the text data at a specified position in the application interface and hide the text data with a gradient effect after a preset time duration, thereby reducing the time of shading to the interface, and enhancing the viewing experience of the user.

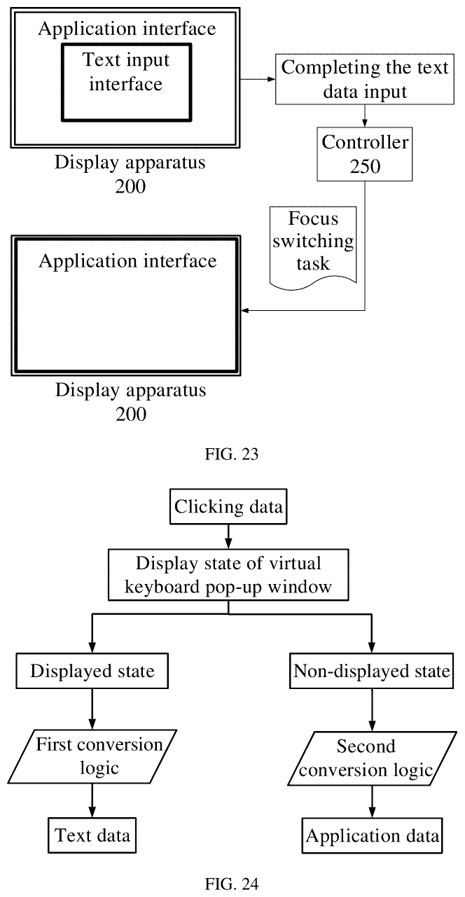

After controlling the display 260 to display the application interface rendered based on the text data, i.e., after completing a time of the text data input, the at least one processor 250 can control the display 260 to hide the virtual keyboard pop-up window after listening to the sending event, so as to automatically return to the application interface to continue inputting the operation command after completing the text data input. In the above process, as shown in FIG. 23, the at least one processor 250 can generate a focus switching task based on the text data, the focus switching task can be used to switch the focus interface to the application interface, and the at least one processor 250 can, in response to a focus switching task, control the application interface to obtain the focus, thereby setting the application interface as the focus interface.

In the event that the user wants to enter text data again, the focus switching key can be clicked again to switch the focus interface to the text input interface again. However, if the user needs to input the text data at a high frequency, the user needs to click the focus switching key before each input, resulting in a cumbersome process of inputting the text data.

In some embodiments, the at least one processor 250, after controlling the display 260 to display the application interface with the text data, can continue to display the virtual keyboard pop-up window and continuously listen to the click data from the external device 500, and the at least one processor 250 can realize the input of the text data several times consecutively based on the sending events. After the user completes inputting all the text data, the user can click the focus switching key again to generate a first click event, and the at least one processor 250 can control the application interface to obtain the focus according to the first click event. In the embodiments of the present disclosure multiple pieces of text data can be continuously inputted in the virtual keyboard pop-up window without having to click the focus switching key before each time of the text data input, and it only needs to click the focus switching key once after completing the input of all the text data, so as to switch the focus interface back to the application interface and to reduce the difficulty of input.

After the application interface obtains the focus, the at least one processor 250 can continue to listen to the second click event uploaded by the external device 500, and generate click data based on the second click event. Since the focus is located on the application interface, In this way, the at least one processor 250 can convert the click data to the application data based on the second conversion logic, where the application data is operation data, e.g., control data for pausing and playing in the video playback interface, virtual character action data in the game interface, etc., responsive to the application interface. After obtaining the application data, the at least one processor 250 can control the display 260 to display the application data based on the application interface, so as to realize generating different interface data by using different switching logic in different focus interfaces, and to improve the efficiency and accuracy of text input in the application interface.

In some embodiments, the focus switching key can also realize a sending function while switching the focus interface. For example, the entry key (Enter) on the keyboard can be set as the focus switching key, and meanwhile, the entry key also has the sending function. When the user inputs text data, the user can click the enter key, the keyboard can generate a focus switching command based on the enter key, the at least one processor 250 can control the text input interface to obtain the focus based on the focus switching command, and the user can continue to click other keys to input text data. After completing the input of the text data, the user can click the entry key again to send the text data to the application interface, as well as, the focus switching command is generated again, and the at least one processor 250 can respond to the focus switching command to switch the focus back to the application interface.

In the above embodiments, the click data can be generated based on a second click event between two first click events. When the at least one processor 250 only listens to two consecutive second click events, it can mean that the user did not enter the click data via the non-focus switching key on the external device 500, and the at least one processor 250 cannot generate the text data. For this reason, when the focus interface is the application interface, the at least one processor 250 can obtain the number of consecutive clicks on the focus switching key based on the first click events.

It should be noted that the counting of consecutive clicks in some embodiments of the present disclosure can be only for the same one key. For example, when the focus switching key is clicked twice consecutively, the number of consecutive clicks is recorded as 2. When the focus switching key, the non-focus switching key, and the focus switching key are clicked in sequence, the non-focus switching key refreshes the number of the clicks on the focus switching key, and the number of consecutive clicks of the focus switching key in the above mentioned clicking process is respectively 1, 0, and 1.

When the number of consecutive clicks is an odd number, the focus interface changes, and the at least one processor 250 can control the text input interface to obtain the focus and control the display 260 to display the virtual keyboard pop-up window, and send a listening command to the device interface 240 to perform listening to the external device 500 connected with the device interface 240. Upon listening to the second click event, the at least one processor 250 can convert the click data generated by the second click event to the text data based on the second conversion logic.

When the number of consecutive clicks is an even number, the focus interface eventually can switch back to the application interface, and the at least one processor 250 does not change the focus on the application interface. The at least one processor 250 can perform listening to the external device 500 connected with the device interface 240. After listening to the second click event, the at least one processor 250 can convert the click data generated by the second click event to the application data based on the second conversion logic.

Since the virtual keyboard pop-up window is used for inputting text data, when the text input interface can present the virtual keyboard pop-up window, it can mean that the at least one processor 250 needs to convert the click data to the text data. Therefore, the at least one processor 250 can also perform different logical conversions according to the display state of the virtual keyboard pop-up window. In some embodiments, the at least one processor 250 can obtain a display state of the virtual keyboard pop-up window, where the display state can include a displayed state and a non-displayed state, the displayed state being that the virtual keyboard pop-up window is displayed on the text input interface, and the non-displayed state being that no virtual keyboard pop-up window is displayed on the text input interface.

FIG. 24 is a flowchart of converting data based on the display state of the virtual keyboard pop-up window in the display apparatus according to some embodiments of the present disclosure. Referring to FIG. 24, an initial display state of the virtual keyboard pop-up window can be a non-displayed state, and when the user clicks on a text box on the text input interface via the external device 500, the at least one processor 250 can control the display 260 to display the virtual keyboard pop-up window within the text input interface, and meanwhile, the at least one processor 250 can switch the display state of the virtual keyboard pop-up window to a displayed state. In the displayed state, the at least one processor 250 can, based on the first conversion logic, generate text data from the listened click data.

Upon completing the text data input, the at least one processor 250 shall perform a sending operation, so that the at least one processor 250 can control the display 260 to hide the virtual keyboard pop-up window and switch the display state of the virtual keyboard pop-up window to the non-displayed state. When the display state is switched from the displayed state to the non-displayed state, the at least one processor 250 can generate a focus switching task based on the non-displayed state, and control the application interface to obtain the focus based on the focus switching task. When the focus interface is an application interface, the at least one processor 250 can convert the listened click data into application data based on the second conversion logic.

To alleviate a conversion conflict between the application interface and the text input interface during the conversion of the click data based on the conversion logic by the at least one processor 250, in some embodiments, the at least one processor 250 can control the start and stop of the conversion between the interface and the click data. For example, when the focus interface is the text input interface, the at least one processor 250 can deactivate the second conversion logic between the application interface and the click data uploaded by the external device 500, so that the click data is only converted to text data based on the first conversion logic, thereby alleviating mis-operation during inputting the text due to the application interface being also affected by the click data, and improving the stability of the interface operation.

When the focus interface is switched, the at least one processor 250 can switch the usage state corresponding to the conversion logic. For example, when the focus interface is switched to the application interface, the at least one processor 250 can switch to enabling the second conversion logic and disabling the first conversion logic, so that while the application interface displays the text data, it can convert the newly-listened-to click data into application data based on the second conversion logic, and control the display 260 to perform corresponding rendering for the application interface to complete the display of the application data.

It should be noted that both the application interface and the text input interface can be user interfaces displayed based on a browser, and the at least one processor 250 can also control the start and stop of the conversion logic based on the interaction with the browser. The browser can be provided with a logic management module of the user interface for managing the conversion logic between different pages. The browser can manage different pages according to a default logic priority. For example, when the upper layer of the user interface is overlaid with another displayed interface, the click data can be processed based on the conversion logic of the interface in the uppermost layer. In this way, the browser can disconnect all the conversion logics located in the lower layer, so that the click data of the external device 500 can only be inputted to the interface in the uppermost layer as the corresponding data.

For user interfaces in the same layer, the browser can select the corresponding conversion logic based on the focus, and deactivate the conversion logic of the unselected interface before processing the click data with the conversion logic of the selected interface, so that the corresponding data can be only generated from the click data for the selected interface, improving the accuracy of data processing.

In some embodiments, the switching of the conversion logic can also be determined based on a time point, and when the at least one processor 250 controls the display 260 to hide the virtual keyboard pop-up window, the at least one processor 250 can switch the display state to a non-displayed state while generating a pop-up variable. The pop-up variable can include a variable generation time, and the pop-up variable can be used to indicate a time point at which the virtual keyboard pop-up window is hidden. The at least one processor 250 can listen to an application key event based on the variable generation time as the time point, the application key event being a second click event whose generation time is later than the variable generation time. The at least one processor 250 can, based on the second conversion logic, convert the click data generated based on the application key event to the application data.

When listening to the first click event again, the at least one processor 250 can set the pop-up variable to an invalid state while switching the second conversion logic to the first conversion logic, and generate the text data based on the click data. When the virtual keyboard pop-up window is hidden again, the at least one processor 250 can generate the pop-up variable again based on the current time and replace the pop-up variable in the invalid state with the current pop-up variable, where the pop-up variables in the valid state have the same function.

Based on the display apparatus 200 according to the above embodiments, a browser-based data displaying method for an external device is further according to some embodiments of the present disclosure. The method can include the following steps.

S101: generating a listening command when the external device is connected with the device interface.

S201: in response to the listening command, listening to click data sent from the external device.

The click data is generated by the external device based on a key operation event.

S301: generating a target application interface based on the click data, and, replacing a currently displayed application interface based on the target application interface.

S401: if a frame duration of the target application interface is less than a frame duration threshold, calculating a frame duration difference.

The frame duration is a displaying duration of the target application interface, and the frame duration threshold is a single frame duration of the browser at the current page refresh rate.

S501: controlling the display to display the target application interface based on the browser, and, performing a null task based on the frame duration difference.

The null task is a task executed during an idle time.

According to the embodiments of the present disclosure, the browser-based data displaying method for the external device, the click data from the external device is listened when the external device is connected with the device interface, and the target application interface is generated based on the click data and based on the user interface of a browser, the currently displayed application interface is replaced based on the target application interface, the frame duration difference is calculated if the frame duration of the target application interface is less than a frame duration threshold, the display is controlled to show the target application interface based on the browser and, and the null task is performed based on the frame duration difference. In the present disclosure, the display time of the target application interface is determined by the frame duration, so as to perform the null task in the remaining time of the frame, reduce the phenomenon of frame loss of the display, and improve the smoothness of the display picture.

Based on the display apparatus 200 according to the above embodiments, some embodiments of the present disclosure further can provide a control method. The method can include the following.

S102: in response to a text input command, obtaining a focus interface.

The focus interface is a user interface on which a focus is currently located.

S202: based on that the focus interface being an application interface, listening to a first click event.

The first click event can be used to switch the focus interface to the text input interface, and the first click event is generated by a focus switching key of the external device.

S302: obtaining a second click event from the external device based on the first click event.

The second click event is generated by the non-focus switching key.

S402: generating text data based on the second click event, and controlling the display to show the text data on the application interface.

According to some embodiments of the present disclosure, in the control method, the focus interface is obtained in response to the text input command, and the first click event is listened if the focus interface is the application interface, where the first click event can be used to switch the focus interface to the text input interface, and the first click time is generated by the focus switching key of the external device. Based on the first click event, the second click event generated by the non-focus switching key and sent from the external device is obtained, and the text data is generated and displayed based on the second click event. In the present disclosure, the focus is switched between the application interface and the text input interface by the focus switching key, and the text data on the text input interface is generated through the external device, so as to reduce the data that is input incorrectly due to the focus control confusion, and improve the efficiency of the user's text input on the application interface.

In some embodiments, the display apparatus 200 stores a key value mapping table (key-map) that can include a mapping relationship between key values and operations of the keys of the control device 100. After receiving the key value sent from the control device 100, the display apparatus 200 can map to the operation corresponding to the key value according to the key value mapping table, and then execute the operation to realize the function corresponding to the key value. For example, if the control device 100 is a remote control, the user presses the right key on the remote control, and the remote control can send the key value “Key_Right” to the display apparatus 200. If the key value mapping table includes Key_Right, and Key_Right is mapped to an operation, such as a function or command to move the focus to the right, then the display apparatus 200 can perform the operation of moving the focus to the right based on the key value “Right” and the key value mapping table.

A gamepad is an external device for the display apparatus 200. The display apparatus 200 can access the gamepad via the communicating device 220, for example, the display apparatus 200 is connected with the gamepad via Bluetooth. The display apparatus 200 can also access the gamepad via an external device interface 240, for example, the display apparatus 200 can access the gamepad via a USB interface. As shown in FIG. 1, after the display apparatus 200 is connected with the gamepad 600, if the user uses the display apparatus 200 to play a game, for example, the display apparatus 200 displays a game page in the foreground, the user can operate on the game page via the gamepad 600.

When the user operates on the game page via the gamepad 600, the user inputs control information to the display apparatus 200 via the joystick and keys of the gamepad 600. In some embodiments, the joystick of the gamepad 600 can be a single joystick, and the single joystick can be located on the left side, the right side, or the center of the body of the gamepad 600. The number of the joysticks of the gamepad 600 can be 2, the joysticks can be disposed on the left side and the right side of the body of the gamepad 600, where the joystick disposed on the left side of the body can be referred to as the left joystick and the joystick disposed on the right side of the body can be referred to as the right joystick.

When the gamepad 600 detects that the position of the joystick has moved, it can send the position after the movement of the joystick to the display apparatus 200 as control information. For example, the gamepad 600 can send the position after the movement of the joystick in the form of a joystick event, which has an event type of EV_ABS. The gamepad 600 can represent the position after the movement of the joystick in the form of coordinates, and establish a preset coordinate system by a movement range of the joystick. A center point of the preset coordinate system is an initial position of the joystick, an x-axis of the preset coordinate system is a dynamic line that is pre-configured for the joystick to move horizontally to the left or horizontally to the right, and a y-axis of the preset coordinate system is a dynamic line that is pre-configured for the joystick to move vertically upward or vertically downward. The movement range of the joystick is a circle with the center point as the center and the preset distance as the radius. For example, if the preset distance is Max, the movement range of the joystick in x-axis and y-axis is (−Max, Max). Under Linux, Max can be 32768. When redisplaying a joystick event in coordinates, the left joystick x-axis returns ABS_X type coordinate value, the left joystick y-axis returns ABS_Y type coordinate value; the right joystick x-axis returns ABS_Z type coordinate value, the right joystick y-axis returns ABS_RY type coordinate value.

After the user moves the joystick, the gamepad 600 can recognize the coordinates corresponding to the position of the joystick after the movement of the joystick in the preset coordinate system and send the coordinates as control information to the display apparatus 200. The display apparatus 200, after receiving the control information, can transmit the control information to the game page, which processes the control information and performs the operation corresponding to the control information. For example, the game page can process the control information and determine that the operation corresponding to the control information is to move the target object in the game horizontally to the right, and move the target object to the right.

When the gamepad 600 detects that the user presses an arrow key, it can send the key information of the arrow key as control information to the display apparatus 200. For example, the gamepad 600 can send the key information of the arrow key in the form of a key event, the key event having an event type of EV_ABS. The display apparatus 200, after receiving the control information, can transmit the control information to the game page, where the game page processes the control information and performs an operation corresponding to the control information. For example, the game page can process the control information to determine that the arrow key is a right-arrow key, and that the operation corresponding to the right-arrow key is to horizontally move the focus to the right to move the focus to the right.

The gamepad 600, when detecting that the user presses other keys (ordinary keys, such as X, Y, A, B, LB, RB, LT, RT, Select, Start, and other keys), can send the key information of that ordinary key to the display apparatus 200 as control information. For example, the gamepad 600 can send the key information of that ordinary key in the form of a key event, the key event having an event type of EV_KEY. The display apparatus 200, after receiving the control information, can transmit the control information to the game page, which processes the control information and performs an operation corresponding to the control information. For example, the game page can process the control information, determine that the ordinary key is a key “Select”, and that the operation corresponding to the key “Select” is to select an object and select the object on which the focus is currently located.

Based on the type of the foreground page on which the focus is currently obtained, the scene in which the display apparatus 200 is currently located can be divided into a game scene and a non-game scene. If the foreground page is a game page, such as a page of a webpage game, a page of a third-party game application, the scene in which the display apparatus 200 is currently located is a game scene. If the foreground page is a non-game page, such as a non-game webpage, a page of a third-party application of a non-game type, a home page of the display apparatus 200, a page of a live television broadcasting, etc., the scene in which the display apparatus 200 is currently located is a non-game scene. If the foreground page is a browser page, the display apparatus 200 can recognize the page content on the page that gains the focus and determine whether the foreground page is a game page. If the page content on the page that gains the focus is a game, the foreground page is determined to be a game page. If the foreground page is a page of a third-party application, the display apparatus 200 can recognize the application type of the third-party application to determine whether the foreground page is a game page, where, if the application type of the third-party application is recognized as a game, the foreground page is determined to be a game page.

In a game scene, although the user can control the operation on the game page via the gamepad 600, the gamepad 600 can only support controlling the webpage game and cannot support controlling the third-party game application. That is, the user can play the webpage game using the gamepad 600 and cannot play the third-party game application using the gamepad 600. In a non-game scene, the display apparatus 200 can receive the control information from the gamepad 600 and transmit it to the non-game page, and the non-game page does not respond to the control information, i.e., the user is unable to control the operation on the non-game page via the gamepad 600. It can be seen that the limitations of the scenes supported by the gamepad 600 are large.

Moreover, in the game scene, since the display apparatus 200 can first send the control information from the gamepad 600 to the middleware layer, and then transmit the control information to the game page through the relevant middleware in the middleware layer, the time duration for the game page to receive the control information is prolonged, which causes that the game page is unable to process the control information in time and perform the corresponding operation, and the response speed to the control of the gamepad 600 is slower, and the user can feel a delay in the response of the display apparatus 200 to the control of the gamepad 600, causing poor user gaming experience.

In view of the above issues, the display apparatus 200 according to the embodiments of the present disclosure can be configured with a system architecture related to responding to the control of the gamepad 600 as shown in FIG. 5. The system architecture associated with the control in response to the gamepad 600 can include an application layer, a kernel layer, and a driver layer. The application layer can include: a non-game page UI, a page of a webpage game, a third-party application (Third-party App), a system service (system server), and a browser. The kernel layer (Linux Kernel) can include: buffers. The driver layer can include: drivers used to access the gamepad 600, such as Bluetooth BT driver and USB driver.

The Bluetooth BT driver and USB driver can be used to provide support for the gamepad 600 for cloud gaming; the kernel layer can be used to write the received control information from the gamepad 600 into the buffer. A system service can be used to read the control information from the buffer, convert the control information, and distribute the converted control information, where the system service can read the control information from the buffer via Direct FB (frame buffer). The UI can respond to the converted control information distributed by the system service. A browser can be used to provide the required network and other support for the webpage, and can read the control information from the buffer and distribute the control information to the webpage. The page of the webpage game can be used to respond to the control information distributed by the browser. If the third-party application is a game application, it can be compatible with the gamepad 600, read the control information from the buffer, and process that control information.

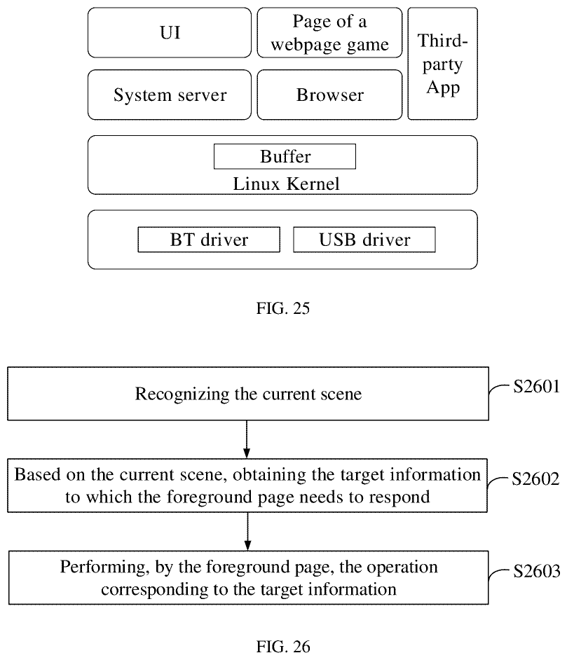

Based on the system architecture shown in FIG. 25, after the display apparatus 200 receives the control information sent from the game device, such as the gamepad 600, the display apparatus 200 writes the control information into the buffer at the kernel layer.

In some embodiments, the display apparatus 200 can respond to the control of the gamepad 600 based on the process shown in FIG. 26 in the following steps.

S2601, recognizing a current scene.

The current scene can include a game scene and a non-game scene.

S2602, based on the current scene, obtaining the target information to which the foreground page needs to respond.

In the game scene, the display apparatus 200, after listening to that control information is written into the buffer, can directly read the control information from the buffer, which is the target information.

In a non-game scene, the display apparatus 200, after listening to that control information is written into the buffer, can directly read the control information from the buffer and convert the read control information into a first key value, which belongs to a key value mapping table preset within the display apparatus 200, and the first key value is the target information.

S2603, performing, by the foreground page, the operation corresponding to the target information.

In a game scene, a first operation corresponding to the control information is performed by the game page. That is, in the game scene, the game page can perform the first operation corresponding to the control information in response to the raw data (control information) from the gamepad 600. Based on the system architecture shown in FIG. 25, it can be understood that after the control information is written into the buffer in the kernel layer, the path for the system service and the browser to read the control information is: to read the control information directly from the buffer without passing through the middleware layer, which can effectively shorten the path for reading the control information, and thus shorten the time duration for the game page to obtain the control information, and effectively improve the efficiency of the game page responsive to the control information, namely effectively improving the response speed to the control of the gamepad 600.

In the non-game scene, a second operation corresponding to the first key value is performed by the non-game page. That is, in the non-game scene, the raw data (control information) sent from the gamepad 600 can be first converted into a key value that the non-game page supports processing, and then the non-game page responds to the key value to perform the corresponding second operation. In this way, not only the efficiency of reading the control information can be improved, but also the non-game page can be made to respond to the control information, i.e., respond to the control of the gamepad 600 in the non-game scene, as well as the response speed to the control of the gamepad 600 can be improved.

In some embodiments of the present disclosure, the display apparatus 200 can support responding to the gamepad 600 under the webpage game and the third-party game application.

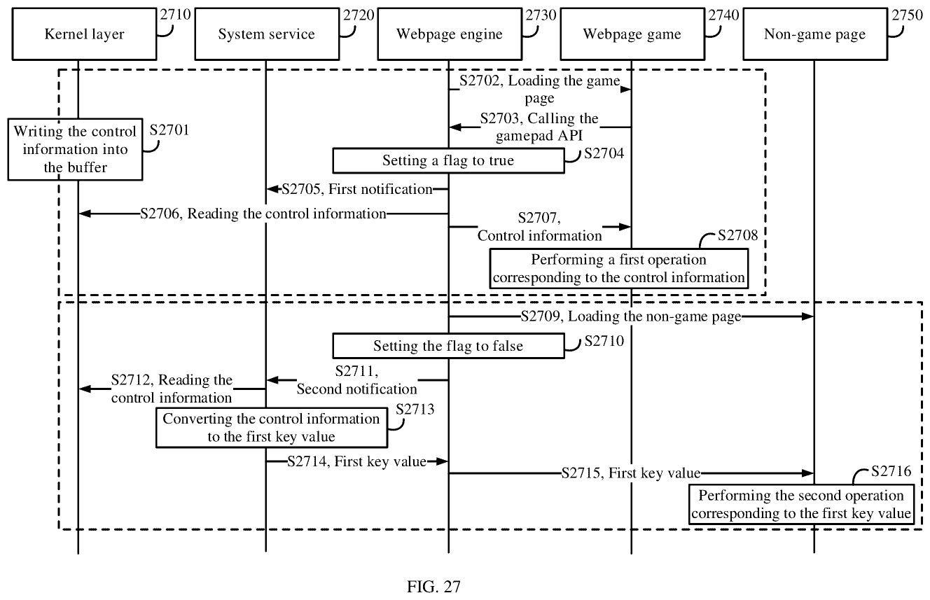

The process of the display apparatus 200 responding to the control of the gamepad 600 while running a webpage game is illustrated in combination with FIG. 27.

The display apparatus 200, after accessing the gamepad 600, can receive the control information sent from the gamepad 600. At step S2701, the display apparatus 200 can write the control information into the buffer via the kernel layer 2710. At step S2702, the display apparatus 200 can load the game page via the webpage engine 2730 to access the webpage game. The display apparatus 200, before or after accessing the gamepad 600, can start the webpage game.

The current scene can be recognized by the webpage engine.

In some embodiments, at step S2703, when the game page is in the foreground, the game page can call the gamepad interface (gamepad API) of the webpage engine to obtain the control information sent from the gamepad 600. The webpage engine can determine that it is currently in a game scene based on the call request. If the webpage engine does not receive the call request, or detects that the gamepad interface stops being called after receiving the call request, it can be determined that it is currently in a non-game scene.

The webpage engine, based on the current scene, can obtain the target information to which the foreground page needs to respond.

In the game scene, i.e., after the webpage engine receives the call request from the game page, the webpage engine can open a thread to listen to whether the control information sent from the gamepad 600 is written into the buffer. At step S2704, the webpage engine can set an associated flag bit (flag) to true, which represents that the game page expects to respond to the raw data (control information) from the gamepad 600.

At step S2705, the webpage engine can send a first notification to the system service 2720, the first notification including distribution of the control information by the webpage engine. The system service, based on the first notification, can stop reading the control information from the buffer, or discard the control information after reading the control information from the buffer. Discarding the control information by the system service can include not converting the control information to the first key value and not distributing the control information, or converting the control information to the first key value and not distributing the first key value. At step S2706, the webpage engine can read the control information from the buffer after listening to that the control information is written into the buffer. At step S2707, the webpage engine, after reading the control information, can send the control information to the game page of the webpage game 2740.

At step S2708, a first operation corresponding to the control information is performed by the game page, thereby realizing that the user controls the operation on the webpage game via the gamepad 600.

In a non-game scene, at step S2709, the webpage engine can load the non-game page 2750. In a non-game scene, the webpage engine does not receive a call request from the game page, or, after receiving the call request, detects that the interface ceases to be called. At step S2710, the webpage engine can set an associated flag bit to false, which represents that the non-game page expects to respond to the key value.

At step S2711, the webpage engine can send a second notification to the system service, the second notification including distribution of control information via the system service. At step S2712, the system service, based on the second notification, can listen to whether the control information is written into the buffer, and read the control information from the buffer after listening to that the control information is written into the buffer. At step S2713, the system service, after reading the control information, can convert the control information to the first key value. At step S2714, the system service can distribute the first key value to the webpage engine. At step S2715, the webpage engine, after receiving the first key value, can send the first key value to the non-game page.

The webpage engine can stop listening to the control information written into the buffer; or, the webpage engine can listen to whether the control information is written into the buffer, and does not read the control information even if it listens to that the control information is written into the buffer; or, the webpage engine can listen to whether the control information is written into the buffer and, and after listening to that the control information is written into the buffer, read the control information but does not send the control information to the non-game page.

At step S2716, the second operation corresponding to the first key value is performed by the non-game page, thereby realizing that the user controls the operation on the non-game page via the gamepad 600.

The processes of loading the game page and loading the non-game page can be arranged in any time order.

In the above process, the system service can always listen to whether the second key value sent from the control device 100 is received, and after listening to the second key value, can send the second key value to the webpage engine. The webpage engine can send the second key value to the foreground page (the game page or the non-game page), and the foreground page can perform the operation corresponding to the second key value. As a result, the operation on the foreground page by the user via the control device 100 can be realized.

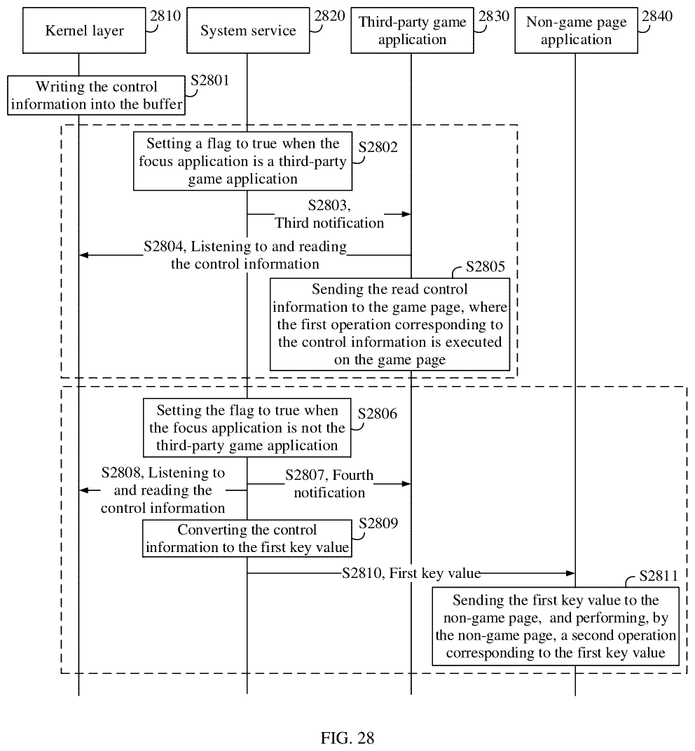

The process of the display apparatus 200 responding to the control of the gamepad 600 while running a third-party game application is illustrated in combination with FIG. 28.

At step S2801, the display apparatus 200, after accessing the gamepad 600, can receive the control information sent from the gamepad 600 and writes the control information into the buffer by the kernel layer 2810. The display apparatus 200, before or after accessing the gamepad 600, can access the third-party game application 2830.

The current scene can be recognized by a system service.

In some embodiments, the system service can obtain application information, such as an application name, of the focus application, that currently gains the focus, and compare the application name of the focus application with the application name of the third-party game application to determine whether the third-party game is a focus application. If the third-party game application is the focus application, the system service can determine that it is currently in a game scene; and if the third-party game application is not the focus application, the system service can determine that it is currently in a non-game scene.

The system service, based on the current scene, can obtain the target information to which the foreground page needs to respond.

In the game scene, at step S2802, after the system service 2820 recognizes that the focus application is a third-party game application, the system service can set an associated flag bit (flag) to true, which represents that the focus application expects to respond to the raw data (control information) of the gamepad 600. At step S2803, the system service can send a third notification to the third-party game application. The third notification can include reading the control information by the third-party game application. At step S2804, the third-party game application, based on the third notification, can listen to whether the control information from the gamepad 600 is written into the buffer, and read the control information after listening to that the control information is written into the buffer. At step S2805, the read control information is sent from the third-party game application to the game page, and the first operation corresponding to the control information is executed on the game page, thereby realizing the operation of the user controlling the third-party game application via the gamepad 600. The system service may not start, or after starting, stop listening to the control information written into the buffer; or, the system service can listen to whether the control information is written into the buffer, and does not read the control information even if it listens to that the control information is written into the buffer; or, the system service can listen to whether the control information is written into the buffer, and after listening to that the control information is written into the buffer, read the control information but discard the control information. Discarding the control information by the system service can include not converting the control information to the first key value and not distributing the control information, or converting the control information to the first key value and not distributing the first key value.

In the non-game scene, at step S2806, after the system service recognizes that the focus application is not the third-party game application, the system service can open a thread to listen to whether the control information sent from the gamepad 600 is written into the buffer, and set the associated flag bit (flag) to false, which can mean that the focus application expects to respond to the key value. The system service can send a fourth notification to the third-party game application, wherein the fourth notification can include distribution of the key value by the system service. At step S2807, the third-party game application, based on the fourth notification, does not start, or after starting, can stop listening to the control information written into the buffer; or, the third-party game application can listen to whether the control information is written into the buffer, and does not read the control information even if it listens to that the control information is written into the buffer; or, the third-party game application can listen to whether the control information is written into the buffer, and after listening to that the control information is written into the buffer, read the control information but does not respond to the control information.

At step S2808, the system service can listen to that the control information is written into the buffer and read the control information. At step S2809, the system service can convert the read control information to a first key value. At step S2810, the system service can send the first key value to the focus application (e.g., non-game application 2840). The received first key value is transmitted to the non-game page by the focus application.

At step S2811, a second operation corresponding to the first key value is performed by the non-game page, thereby realizing that the user controls the operation on the non-game page via the gamepad 600.

In the above process, the system service can always listen to whether the second key value sent from the control device 100 is received, and after listening to the second key value, regardless of whether the flag bit is true or false, send the second key value to the focus application (the third-party game application or other application). The focus application can send the second key value to the foreground page (the game page or the non-game page), and the foreground page can perform the operation corresponding to the second key value. Thus, the operation on the foreground page by the user via the control device 100 can be realized.

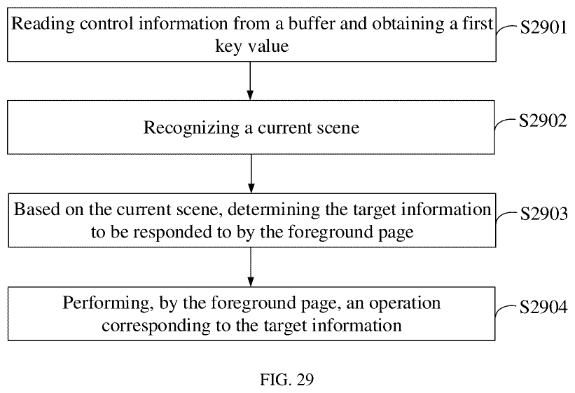

In some embodiments, the display apparatus 200 can respond to the control of the gamepad 600 based on the flow shown in FIG. 29 in the following steps.

S2901, reading control information from a buffer and obtaining a first key value.

The display apparatus 200, after listening to that control information is written into the buffer, can read the control information from the buffer, and convert the read control information into the first key value. The display apparatus 200 can hold both the control information and the first key value.

S2902, recognizing a current scene.

The current scene can include a game scene and a non-game scene.

S2903, based on the current scene, determining the target information to be responded to by the foreground page.

In the game scene, it can be determined that the control information has been read is the target information.

In the non-game scene, it can be determined that the converted first key value is the target information.

S2904, performing, by the foreground page, an operation corresponding to the target information.

Step S2904 is similar to the step S2603 and is not described herein.

Based on steps S2901-S2904, the process of converting the control information that has been read into the first key value is parallel to the process of recognizing the scene without waiting for the recognition result of the scene, which can further shorten the time duration of the reception of the target information by the foreground page, and thus further improve the response speed of the foreground page to the control of the gamepad 600.

In some embodiments of the present disclosure, the display apparatus 200 can support the response to the gamepad 600 under the webpage game and the third-party game application.

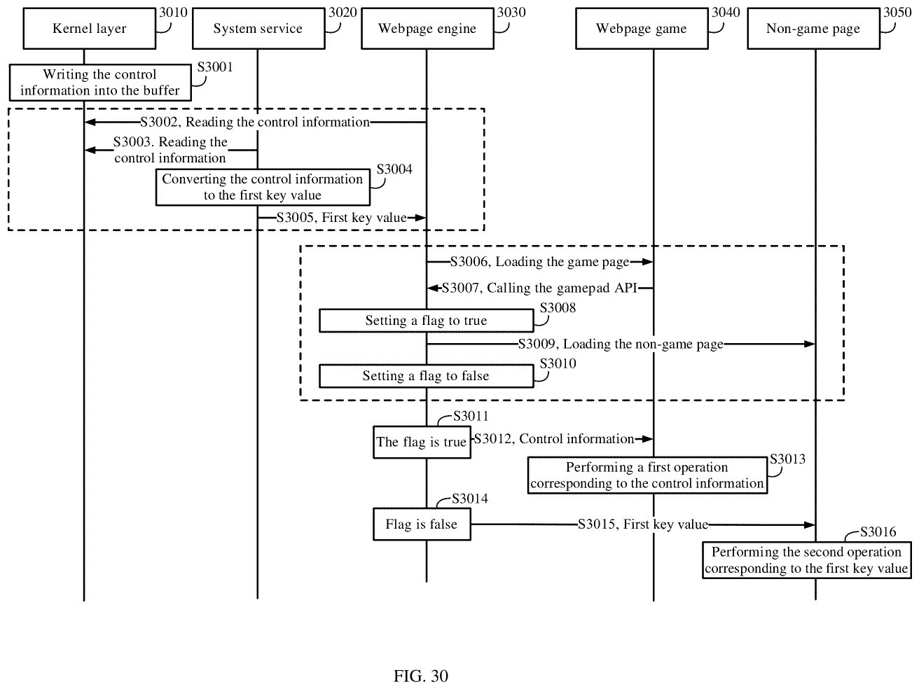

The process of the display apparatus 200 responding to the control of the gamepad 600 while running a webpage game is illustrated in combination with FIG. 30.

At step S3001, the display apparatus 200, after accessing the gamepad 600, can receive control information from the gamepad 600 and writes the control information into the buffer by the kernel layer 3010. The display apparatus 200 can load the webpage via the webpage engine 3030 to access the webpage game. The display apparatus 200, before or after accessing the gamepad 600, can start the webpage game.

At step S3002, the control information is read from the buffer by the webpage engine. A first key value is obtained by the system service 3020.

After accessing the gamepad 600, or after entering the web application, the webpage engine can open a thread to listen to whether the control information from the gamepad 600 is written into the buffer. After accessing the gamepad 600, the system service can open a thread to listen to whether the control information from the gamepad 600 is written into the buffer.

After the webpage engine listens to that the control information is written into the buffer, the webpage engine can obtain the control information from the buffer. At step S3003, after the system service listens to that control information is written into the buffer, the system service can read the control information from the buffer. At step S3004, the system service automatically can convert the control information to the first key value. At step S3005, the system service distributes that first key value to the webpage engine. The control information and the first key value can be managed by the webpage engine.

The webpage engine can recognize the current scene.

The process of the webpage engine recognizing the current scene can be referred to the process of the webpage engine recognizing the current scene in the process shown in FIG. 27, which is not described herein. Therefore, for step S3006 and step S3007, please refer to step S2702 and step S2703 in FIG. 27.

The target information to be responded to by the foreground page can be determined by the webpage engine based on the current scene.

In the game scene, at step S3008, the webpage engine can set an associated flag bit (flag) to true. At step S3011, after the webpage engine receives a call request from the game page, if the webpage engine recognizes that the first key value is obtained by the conversion of the control information and recognizes that the flag bit is true, it executes step S3012, and can determine that the foreground page is a game page and determine that the target information to which the foreground page needs to respond is the control information. The webpage engine can discard the first key value. At step S3012, the webpage engine can transmit the control information to the game page of the webpage game 3040.

At step S3013, a first operation corresponding to the control information is performed by the game page, thereby realizing that the user controls the operation on the webpage game via the gamepad 600.

In a non-game scene, at step S3009, the webpage engine can load the non-game page 3050. At step S3010, the webpage engine can set an associated flag bit (flag) to false, which represents that the non-game page expects to respond to the key value. That is, after the webpage engine does not receive a call request from the game page, or, after receiving the call request, detects that the interface ceases to be called, at step S3014, the webpage engine can recognize that the flag bit is false, then performs step S3015, in which it can determine that the foreground page is a non-game page, and determine that the target information that the foreground page is expected to respond to is the first key value. As a result, the webpage engine can discard the control information. At step S3015, the webpage engine can transmit the first key value to the non-game page 3050.

At step S3016, a second operation corresponding to the first key value can be performed by the non-game page, thereby realizing that the user controls the operation on the non-game page via the gamepad 600.

In the above process, the system service can always listen to whether the second key value sent from the control device 100 is received, and after listening to the second key value, send the second key value to the webpage engine. The webpage engine, if it recognizes that the second key value is a key value from the control device 100, can send the second key value to the foreground page (the game page or the non-game page) regardless of whether the flag bit is true or false, and the foreground page can perform the operation corresponding to the second key value. Thus, the operation on the foreground page by the user via the control device 100 can be realized.

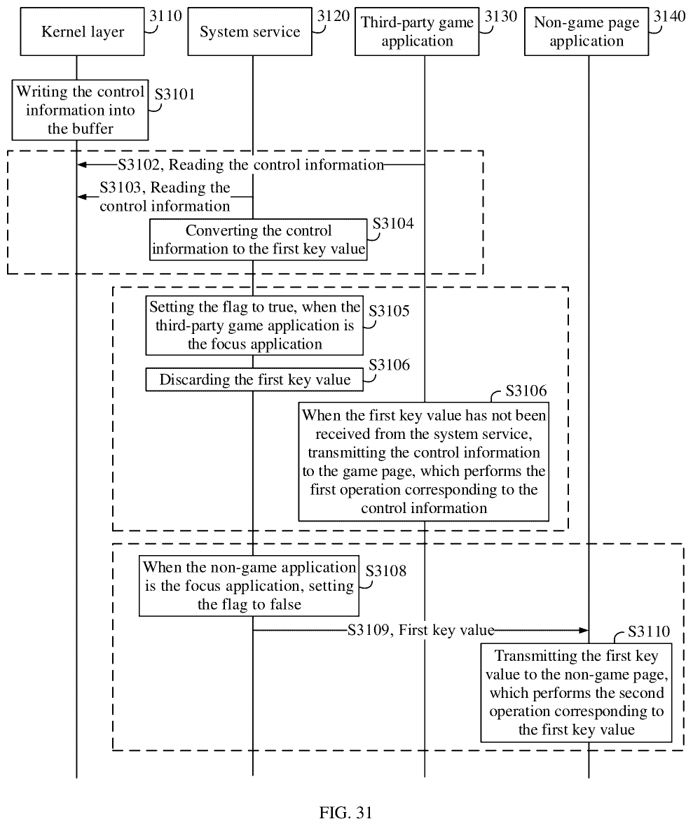

The process of the display apparatus 200 responding to the control of the gamepad 600 while running a third-party game application is illustrated in combination with FIG. 31.

The display apparatus 200, after accessing the gamepad 600, can receive control information s from the gamepad 600. At step S3101, the control information is written into the buffer by kernel layer 3110. The display apparatus 200, before or after accessing the gamepad 600, can access the third-party game application.

At step S3102, the control information is read from the buffer by the third-party game application 3130. A first key value is obtained by a system service.

After accessing the third-party game application, the third-party game application can open a thread to listen to whether the control information from the gamepad 600 is written into the buffer. After accessing the gamepad 600, the system service 3120 can open a thread to listen to whether the control information from the gamepad 600 is written into the buffer.

After the third-party game application listens to that the control information is written into the buffer, the third-party game application can obtain the control information from the buffer. At step S3103, after the system service listens to that control information is written into the buffer, the system service can read the control information from the buffer. At step S3104, the system service, after reading the control information, can automatically convert the control information to the first key value. If the focus application is a game application, the focus application can hold the control information; and if the focus application is a non-game application, the focus application does not hold the control information and the first key value.

The current scene is recognized by the system service.

The process of recognizing the current scene via the system service can be referred to the process of recognizing the current scene by the system service in the process shown in FIG. 28, which is not described herein. The system service can set an associated flag bit based on the recognition result. At step S3105, the system service 3120 can recognize that the third-party game application 3130 is the focus application, and set the flag to true. At step S3108, the system service 3120 can recognize that the non-game application 3130 is the focus application, and set the flag to false. For example, if it is recognized as being in a game scene, the flag bit is set to true; and if it is recognized as being in a non-game scene, the flag bit is set to false.

The system service, based on the current scene, can determine the target information to be responded to by the foreground page.

In the game scene, i.e., where the system service can recognize that the flag bit is true, it can be determined that the foreground page is a game page, and that the target information to be responded to by the foreground page is the control information. That is, at step S3106, the system service can discard the first key value. At step S3107, the third-party game application, after determining that it has not received the first key value from the system service, can transmit the control information to the game page, which performs the first operation corresponding to the control information. This realizes that the user controls the operation on the third-party game application via the gamepad 600.

In a non-game scene, i.e., where the system service can recognize that the flag bit is false, it can be determined that the foreground page is a non-game page and that the target information to be responded to by the foreground page is the first key value. Thereby, at step S3109, the system service can transmit the first key value to the focus application (i.e., the non-game application 3140). At step S3110, the focus application (i.e., the non-game application 3140), after receiving the first key value, can transmit the first key value to the non-game page, which performs the second operation corresponding to the first key value. This realizes that the user controls the operation on the non-game page through the gamepad 600.

In the above process, the system service can always listen to whether the second key value from the control device 100 is received, and after listening to the second key value, send the second key value to the focus application (the third-party game application or other application) regardless of whether the flag bit is true or false. The focus application can send the second key value to the foreground page (the game page or the non-game page), and the foreground page can perform the operation corresponding to the second key value. Thus, the operation on the foreground page by the user via the control device 100 can be realized.

In the above embodiments, the control information can include the first coordinate value corresponding to the first position in the preset coordinate system after the joystick is moved, and the key value of the first key on the gamepad 600. The system service can convert the control information to the corresponding first key value according to the different control information.

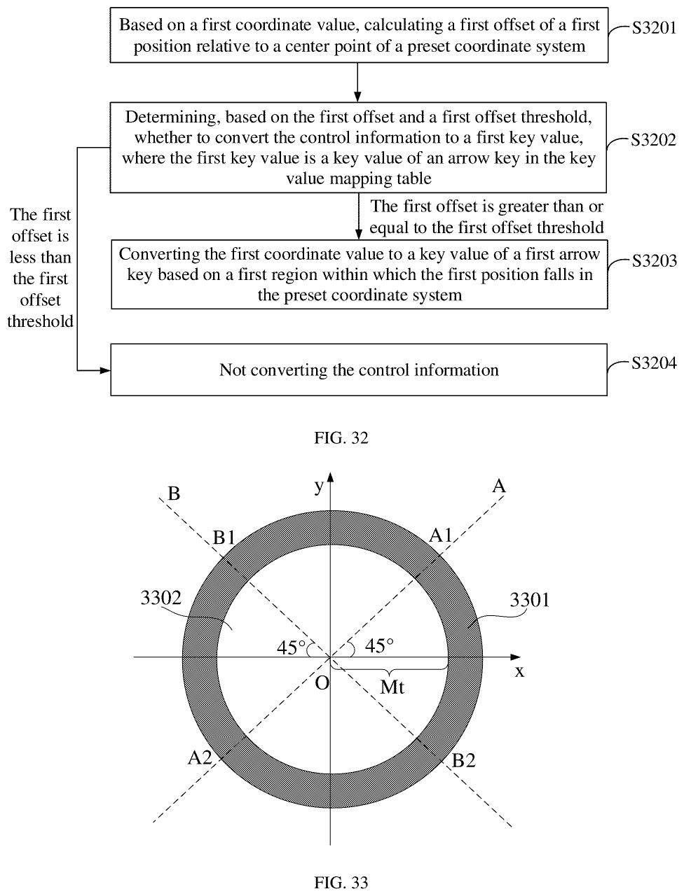

If the control information is the first coordinate value corresponding to the first position in the preset coordinate system after the joystick is moved, in the display apparatus 200, the system service can convert the control information based on the process shown in FIG. 32 in the following steps.

S3201, based on a first coordinate value, calculating a first offset of a first position relative to a center point of a preset coordinate system.

The first offset is a straight-line distance between the first position and the center point, and the first offset can be calculated according to the following formula:

$$z = \sqrt[2]{{x}^{2} + {y}^{2}} .$$

In which, x represents a coordinate x in the first coordinate value, y represents a coordinate y in the first coordinate value, and z represents the first offset.

S3202, determining, based on the first offset and a first offset threshold, whether to convert the control information to a first key value, where the first key value is a key value of an arrow key in the key value mapping table.

If the control information is the first coordinate value, it can mean that the user wants to send a movement command to the display apparatus 200 by moving the joystick in a target direction, and the movement command indicates to move in the target direction. Thus, the first key value corresponding to the first coordinate value is a key value of an arrow key that corresponds to the target direction.

In some embodiments, if the first offset is greater than 0, a movement of the joystick has occurred, which can trigger the task of converting that first coordinate value to the first key value. In this way, it is possible to respond to the user's subtle manipulation and improve the sensitivity of the response.

In other embodiments, whether to convert the first coordinate value to the first key value is determined based on the first offset and the first offset threshold.

S3203, if the first offset is greater than or equal to the first offset threshold, converting the first coordinate value to a key value of a first arrow key based on a first region to which the first position belongs in the preset coordinate system.

If the first offset is greater than or equal to the first offset threshold, it can mean that the distance between the joystick and the center point is larger, and the movement of the joystick is not a slight wobble, but is a result of the user's conscious movement. In this way, the first coordinate value is converted to the key value of the first arrow key, and a direction indicated by the key value of the first arrow key is the same as a direction corresponding to the first region, so that the display apparatus 200 can accurately respond to the control of the gamepad 600.

Taking the preset coordinate system shown in FIG. 33 as an example, the center point is O and the first offset threshold is Mt. If the first offset z is greater than or equal to Mt, the first position is located in the annular region 3301 (shown in gray), triggering the task of converting the first coordinate value to the key value of the first arrow key.

The preset coordinate system can include a plurality of preset regions, each of which corresponds to a direction, and each direction corresponds to a key value of an arrow key in the key value mapping table. For example, the preset coordinate system can include four preset regions corresponding to up, down, left, and right. The preset regions can be divided based on the body structure of the gamepad 600 and/or the user's operating habits, and the preset regions can correspond to an angular range of the same size, or can correspond to angular ranges of different sizes. Taking the preset coordinate system shown in FIG. 33 as an example, the preset coordinate system is divided by a straight line A and a straight line B passing through a center point and each having an angle of 45° with the coordinate axis. The intersection points of the straight line A and the movement range is A1 and A2, respectively, and the intersection points of the straight line B and the movement range is B1 and B2, respectively. A region S1 located between OA1 and OB1 corresponds to up, a region S2 located between OA2 and OB2 corresponds to down, a region S3 located between OA2 and OB1 corresponds to left, and a region S4 located between OA1 and OB2 corresponds to right. The region S1, region S2, region S3, and region S4 correspond to the angular range of the same size, all of which are 90°.

In the conversion process, the system service can determine, based on the first coordinate value, the first region within which the first position falls in the preset coordinate system, the first region falling within the preset region, and determine a corresponding direction based on the first region, and thus determine a key value of an arrow key corresponding to the direction in the key value mapping table. Taking the preset coordinate system shown in FIG. 33 as an example, if it is determined that the first position is located in the region S1 based on the first coordinate value, it can be determined that the corresponding direction is up, and thus it can be determined that the key value of the arrow key in the key value mapping table is KEY_UP, which will be used as the first key value.

S3204, if the first offset is less than the first offset threshold, not converting the control information.

If the first offset is less than the first offset threshold, it can mean that the movement of the joystick belongs to a slight wobble and is not the result of the user's conscious movement. In this way, the task of converting the first coordinate value is not triggered to be compatible with the slight wobble of the joystick and to avoid jitter generated in response to the slight wobble of the joystick.

Taking the preset coordinate system shown in FIG. 33 as an example, if the first offset z is less than Mt, the first position is located within the region 3302 (shown in white) and the task of converting the first coordinate value is not triggered.

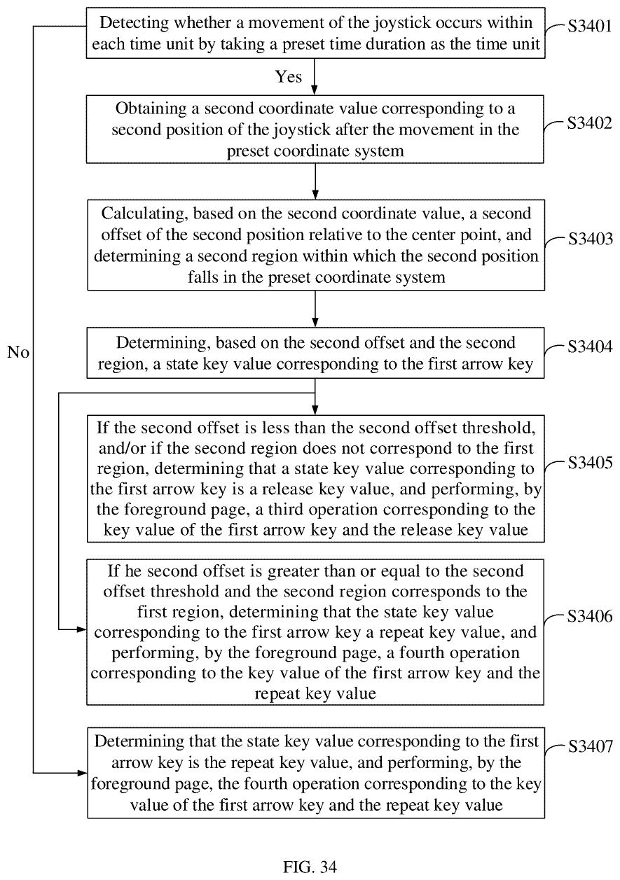

In some embodiments, based on step S3203, after converting the first coordinate value to the key value of the first arrow key, in the display apparatus 200, the system service can determine the state key value of the first arrow key based on the process illustrated in FIG. 34 in the following steps.

S3401, detecting whether a movement of the joystick occurs within each time unit by taking a preset time duration as the time unit.

The joystick can be configured to have an automatic reset function, and after the joystick moves to the first position, if the user does not apply a force to the joystick, the joystick will automatically move to a center point position.

The joystick can be configured to not have an automatic reset function, that is, each movement of the joystick is dependent on the force applied by the user.

S3402, if the movement occurs, obtaining a second coordinate value corresponding to a second position of the joystick after the movement in the preset coordinate system.

Based on step S3402, steps S3403-S3406 can be performed.

S3403, calculating, based on the second coordinate value, a second offset of the second position relative to the center point, and determining a second region within which the second position falls in the preset coordinate system.

At step S3403 is similar to steps S3201 and S3203 and is not described herein.

S3404, determining, based on the second offset and the second region, a state key value corresponding to the first arrow key.

The state key value of the arrow key is used for the state of the arrow key, and the state key value can include a press key value, a release key value, and a repeat key value. The display apparatus 200 can perform a corresponding operation according to the state key value, e.g., send the key value of the current arrow key based on “press”, release the key value of the current arrow key based on “release”, and repeatedly send the key value of the current arrow key based on “repeat”.

S3405, if the second offset is less than the second offset threshold, and/or if the second region does not correspond to the first region, determining that a state key value corresponding to the first arrow key is a release key value, and performing, by the foreground page, a third operation corresponding to the key value of the first arrow key and the release key value.

In some embodiments, the second offset threshold is equal to the first offset threshold. Taking the preset coordinate system shown in FIG. 33 as an example, if the second offset z′ after the joystick is moved again is less than the second offset threshold, the joystick after being moved again is not within the annular region 3301, and the task of converting the second coordinate value to the key value of the arrow key is not triggered, that is, the display apparatus 200 does not respond to the movement action of the joystick. Accordingly, the state key value of the first arrow key is determined as the release key value to indicate releasing the key value of the first arrow key.

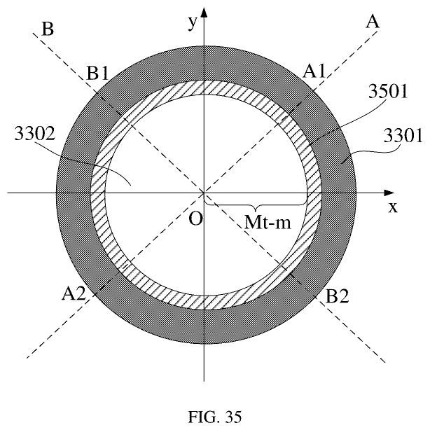

In other embodiments, the second offset threshold is smaller than the first offset threshold. Taking the preset coordinate system shown in FIG. 35 as an example, which can include a second offset threshold of Mt−m as compared to the preset coordinate system shown in FIG. 33, that is, the annular region based on the second offset threshold is expanded by the annular region 3501 (illustrated with a shaded) as compared to the annular region 3301 based on the first offset threshold. If the second offset z′ after the joystick is moved again is smaller than the second offset threshold, the joystick after being moved again is not within the annular region formed based on the second offset threshold, and the task of converting the second coordinate value to the key value of the arrow key is not triggered, that is, the display apparatus 200 does not respond to the movement action of the joystick. Accordingly, the state key value of the first arrow key is determined as the release key value to indicate that the response to the key value of the first arrow key is stopped.

The second region and the first region can be used to determine whether the direction corresponding to a region to which the joystick belongs changes after the joystick is moved again. If the second region does not correspond to the first region, the corresponding direction changes; and if the second region corresponds to the first region, the corresponding direction does not change. If the corresponding direction is changed, it can mean that the changed direction no longer corresponds to the key value of the first arrow key, and the state key value of the first arrow key can be determined as the release key value to indicate releasing the key value of the first arrow key.

The foreground page, after receiving the release key value, can perform a third operation, such as ending the movement in the direction indicated by the first arrow key, based on the key value of the first arrow key and the release key value.

S3406, if the second offset is greater than or equal to the second offset threshold and the second region corresponds to the first region, determining that the state key value corresponding to the first arrow key a repeat key value, and performing, by the foreground page, a fourth operation corresponding to the key value of the first arrow key and the repeat key value.

In some embodiments, the second offset threshold is equal to the first offset threshold. Taking the preset coordinate system shown in FIG. 33 as an example, if the second offset z′ after the joystick is moved again is greater than or equal to the second offset threshold, then the joystick after being moved again is still located in the annular region 3301, and the task of converting the second coordinate value to the key value of the arrow key can still be triggered. That is, the display apparatus 200 needs to respond to the movement action of the joystick.

In other embodiments, the second offset threshold is less than the first offset threshold. Taking the movement range of the joystick shown in FIG. 35 as example, if the second offset z′ after the joystick is moved again is greater than or equal to the second offset threshold, then even if the joystick after being moved again is not located within the annular region 3301, as long as the joystick after being moved again is located within the annular region 3501, the task of converting the second coordinate value to the key value of the arrow key is still triggered, that is, the display apparatus 200 still needs to respond to the movement action of the joystick.

In some scenarios, if the previous position of the joystick is located within the annular region 3301 and close to the boundary of the circle formed with the first offset threshold, the position of the joystick after the movement of the joystick is prone to move out of the annular region 3301 when the joystick undergoes a slight wobble. Whereas if the joystick wobbles slightly again, it can return to the annular region 3301, that is, the position of the joystick can move back and forth within and outside the boundary of the circle formed with the first offset threshold, which can lead to the problem with frequently releasing and retransmitting the key value of the first arrow key. By expanding the annular region after the joystick is first moved to the annular region 3301 and determining whether to release the key value of the first arrow key based on the expanded annular region (i.e., the second offset threshold), it is possible to effectively reduce the number of times determining that the first arrow key is in a release state due to the joystick moving out of the annular region 3301 responding to the slight wobble, and to reduce the number of times resending the key value of the first arrow key due to the joystick moving back into the annular region 3301 again responding to the slight wobble, which in turn allows for better compatibility with the slight wobble of the joystick at the boundary of the circle formed with the first offset threshold.

If the second region corresponds to the first region, it can mean that the changed direction still corresponds to the key value of the first arrow key.

Within the preset time duration, if it is determined that the position of the joystick after being moved again can still trigger the task of converting the key value and the corresponding direction has not changed, the state key value of the first arrow key can be determined as the repeat key value to indicate a continuous response to the key value of the first arrow key.

The foreground page, after receiving the repeat key value, can perform a fourth operation, such as moving continuously in the direction indicated by the first arrow key, based on the key value of the first arrow key and the repeat key value.

S3407, if the movement does not occur, determining that the state key value corresponding to the first arrow key is the repeat key value, and performing, by the foreground page, the fourth operation corresponding to the key value of the first arrow key and the repeat key value.

If the movement has not occurred, the position of the joystick after being moved again within the preset time duration can still trigger the task of converting the key value, and the corresponding direction has not changed, and the state key value of the first arrow key can be determined as the repeat key value to indicate a continuous response to the key value of the first arrow key.

The foreground page, after receiving the repeat key value, can perform a fourth operation, such as moving continuously in the direction indicated by the first arrow key, based on the key value of the first arrow key and the repeat key value.

In some embodiments, among the same set of N (N is a positive integer greater than 0) time units, the first time unit can correspond to a preset time duration longer than preset time durations corresponding to the other time units. After determining that the state key value corresponding to the first arrow key is the release key value, the next set of time units is turned on.

For example, after executing step S3203, a first time unit in a set of time units is turned on, and a preset time duration of the first time unit can be T_first, which can be realized by a timer. If step S3405 is executed within T_first, and then the set of time units is terminated. After terminating the set of time units, if step S3203 is executed again, another set of time units is turned on. If step S3406 is executed within T_first, other time units in the another set of time units can be turned on, and a preset time duration of each of the other time units can be T_repeat. T_repeat and T_first can be set floatingly on a base of 300 milliseconds, where T_repeat<T_first If step S3405 is executed within T_repeat, the another set of time units is terminated. After terminating the another set of time units, if step S3203 is executed again, yet another set of time units is turned on. If step S3406 is executed within T_repeat, other time units in the yet another set of time units continue to be turned on until step S3405 is performed within T_repeat.

Since the preset time duration of the first time unit is longer than the preset time durations of the other time units, when the foreground page performs the fourth operation, the user can perceive that there is a pause in the foreground page after the foreground page executes one moving operation, and then that the foreground page can start executing the moving operation continuously.

In some embodiments, during the execution of step S3405, if the second region does not correspond to the first region and the second offset is greater than or equal to the first offset threshold, a task of converting the second coordinate value to a key value of a second arrow key is triggered, which process can be referred to at step S3203 and will not be described herein. The foreground page can perform an operation corresponding to the key value of the second arrow key.

In other embodiments, during the execution of step S3405, if the second region does not correspond to the first region and the second offset is greater than or equal to the first offset threshold, the key value of the first arrow key is released, but the task of converting the second coordinate value to the key value of the second arrow key is not triggered, that is, the foreground page is not responded to the moving operation. If no movement of the joystick occurs or the movement of the joystick occurs again within the time unit turned on again, if the offset of the position after the movement is greater than or equal to the first offset threshold, and if the region to which the position after the movement belongs corresponds to the second region, then the task of converting the second coordinate value to the key value of the second arrow key is triggered. In some embodiments, after converting the second coordinate value to the key value of the second arrow key, a response can be made based on steps S3401-S3407. In this way, a second time unit of the N time units in the same set can be taken as the first time unit, and the time duration of the second time unit can be dynamically prolonged so that the user can perceive a pause in the continuous moving process.

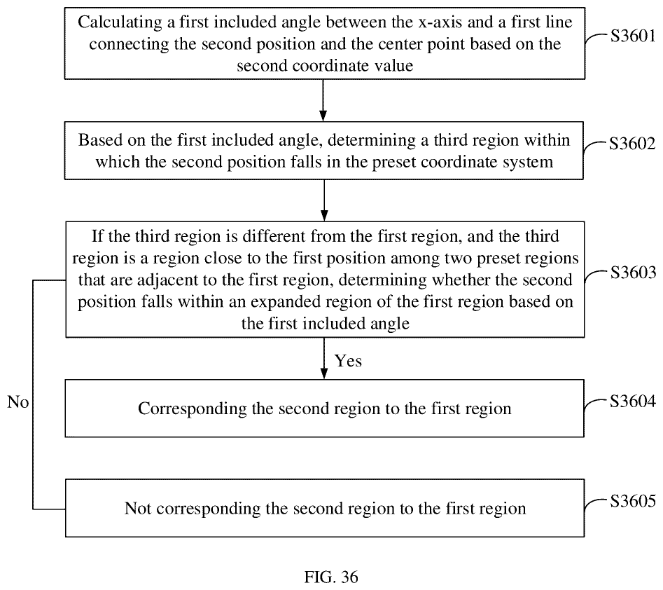

In some embodiments, in the display apparatus 200, the system service can determine whether the first region corresponds to the second region based on the flow shown in FIG. 36 in the following steps.

S3601, calculating a first included angle between the x-axis and a first line connecting the second position and the center point based on the second coordinate value.

The first included angle can be calculated according to the following formula:

$$α = arctan \frac{\vert y \vert}{\vert x \vert} .$$

Where, x represents a coordinate x in the second coordinate value, y represents a coordinate y in the second coordinate value, and a represents the first included angle.

S3602, based on the first included angle, determining a third region within which the second position falls in the preset coordinate system.

The third region is a preset region in the preset coordinate system.

Taking the preset coordinate system shown in FIG. 33 as an example, if α>45° and y>0, the second position falls within a region S1; if α>45° and y<0, the second position falls within a region S2; if α<45° and x<0, the second position falls within a region S3; and if α<45° and x>0, the second position falls within a region S4. The third region can be the region S1, region S2, region S3, or region S4.

S3603, if the third region is different from the first region, and the third region is a region close to the first position among two preset regions that are adjacent to the first region, determining whether the second position falls within an expanded region of the first region based on the first included angle.

The first region within which the first position falls can be determined based on the first coordinate value, and the process can be referred to at step S1502, which will not be repeated here. The first region can be the region S1, region S2, region S3, or region S4.

If the third region and the first region are the same one region, the third region is the same as the first region; and if the third region and the first region are not the same one region, the third region is different from the first region.

If the third region and the first region are the same, the third region is the second region, and the second region corresponds to the first region.

If the third region is different from the first region, and the third region is a region close to the first position among two preset regions that are adjacent to the first region, it is necessary to further determine whether the second position falls within an expanded region of the first region based on the first included angle.

For example, the first region is a region S1, and the two preset regions that are adjacent to the first region are a region S3 and a region S4. Assuming that the first position is closer to the region S4, if the third region is not the region S4, the third region is the second region, and the second region does not correspond to the first region; and if the third region is the region S4, it is to be further determined based on the first included angle.

When determining the direction corresponding to the second position, the angular range of the first region within which the first position falls is expanded to obtain an expanded region of the first region.

If the first position is in the vicinity of a boundary line between the first region and a region adjacent to the first region, the position of the joystick can move back and forth between the first region and the region adjacent to the first region when the joystick undergoes a slight wobble., resulting in frequently and alternately sending of key values of the arrow keys corresponding to the two regions. The foreground page responding to the frequently and alternately receiving of the key values of the two arrow keys will appear to be jittery. After the joystick is moved to the first region for the first time, whether the joystick that is moved again indicates a different direction is determined by enlarging the angular range of the first region and using the expanded region of the first region as a reference, which can effectively reduce the number of times determining to indicate a new direction due to the slight wobble of the joystick alternating between the first region and the region adjacent to the first region, which can then be better compatible with the slight wobble of the joystick at the boundary line between the first region and the region adjacent to the first region.

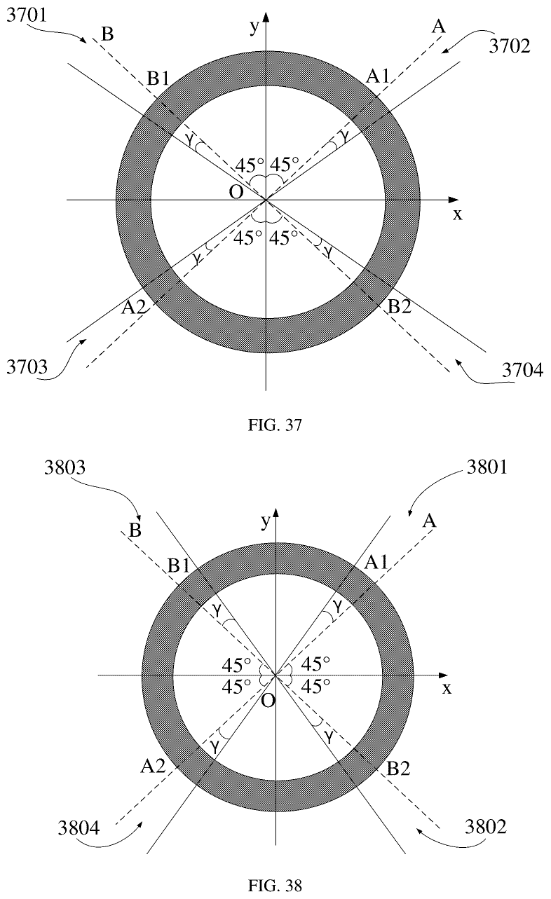

Taking the preset coordinate system shown in FIG. 37 as an example, compared to the preset coordinate system shown in FIG. 33, if the first region is the region S1 or the region S2, the expanded region of the first region corresponds to an angular magnitude of γ°. For example, the expanded region of the region S1 can include a region 3701 and a region 3702, where the region 3701 falls within the region S3, the region 3702 falls within the region S4, and the corresponding angular magnitudes of the region 3701 and the region 3702 can be both γ°. The expanded region of the region S2 can include a region 3703 and a region 3704, where the region 3703 falls within the region S3, the region 3704 falls within the region S4, and the corresponding angular magnitudes of the region 3703 and the region 3704 are both γ°.

If α<(45+γ)°, the second position falls within the expanded region of the first region, and the second region corresponds to the first region; if α>(45+γ)° and y>0, the second position does not fall within the expanded region of the first region, and the second position falls within the region S1; and if α>(45+γ)° and y<0, the second position does not fall within the expanded region of the first region, and the second position falls within the region S2.

Taking the preset coordinate system shown in FIG. 38 as an example, compared to the preset coordinate system shown in FIG. 33, if the first region is the region S3 or the region S4, the expanded region of the first region corresponds to an angular magnitude of γ°. For example, the expanded region of the region S3 can include a region 3801 and a region 3802, where the region 3801 falls within region S1, the region 3802 falls within region S2, and the corresponding angular magnitudes of the region 3801 and the region 3802 can be both γ°. The expanded region of the region S4 can include the region 3803 and the region 3804, where the region 3803 falls within region S1, the region 3804 falls within region S2, and the corresponding angular magnitudes of the region 3803 and the region 3804 can be both γ°.

If α>(45−γ)°, the second position falls within the expanded region of the first region, and the second region corresponds to the first region; if α<(45−γ)° and x>0, the second position does not fall within the expanded region of the first region, and the second position falls within the region S4; and if α<(45−γ)° and x<0, the second position does not fall within the expanded region of the first region, and the second position falls within the region S3.

S3604, if the second position falls within the expanded region of the first region, it is determined that the second region is corresponding to the first region.

If the second position falls within the expanded region of the first region, it can mean that the second position, although located in a region adjacent to the first region, is still located in an expanded region of the expanded first region, and a region within which the second position falls can be redefined as a second region, which is an expanded region of the first region. The second region corresponds to the same direction as the first region, and the second region corresponds to the first region.

S3605, if the second position does not fall within the expanded region of the first region, it is determined that the second region is not corresponding to the first region.

If the second position does not fall within the expanded region of the first region, it can mean that even if the range of the first region is expanded, the second position still does not fall within the expanded region, and a region within which the second position falls can be redefined as a second region, which is a region of the third region that does not fall within the expanded region of the first region. The second region corresponds to a direction different from the first region, and the second region does not correspond to the first region.

If the control information is a key value of a first key on the gamepad 600, in the display apparatus 200, the system service can determine a converted first key value based on the key value of the first key and the key value mapping table, the first key value is a target key value corresponding to the key value of the first key in the key value mapping table. The key value of the first key can include the key value of the arrow keys and the key values of other keys on the gamepad 600, and the pre-stored key value mapping table can include the key value of the second key of the control device 100, the mapping relationship between the operation and the key value of the first key.

Taking the control device 100 as a remote control as an example, the key value mapping table can include the mapping relationship between a key value (KEY_UP) of an up key (second key) of the remote control and a key value (EV_ABS_UP) of an operation (move up) and an up key (first key) of the gamepad 600. The system service, after receiving the EV_ABS_UP from the gamepad 600, can map it to KEY_UP based on the key value mapping table, that is, the target key value is KEY_UP, which in turn can be mapped to the corresponding operation, such as moving upward. KEY_UP is the target information to which the non-game page needs to respond, and the non-game page can perform the second operation, i.e., moving upward, corresponding to KEY_UP.

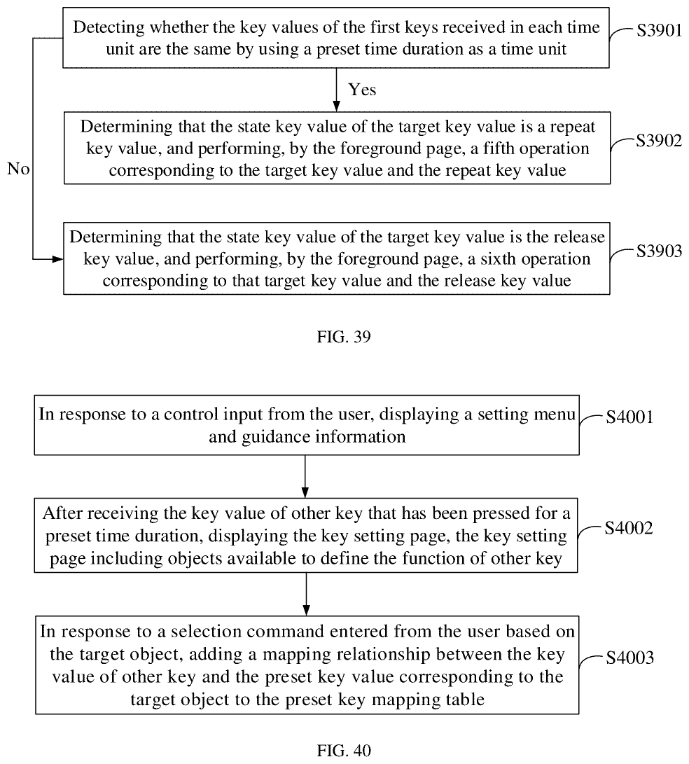

In the display apparatus 200, the system service can respond to the control information of the key input on the gamepad 600 based on the flow shown in FIG. 39 in the following steps.

S3901, detecting whether the key values of the first keys received in each time unit are the same by using a preset time duration as a time unit.

In some embodiments, in the same set of M (M is a positive integer greater than 0) time units, the first time unit can correspond to a preset time duration longer than preset time duration corresponding to the other time units. The time unit of the next set is turned on when the key values of the first keys can be determined to be different.

S3902, if the key values of the first keys are the same, determining that the state key value of the target key value is a repeat key value, and performing, by the foreground page, a fifth operation corresponding to the target key value and the repeat key value.

If the key values of the first keys are all the same, i.e., the user long-presses one key on the gamepad 600 to input control information to the display apparatus 200, the state key value of the target key value is determined to be the repeat key value.

After receiving the repeat key value, the foreground page can perform the fifth operation, such as moving continuously in the direction indicated by the target key value, based on the target key value and the repeat key value.

S3903, if the key values of the first keys are different, determining that the state key value of the target key value is the release key value, and performing, by the foreground page, a sixth operation corresponding to that target key value and the release key value.

If the key values of the first keys are different, i.e., another key on the gamepad 600 that the user switches to press inputs control information to the display apparatus 200, or the user no longer presses the key on the gamepad 600, the state key value of the target key value can be determined to be the release key value.

Upon receiving this release key value, the foreground page can perform the sixth operation, such as ending movement in the direction indicated by the target key value, based on the target key value and the release key value.

In some embodiments, the display apparatus 200 can customize functions of the ordinary keys on the gamepad 600 based on the flow shown in FIG. 40 in the following steps.

S4001, in response to a command input from the user, displaying a setting menu and guidance information.

The user can input a command through the control device 100 or the gamepad 600, where the a command indicates entering the setting menu. The display apparatus 200 also displays guidance information after entering the setting menu. The guidance information can be used to guide the user to enter the key setting page based on a specified method. The specified method can include long pressing a “button” for a preset time duration.

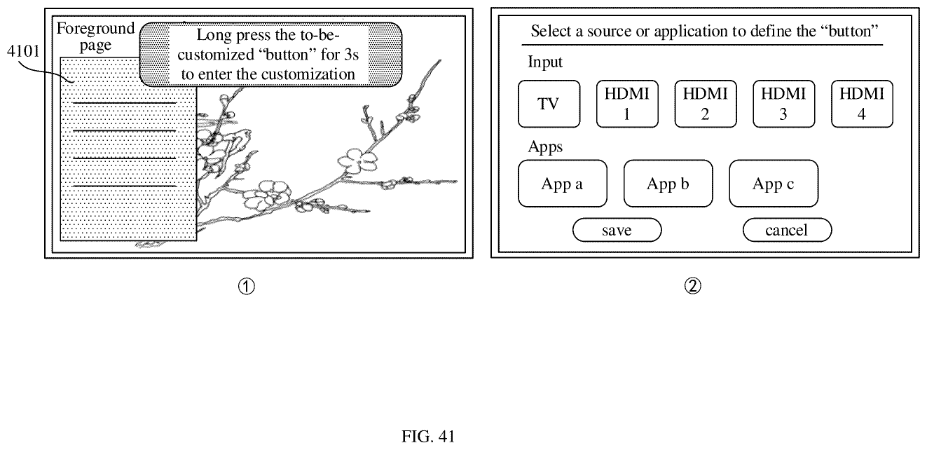

The setting menu can include an entrance to the key setting page. Reference can be made to the foreground page shown as \textcircled{1} in FIG. 41, in which the foreground page can be a game page and a non-game page. In response to the a command, the display apparatus 200 displays the setting menu 4101, and displays a prompt message, such as “long press the to-be-customized button” for 3 s to enter the customization”.

S4002, after receiving the key value of other key that has been pressed for a preset time duration, displaying the key setting page. The key setting page can include objects available to define the function of other key.

The display apparatus 200, after receiving the key value of the other key, can recognize whether the key value is raw data of the gamepad 600, i.e., whether it is a key value of a key on the gamepad 600. Upon determining that the key value is the key value of the key on the gamepad 600, the key setting page is displayed.

Selectable objects in the key setting page can include icons of the signal source input and/or the application. As shown in \textcircled{2} in FIG. 41, the display apparatus 200 displays the key setting page after receiving the key value of the key A that is long pressed for a time duration of 3 s. The key setting page can include options for Inputs, such as TV, HDMI1, HDMI2, HDMI3, HDMI4, and can also include options for Apps, such as application a, application b, and application c. The key setting page can also include an option “save” and an option “cancel”. The key setting page can also include guides that direct the user on how to establish mapping, such as “Select a source or application to define the button.

S4003, in response to a selection command entered from the user based on the target object, adding a mapping relationship between the key value of other key and the preset key value corresponding to the target object to the preset key mapping table.

The user can control the control device 100 or the gamepad 600 to move the focus to the target object and enter a selection command, and move to the option “save” to enter a confirmation command to indicate the mapping of the other key to that target object. The display apparatus 200 can add the mapping of the key value of that other key to the preset key value corresponding to that target object to the key value mapping table. The preset key value corresponding to the target object corresponds to the key on the control device 100, and the corresponding operation in the key value mapping table goes to that target object. Thus, the customization of the button” is completed.

In this way, after the display apparatus 200 receives the key value of the other key again, it can be mapped to the preset key value of the target object based on the updated key value mapping table, and further mapped to the operation into the target object.

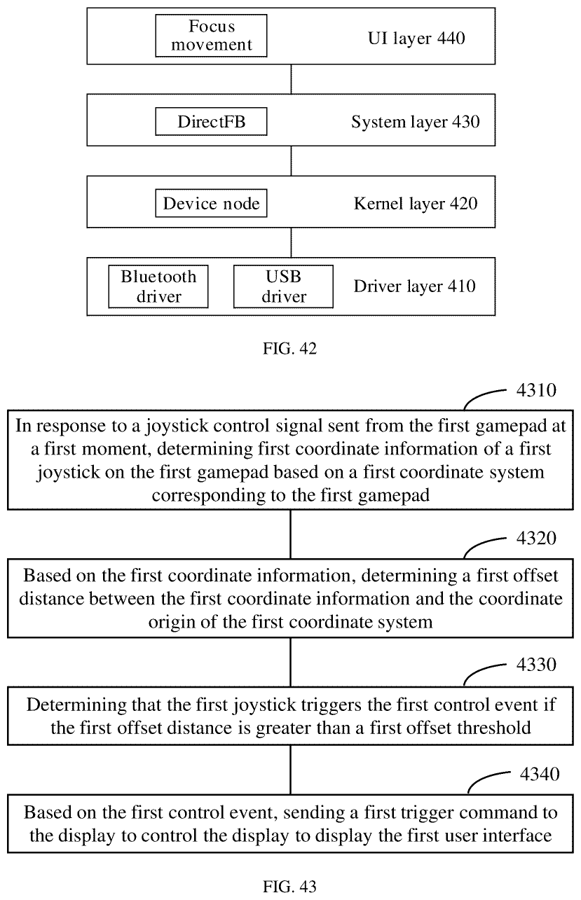

FIG. 42 is a schematic diagram of a system framework of a television according to some embodiments of the present disclosure. As shown in FIG. 42, the system of the television can include a driver layer 4210, a kernel layer 4220, a system layer 4230, and a UI layer 4240.

In some examples, the driver layer 4210 can include a plurality of driver modules, such as a Bluetooth driver module, a USB driver module, and a WIFI driver module. The driver modules can provide different driver supports for the gamepad. For example, the gamepad can access the television by way of Bluetooth, USB, LAN, WLAN, or other networks.

In some examples, the kernel layer 4220 can be used to write information about the accessed gamepad, such as device attributes of the gamepad, a number of the gamepad, and the like, to a corresponding device node. For example, when the gamepad is newly connected with the television, the kernel layer 4220 can number the newly accessed gamepad and establish its corresponding device node, and correspond the device node of the gamepad to the number of the gamepad, facilitating subsequent independent control for the television by each gamepad.

In some examples, the system layer 4330 can read control signals, including control signals sent from joysticks, arrow keys, and other keys, etc., sent from different gamepads from the device nodes via a module such as DirectFB, and convert the control signals into corresponding key signals to be sent to the UI layer 4440. The UI layer 4440, in response to the control signals of the gamepads sent from the system layer 4330, can respond in turn, and display the corresponding focus movement.

The display method according to the embodiments of the present disclosure is described in detail below in combination with the accompanying drawings. For example, the display method can be realized by at least one processor 250 in the display apparatus 200, such as a television.

FIG. 43 is a schematic diagram of a display method according to embodiments of the present disclosure. As shown in FIG. 43, the display method can include steps 4310 to steps 4340 as shown below.

At step 4310, in response to a joystick control signal sent from the first gamepad at a first moment, determining first coordinate information of a first joystick on the first gamepad based on a first coordinate system corresponding to the first gamepad.

In some examples, a single gamepad or a plurality of gamepads can be accessed in the television. The brands and models of the gamepads accessed in the display apparatus 200 can be the same or different. The first gamepad is any one of the gamepads accessed in the television, which is not limited in the embodiments of the present disclosure.

Exemplarily, the gamepad can include a joystick, and the joystick can be moved in different directions within its movement range. When the joystick is moved, a corresponding joystick control signal can be sent to the at least one processor, and the at least one processor can determine, based on the joystick control signal, whether the gamepad triggers a control event.

In some examples, the gamepad triggering a control event can be used to indicate whether the joystick control signal sent from the gamepad is capable of being converted into a key control event, such as a direction control event, that is, whether the joystick control signal is capable of realizing control for the television. If the joystick control signal is able to realize the control for the television, it can mean that the joystick control signal can trigger the control event; and if the joystick control signal is not able to realize the control for the television, it can mean that the joystick control signal does not trigger the control event.

For example, at least one joystick (e.g., one or more) can be included on the gamepad. For example, a first joystick is included on the first gamepad, where the first joystick can be any of the joysticks on the first gamepad.

In some examples, when recognizing a first gamepad is newly accessed to the television, the first gamepad can be configured with a device node. For example, if the first gamepad is a 3rd input device accessed to the television, the first gamepad corresponds to a device node 3.

In some examples, the first gamepad can be numbered. The number of the gamepad can be determined based on the number of gamepads accessed in the television. For example, when the first gamepad is a first gamepad accessed, the number of the first gamepad can be log_id 0. A correspondence can be established between the device node corresponding to the first gamepad and the number of the gamepad, e.g., a correspondence can be established between the device node 3 and log_id 0.

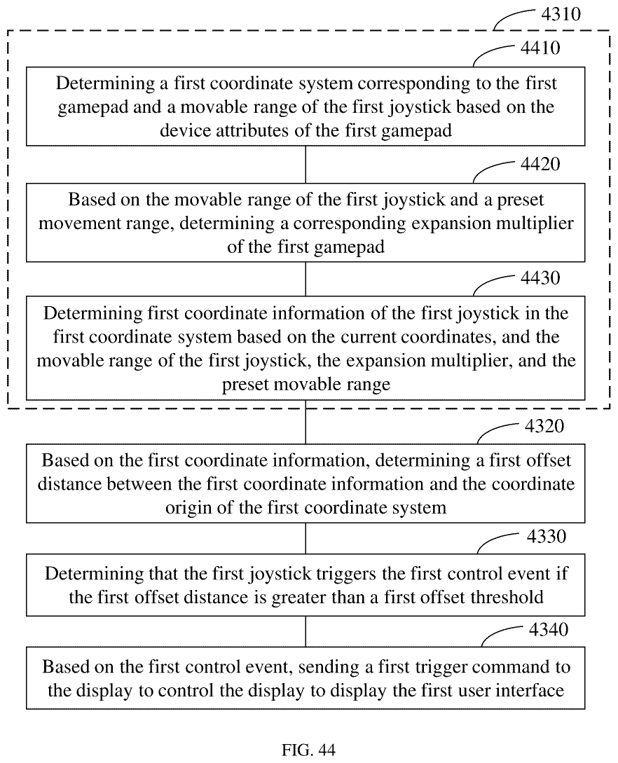

FIG. 44 is a schematic diagram of another display method according to embodiments of the present disclosure. The process of determining the first coordinate information of the first joystick is described below in combination with FIG. 44. As shown in FIG. 44, the above step 4310 can include steps 4410 to steps 4430 as shown below.

At step 4410, determining a first coordinate system corresponding to the first gamepad and a movable range of the first joystick based on the device attributes of the first gamepad.

For example, upon receiving the joystick control signal sent from the first joystick on the first gamepad, the device attributes of the first gamepad can be obtained, and the first coordinate system corresponding to the first gamepad and the movable range of the first joystick can be determined based on the device attributes of the first gamepad. The coordinate system and the movable range corresponding to each gamepad can be stored in the at least one processor.

Exemplarily, when the plurality of gamepads are accessed in the television, different coordinate systems can be configured separately for the gamepads, thereby facilitating the realization of independent control for the television by each gamepad.

For example, the first gamepad corresponds to the first coordinate system and the second gamepad corresponds to the second coordinate system. The at least one processor, upon receiving the joystick control signals sent from the different gamepads, can determine the coordinate information of the respective joysticks according to the respective corresponding coordinate systems.

In some examples, the joysticks on the respective gamepads correspond to having movable ranges, and the movable range of the joysticks on the gamepads of different brands or models can be different. For example, the movable range of the joystick on the gamepad can be [−256, 255] or [0, 255]; or, can be [0, 65535] or [−32768, 32767]. The movable range of the joystick can also be referred to as the coordinate range of the joystick.

At step 4420, based on the movable range of the first joystick and a preset movement range, determining a corresponding expansion multiplier of the first gamepad.

For ease of calculation, the movable range of the joystick on different gamepads can be unified, i.e., the movable range [min, max] of the joystick of each different gamepad is unified to the preset movement range [Min, Max], e.g., the preset movement range can be [−32768, 32767], where Min=−32768 and Max=32767.

Exemplarily, a preset maximum diameter (e.g., D) and a preset movement radius (e.g., R) of the joystick can be determined based on the preset movable range (e.g., [−32768, 32767]). For example, the preset maximum diameter D of the joystick movement is D=Max−Min, i.e., the preset maximum diameter D=65535. the preset movement radius R of the joystick movement is the maximum of an absolute value of Max and an absolute value of Min in the preset movement range. For example, in the preset movement range [−32768, 32767], the preset movement radius R of the joystick movement is R=32768.

In some examples, if the obtained movable range of the first joystick is [min, max], a maximum diameter d of the first joystick can be calculated based on the movable range; where d=max−min.

Exemplarily, based on the preset maximum diameter D and the maximum diameter d of the first joystick, an expansion multiplier t of the first gamepad is determined. For example, the expansion multiplier t is equal to the preset maximum diameter D/the maximum diameter d of the first joystick, that is, t=65535/d.

At step 4430, determining first coordinate information of the first joystick in the first coordinate system based on the current coordinates, and the movable range of the first joystick, the expansion multiplier, and the preset movable range.

In some examples, if the current coordinates (i.e., the coordinate value corresponding to the current position) of the first joystick are (x, y), the current coordinates can be expanded by a factor of t to obtain the expanded coordinates as (x*t, y*t).

Exemplarily, the first coordinate information can be determined based on a magnitude relationship between min and 0 in the movable range [min, max] of the first joystick. The first coordinate information can include a first coordinate value, which can also be referred to hereinafter as the first coordinates.

In some examples, when min=0, it can mean that the current origin of the first joystick is not a coordinate origin, in which case the first coordinates are obtained by subtracting a preset movement radius R from the expanded coordinates (x*t, y*t), i.e., the first coordinates are: (x*t−R, y*t−R).

In some examples, when min<0, it can mean that the current origin of the first joystick is the coordinate origin, in which case the first coordinates are the expanded coordinate value (x*t, y*t).

In other words, after the conversion from step 4410 to step 4430 above, the current coordinates of the first joystick on the first gamepad can be converted to a coordinate value in a circle with (0, 0) as the origin and R as the radius.

At step 4320, based on the first coordinate information, determining a first offset distance between the first coordinate information and the coordinate origin of the first coordinate system.

For example, when the first joystick on the first gamepad moves, the device node corresponding to the first gamepad can send the current coordinates of the first joystick, convert the current coordinates of the first joystick to the first coordinates by step 4310 (including step 4410 to step 4430), and update the coordinate value of the first gamepad. For example, when the gamepad log_id 0 moves, the coordinates of the gamepad log_id 0 in an array can be updated to the first coordinates.

Exemplarily, based on the first coordinate information, it can be determined whether the first joystick triggers a control event. For example, when the first coordinates of the first joystick are (x, y), it can be determined whether the first joystick triggers the control event based on a first offset distance between the first coordinates (x, y) and the coordinates (0, 0) of the origin of the first coordinate system.

In some examples, the first offset distance can be determined by a distance between two points. For example, the first offset distance can be determined by the formula (1) shown below.

$$z = \sqrt{{x}^{2} + {y}^{2}} . \qquad Formula ( 1 )$$

Where x is a horizontal coordinate in the first coordinates, y is a vertical coordinate in the first coordinates, and z is the first offset distance between the first coordinates and the coordinate origin.

At step 4330, determining that the first joystick triggers the first control event if the first offset distance is greater than a first offset threshold.

In some embodiments, the control events triggered by the joystick can include an up event, a down event, a right event, and a left event. That is, the joystick control signals triggered by the joystick can be converted to an up event, a down event, a right event, or a left event, respectively.

Exemplarily, the first offset threshold (e.g., Mt) can be a movement threshold of the joystick on the gamepad, and when the movement range of the joystick exceeds the movement threshold, it can mean that the joystick triggered the control event; and when the movement range of the joystick does not exceed the movement threshold, it can mean that the joystick did not trigger the control event.

In some examples, the first offset threshold Mt can be less than the preset movement radius R of the joystick. For example, the first offset threshold Mt can be 0.7 multiplied by the preset movement radius R. That is, when the offset distance of the joystick exceeds 70% of the preset movement radius R, it is determined that the joystick triggered the control event.

Exemplarily, it can be determined whether the first joystick triggers the first control event based on a magnitude relationship between the first offset distance z and the first offset threshold Mt.

In some examples, if z>Mt, it can mean that the first offset distance of the first joystick exceeds the first offset threshold, i.e., the first joystick is currently located outside the circle with a radius of Mt, the first joystick triggers the first control event; if z≤Mt, it can mean that the first offset distance of the first joystick does not exceed the first offset threshold, i.e., the first joystick is currently located inside the circle with the radius of Mt, the first joystick does not trigger the control event.

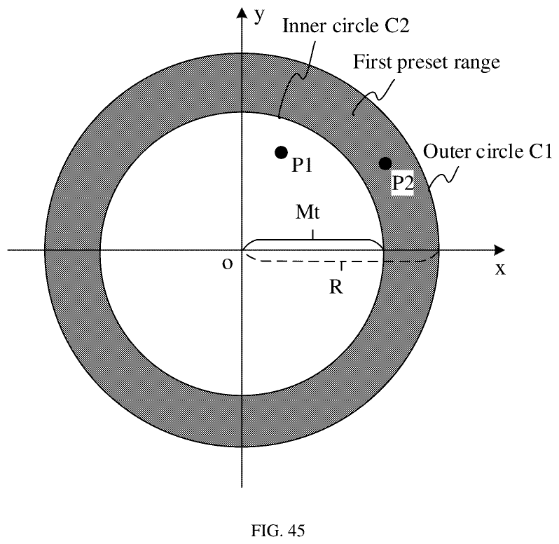

FIG. 45 is a schematic diagram of a first coordinate system according to some embodiments of the present disclosure. As shown in FIG. 45, in the first coordinate system x-o-y, a radius of an outer circle C1 is a preset movement radius R, a radius of an inner circle C2 is a first offset threshold Mt, and the first joystick can move within the outer circle C1.

As shown in FIG. 45, when the coordinates of the first joystick are within the inner circle C2, such as when the coordinates of the first joystick are P1 (x1, y1), the first joystick does not trigger the control event because P1 is within the inner circle C2. When the first joystick moves to the first preset range between the inner circle C2 and the outer circle C1, such as when the coordinates of the first joystick are P2 (x2, y2), since P2 is outside the inner circle, the first joystick triggers the control event.

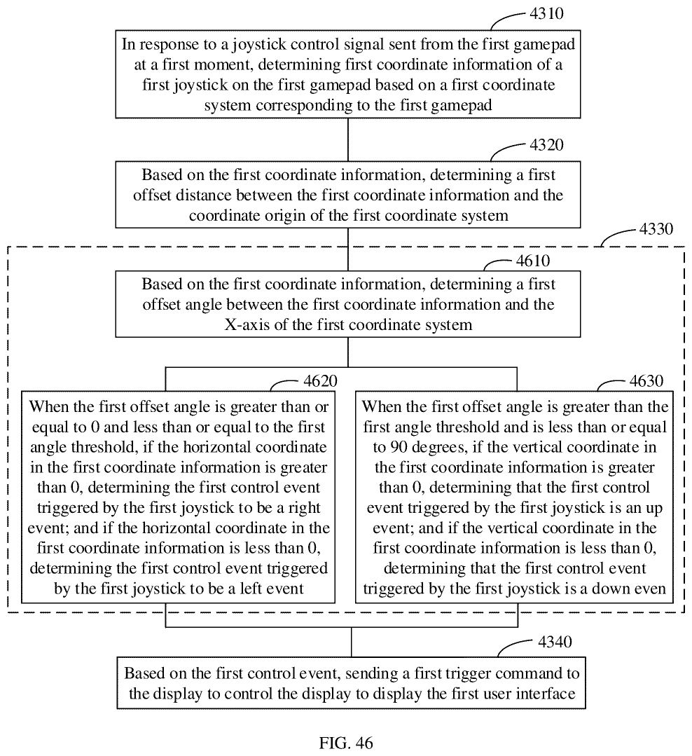

FIG. 46 is a schematic diagram of another display method according to the present disclosure. As shown in FIG. 46, the above step 4330 can include steps 4610 to 4630 as shown below. The specific determination process of the first control event in the case where the first offset distance is greater than the first offset threshold is described below in combination with FIG. 46.

At step 4610, based on the first coordinate information, determining a first offset angle between the first coordinate information and the X-axis of the first coordinate system.

In some examples, the first offset angle between the first coordinate information of the first joystick and the X-axis can be an angle between a line connected the first coordinates (x, y) with the coordinate origin (0, 0) and the X-axis.

In some examples, the first offset angle can be determined from the first coordinates and an inverse tangent trigonometric function. For example, the first offset angle between the first coordinates and the X-axis can be determined by the following formula (2):

$$α = arctan \frac{\vert y \vert}{\vert x \vert} . \qquad Formula ( 2 )$$

Where x is a horizontal coordinate in the first coordinates, y is a vertical coordinate in the first coordinates, and α is the first offset angle between the first coordinates and the X-axis in the first coordinate system. Since α is an arctangent of the absolute value of x to the absolute value of y, the first offset angle α is greater than or equal to 0.

Exemplarily, the movement range of the joystick can be divided into a plurality of regions, and when the joystick is moved to different regions, the corresponding control events are different. For example, the regions can be divided according to the first angle threshold. For example, the first angle threshold can be 45 degrees.

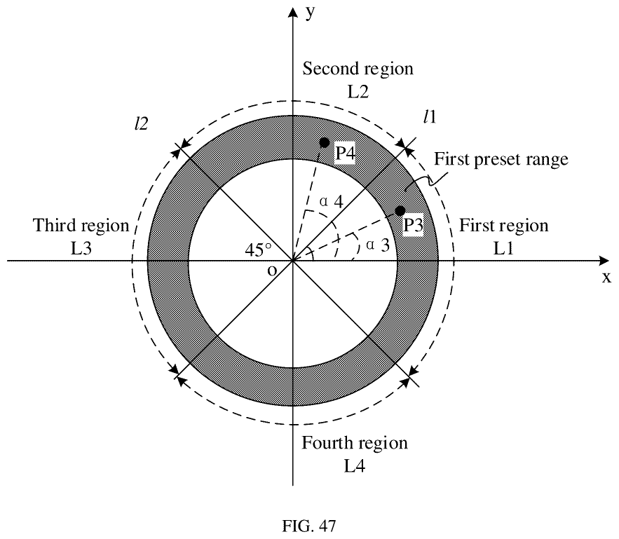

FIG. 47 is a schematic diagram of another first coordinate system according to some embodiments of the present disclosure. As shown in FIG. 47, in the first coordinate system x-o-y, an angle between the straight line l1 and the x-axis and an angle between the straight line l2 and the x-axis are the first angle threshold, such as 45 degrees.

As shown in FIG. 47, the two straight lines l1 and l2 divide the movable range of the first joystick into four portions, respectively, and the overlapping regions between these four portions and the first preset range can be a first region L1, a second region L2, a third region L3, and a fourth region L4, respectively.

In some examples, a type of the first control event can be determined based on the region to which the first coordinates of the first joystick belong, for example, the first control event is determined to be a right event, an up event, a left event, or a down event based on the region within which the first coordinates fall.

As shown in FIG. 47, when the first coordinates are located in the first region L1, the first control event can be determined as a right even; when the first coordinates are located in a second region L2, the first control event can be determined as an up event; when the first coordinates are located in a third region L3, the first control event can be determined as a left event; and when the first coordinates are located within the fourth region L4, the first control event can be identified as a down event.

In some examples, when the coordinates of the joystick of the gamepad at different moments are located within the same one region, it can mean that the control events triggered by the gamepad are the same, and when the coordinates of the joystick at different moments are located in different regions, it can mean that the control events triggered by the gamepad are different, i.e., the gamepad can perform a switching of the control event.

At step 4620, when the first offset angle is greater than or equal to 0 and less than or equal to the first angle threshold, if the horizontal coordinate in the first coordinate information is greater than 0, determining the first control event triggered by the first joystick to be a right event; and if the horizontal coordinate in the first coordinate information is less than 0, determining the first control event triggered by the first joystick to be a left event.

In some examples, when the first offset angle is greater than or equal to 0 and less than or equal to the first angle threshold, it can mean that the first coordinates are located in the first region L1 or the third region L3, i.e., the first joystick can trigger the right event or the left event. In this case, the first control event can continue to be determined based on the magnitude relationship between the horizontal coordinate of the first coordinates and 0.

For example, when the value of the horizontal coordinate of the first coordinates is greater than 0, it can mean that the first coordinates are located in the first region L1, i.e., the first control event is a right event; and when the value of the horizontal coordinate of the first coordinates is less than 0, it can mean that the first coordinates are located in the third region L3, i.e., the first control event is a left event.

Continuing to refer to FIG. 47, when the first coordinates are P3 (x3, y3), it is determined that the first joystick of the first gamepad triggers the right event because the first offset angle α3 between the third coordinates and the coordinate origin is less than 45 degrees and x3 is greater than 0.

At step 4630, when the first offset angle is greater than the first angle threshold and is less than or equal to 90 degrees, if the vertical coordinate in the first coordinate information is greater than 0, determining that the first control event triggered by the first joystick is an up event; and if the vertical coordinate in the first coordinate information is less than 0, determining that the first control event triggered by the first joystick is a down event.

In some examples, when the first offset angle is greater than or equal to the first angle threshold and less than or equal to 90 degrees, it can mean that the first coordinates are located in the second region L2 or the fourth region L4, i.e., the first joystick can trigger an up event or a down event. In this case, the first control event can continue to be determined based on the magnitude relationship between the vertical coordinate of the first coordinates and 0.

For example, when the value of the vertical coordinate of the first coordinates is greater than 0, it can mean that the first coordinates are located in the second region L2, i.e., the first control event is an up event; and when the value of the vertical coordinate of the first coordinates is less than 0, it can mean that the first coordinates are located in the fourth region L4, i.e., the first control event is a down event.

Continuing to refer to FIG. 47, when the first coordinates are P4 (x4, y4), since the first offset angle α4 between the third coordinates and the coordinate origin o is greater than 45 degrees and y4 is greater than 0, it can be determined that the first joystick triggers the up event.

At step 4340, based on the first control event, sending a first trigger command to the display to control the display to display the first user interface.

For example, after determining the first control event triggered by the first joystick, a first trigger command can be sent to the display, and the first trigger command can be used to indicate the display to display the first user interface corresponding to the first control event. For example, when the first control event is an up event, the focus on the first user interface displayed by the display can move upward.

The display apparatus provided in the embodiment of the present disclosure can determine first coordinate information of the first joystick on the first gamepad by responding to the joystick control signal sent from the first gamepad coupled thereto at a first moment and based on the first coordinate system corresponding to the first gamepad; then determine, based on the first coordinate information, the first offset distance between the first coordinate information and the coordinate origin of the first coordinate system; when the first offset distance is greater than the first offset threshold, determine that the first joystick triggers the first control event; and based on the first control event, send the first trigger command to the display to control the display to display the first user interface. The control for the television by any gamepad can be realized by the embodiments of the present disclosure. Meanwhile, when the plurality of gamepads simultaneously control the television, the controls of the gamepads does not affect each other, and independent control for the television can be separately realized, which facilitates the user operation and improves the user experience.

In some embodiments, in response to the joystick control signal sent from the second gamepad at the second moment, based on the second coordinate system corresponding to the second gamepad, second coordinate information of the second joystick on the second gamepad is determined; if it is determined that the second joystick triggers the second control event based on the second coordinate information, the second trigger command is sent to the display; and if the second moment is a moment after the first moment, after control the display to display the first user interface, a second user interface corresponding to the second trigger command is displayed.

In some examples, the second gamepad is any one of the plurality of gamepads accessed to the television that is different from the first gamepad. The second gamepad can include a second joystick, the second joystick being any one of at least one joystick on the second gamepad, which is not limited by the embodiments of the present disclosure.

In some examples, the second gamepad corresponds to a second coordinate system. The second coordinate system and the first coordinate system can be the same or different. For example, the second coordinate system corresponding to the second gamepad can be determined based on the acquired device attributes of the second gamepad.

It should be noted that the process of determining the second coordinate information of the second joystick based on the joystick control signal sent from the second gamepad and the second coordinate system is similar to the process of determining the first coordinate information in the above step 4310, and is not repeated herein to avoid repetition.

In some examples, after obtaining the second coordinate information, whether the second joystick triggers the second control event can be determined based on the second coordinate information. The process of determining the second control event is similar to the above steps 4320 to 4330, where, in the process of determining the second control event, an offset threshold corresponding to the second gamepad can be the same as or different from the first offset threshold, and an angle threshold corresponding to the second gamepad can be the same as or different from the first angle threshold, which is not be limited in the embodiments of the present disclosure.

Exemplarily, the at least one processor can add the first trigger command corresponding to the first control event triggered by the first gamepad and the second trigger command corresponding to the second control event triggered by the second gamepad to a control queue, and, in the control queue, send the respective trigger commands to the display based on the principle of first-in-first-out, so as to make the display to display the user interfaces sequentially in order.

In some examples, when the first moment is a moment before the second moment, the first control event is triggered earlier than the second control event, i.e., the first trigger command corresponding to the first control event is prioritized to enter the queue. In this case, the display can prioritize displaying the first user interface corresponding to the first control event, and after completing the display of the first user interface, then display the second user interface corresponding to the second control event.

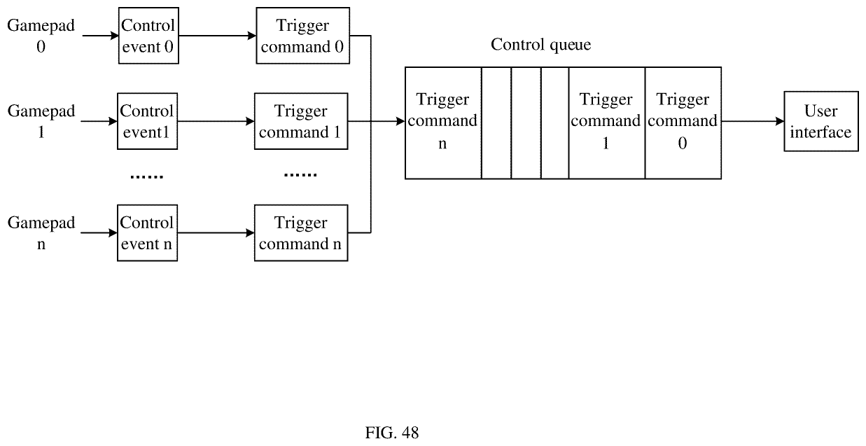

FIG. 48 is a schematic diagram of a plurality of gamepads for sending trigger commands according to some embodiments of the present disclosure. As shown in FIG. 48, n gamepads are accessed in the television, i.e., a gamepad 0 to a gamepad n. When the user operates the gamepads at the same time, the gamepads can trigger a control event 0 to a control event n respectively, thereby generating corresponding trigger command 0 to trigger command n. The n trigger commands are entered into a control queue based on the order in which the control events are triggered, with the one that is triggered first entering first. The at least one processor can control the display to sequentially display the respective user interfaces based on the order of the respective trigger commands in the control queue.

In the display method according to embodiments of the present disclosure, when a plurality of gamepads simultaneously control the television, the control events triggered by the gamepads can be determined based on the coordinate systems corresponding to the gamepads respectively, and the trigger commands corresponding to the control events are add to at least one control queue, so as to control the display to sequentially display the respective user interfaces based on the order of the trigger commands in the control queue. Therefore, in the embodiment of the present disclosure, the control for the television by multiple gamepads can be realized, and the gamepads are independent of each other without interfering with each other, which further facilitates the operation of the user.

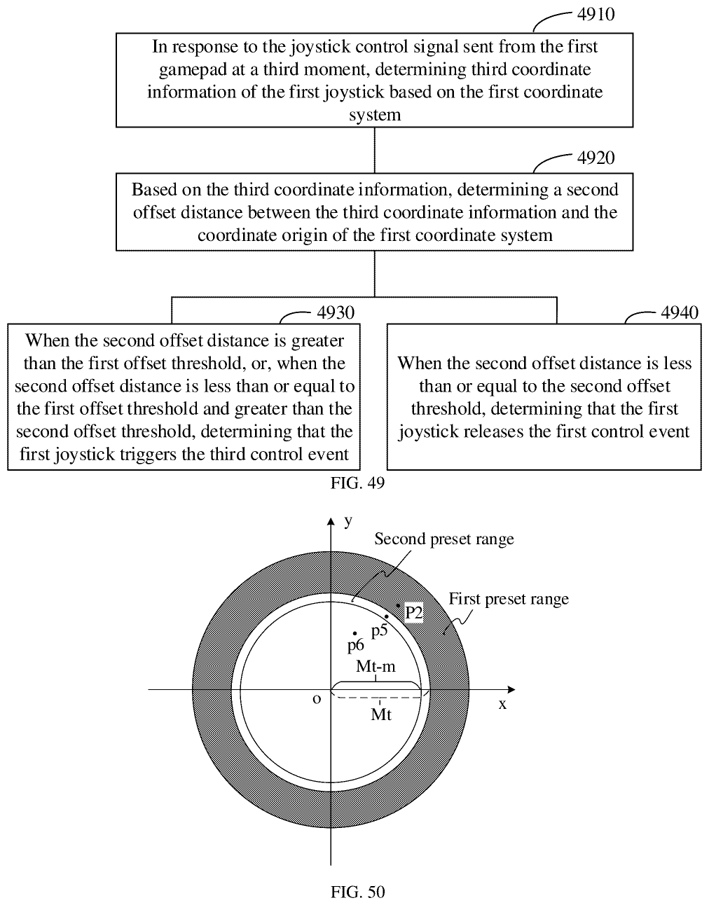

FIG. 49 is yet another display method according to some embodiments of the present disclosure. As shown in FIG. 49, the display method can further include steps 4910 to steps 4940 shown below.

At step 4910, in response to the joystick control signal sent from the first gamepad at a third moment, determining third coordinate information of the first joystick based on the first coordinate system.

At step 4920, based on the third coordinate information, determining a second offset distance between the third coordinate information and the coordinate origin of the first coordinate system.

In some examples, the first joystick can continue to move after moving to the position of the first coordinates, for example, the first joystick can move to the position of the third coordinates at a third moment after the first moment. The third moment is the next moment after the first moment.

In some examples, a joystick control signal can be sent when the first joystick reaches the position of the third coordinates at the third moment, and the at least one processor can determine the third coordinate information based on the joystick control signal, and determine a second offset distance between the third coordinate information and the coordinate origin of the first coordinate system based on the third coordinate information. The third coordinate information can include a third coordinate value, which can also be referred to hereinafter as the third coordinates.

It should be noted that step 4910 to step 4920 are similar to step 4310 (including step 4410 to step 4430) to step 4320 in the above-described embodiment, and are not repeated herein to avoid repetition.

At step 4930, when the second offset distance is greater than the first offset threshold, or, when the second offset distance is less than or equal to the first offset threshold and greater than the second offset threshold, determining that the first joystick triggers the third control event.

At step 4940, when the second offset distance is less than or equal to the second offset threshold, determining that the first joystick releases the first control event.

Exemplarily, after determining the second offset distance, whether the joystick control signal at the third moment triggers the control event can be determined based on a magnitude relationship between the second offset distance and the first offset threshold.

In some examples, when the second offset distance is larger than the first offset threshold, it can mean that the third coordinates of the first joystick are still within the first preset range, in which case it can mean that the first joystick triggers the third control event. The third control event can be the same as or different from the first control event.

For example, the third control event can continue to be further determined based on the second offset angle between the third coordinate information and the X-axis of the first coordinate system. When the third coordinates and the first coordinates are located in the same region, such as both being located in the first region L1, the third control event is the same as the first control event, and both are right events. When the third coordinates and the first coordinates are located in different regions, the third control event is different from the first control event, which is not limited in the embodiments of the present disclosure.

Exemplarily, when the second offset distance is less than the first offset threshold Mt, it can mean that the third coordinates is out of the first preset range, in which case it can mean that the first joystick releases the first control event, which can also be referred to as the first joystick triggers the release event corresponding to the first control event.

In some examples, because the joystick on the gamepad is more sensitive, when the joystick undergoes a slight jitter, the coordinates of the joystick can also change. When the offset distance of the coordinates of the joystick from the coordinate origin (0, 0) is exactly in the vicinity of the first offset threshold Mt, the coordinates of the joystick can jump back and forth between the inside and outside of the first offset threshold Mt if the joystick undergoes a slight jitter. In other words, when the joystick triggers a control event at coordinates greater than the first offset threshold Mt at a previous moment, it can release the control event at the next moment when it moves to a position less than or equal to the first offset threshold Mt and near to the position at the previous moment by jittering, so that by repeated jittering, frequently triggering and releasing of a certain control event occurs, which results in the UI responding to the certain control event continuously, thus causing the phenomenon of focus jittering.

In some embodiments, in the embodiments of the present disclosure, a second offset threshold is introduced, where the second offset threshold is less than the first offset threshold Mt. For example, a buffer m can be set, a value of m can be 0.1*Mt, and then the second offset threshold is equal to the first offset threshold Mt minus the buffer m. When a control event has already been triggered at the current moment, the only way is that the coordinate position at the next moment can move to a circle with a radius of Mt−m, then the control event is released. That is, the control event is still triggered when the coordinate position at the next moment can move to a position outside the circle with the radius of Mt−m (i.e., the overlapping region between the circle with a radius of Mt and the circle with a radius of Mt−m).

That is to say, when the second offset distance is less than or equal to the first offset threshold, it is not certain that the first joystick releases the first control event, and it is necessary to continue to determine the magnitude relationship between the second offset distance and the second offset threshold.

Exemplarily, when the second offset distance is greater than the second offset threshold, it is determined that the first joystick triggers the third control event. When the second offset distance is determined to be less than or equal to the second offset threshold, it is determined that the first joystick releases the first control event. The third control event and the first control event can be the same or different.

FIG. 50 is a schematic diagram of yet another first coordinate system according to some embodiments of the present disclosure. As shown in FIG. 50, an overlapping region (i.e., a buffer) between a circle with a radius of the first offset threshold Mt and a circle with a radius of the second offset threshold Mt−m is a second preset range.

As shown in FIG. 50, when the first joystick is moved from the first coordinates P2 to the third coordinates P5 (x5, y5), since P5 is located in the second preset range, the first joystick triggers a third control event, which can be the same as the first control event. When the first joystick is moved from the first coordinates P2 to the third coordinates P6 (x6, y6), the first joystick releases the first control event since P6 is located outside the second preset range.

In some examples, when it is determined that the first gamepad triggers the third control event, a trigger command (which can also be referred as a press command) corresponding to the third control event can be sent to the display to control the display to display the user interface corresponding to the trigger command, i.e., the movement of the focus. When it is determined that the first gamepad has released the first control event, a release command corresponding to the first control event can also be sent to the display to control the display to display the user interface corresponding to the release command, i.e., the movement of the focus stops.

In the display method according to the embodiments of the present disclosure, by setting the second offset threshold (i.e., the buffer), the problem of focus jitter caused by continuous responses of the UI due to continuous triggering and releasing of the same control event because of situations such as slight jittering of the joystick on the gamepad can be avoided, and the user experience can be further improved.

In some examples, because the joystick on the gamepad is more sensitive and has a very short up-throw interval, when the coordinates of the joystick are located in the vicinity of a boundary line in two directions, such as in the vicinity of the boundary line l1 or l2 of the two regions in FIG. 47, if the joystick undergoes a slight jitter, the offset angle α calculated based on the coordinates can hover up or down at 45 degrees. For example, an offset angle of the coordinates at a previous moment is greater than 45 degrees, and an offset angle of the coordinates at a next moment is less than 45 degrees. Since the coordinates of the joystick switch back and forth on the boundary line, the control events in both directions are sent very frequently, the focus on the UI will move very fast, bringing a bad experience to the user.

In some embodiments of the present disclosure, a second angle threshold is introduced, the second angle threshold being smaller than the first angle threshold. For example, a preset buffer angle γ can be set. When the current coordinates of the joystick are located in a direction region, if a control event in another direction is to be triggered, the range in which the joystick needs to be moved is to be expanded by a certain angle (i.e., the preset buffer angle γ) over the original region before the switching of direction is performed.

Exemplarily, when the first joystick of the first gamepad triggers the first control event at the first moment and moves to the third coordinates at the third moment, the third control event can be determined based on the first control event and the angle between the third coordinate information and the X-axis.

In some embodiments, a second offset angle between the third coordinate information and the X-axis of the first coordinate system is determined based on the third coordinate information.

In some embodiments, if the first control event is a right event or a left event, the third control event is determined to be the same as the first control event when the second offset angle is less than or equal to the second angle threshold. When the second offset angle is greater than the second angle threshold, if the vertical coordinate in the third coordinate information is greater than 0, the third control event is determined to be an up event; and if the vertical coordinate in the third coordinate information is less than 0, the third control event is determined to be a down event.

Exemplarily, the second angle threshold is greater than the first angle threshold, and the second angle threshold is a sum of the first angle threshold and the preset buffer angle γ. For example, the preset buffer angle γ can be a smaller angle, such as 5 degrees. That is, the second angle threshold is equal to the first angle threshold (e.g., 45 degrees) plus the preset buffer angle γ (e.g., 5 degrees).

In some examples, if the first control event is a right event or a left event, it can mean that the first joystick is located in the first region L1 or the third region L3 at the first moment, in this case, the third control event is determined based on the magnitude relationship between the second angle threshold and the second offset angle between the third coordinates of the first joystick and the X-axis at the third moment.

In some examples, when the second offset angle is smaller than the second angle threshold, i.e., α<45+γ, it can mean that the current position of the first joystick is within the updated first region L1 or the updated third region L3, in this case, it can mean that the third control event is not switched, i.e., the third control event is the same as the first control event. When the first control event is a right event, the third control event remains a right event and the first trigger command is sent again to instruct the focus on the UI to move to the right again.

In some examples, when the second offset angle is greater than or equal to the second angle threshold, i.e., α≥45+γ, it can mean that the current position of the first joystick is outside the updated first region L1 or the updated third region L3, i.e., the third control event can be an up event or a down event. In this case, the third control event can be further determined based on the magnitude relationship between the vertical coordinate in the third coordinate information and 0. For example, if the vertical coordinate in the third coordinate information is greater than 0, the third control event is determined to be an up event; and if the vertical coordinate in the third coordinate information is less than 0, the third control event is determined to be a down event.

In some embodiments, if the first control event is an up event or a down event, the third control event is determined to be the same as the first control event if the second offset angle is greater than the third angle threshold. When the second offset angle is less than or equal to the third angle threshold, the third control event is determined to be a right event if the horizontal coordinate in the third coordinate information is greater than 0, and the third control event is determined to be a left event if the horizontal coordinate in the third coordinate information is less than 0.

Exemplarily, the third angle threshold is less than the first angle threshold, and the third angle threshold is the difference between the first angle threshold and the preset buffer angle γ. For example, the third angle threshold is equal to the first angle threshold (e.g., 45 degrees) minus the preset buffer angle γ (e.g., 5 degrees).

In some examples, if the first control event is an up event or a down event, it can mean that the first joystick is located in the second region L2 or the fourth region L4 at the first moment, in this case, the third control event is determined based on the magnitude relationship between the third angle threshold and the second offset angle between the third coordinates and the X-axis of the first joystick at the third moment.

In some examples, when the second offset angle is greater than the third angle threshold, i.e., α>45−γ, it can mean that the current position of the first joystick is within the updated second region L2 or the updated fourth region L4, in which case, it can mean that the third control event is not switched, i.e., the third control event is the same as the first control event. When the first control event is an up event, the third control event remains an up event and the first trigger command is sent again to indicate the focus on the UI to move up again.

In some examples, when the second offset angle is less than or equal to the second angle threshold, i.e., α≤45−γ, it can mean that the current position of the first joystick is outside the updated second region L2 or the updated fourth region L4, i.e., the third control event can be a right event or a left event. In this case, the third control event can be further determined based on the magnitude relationship between the horizontal coordinate in the third coordinate information and 0. For example, if the horizontal coordinate in the third coordinate information is greater than 0, the third control event is determined to be a right event; if the horizontal coordinate in the third coordinate information is less than 0, the third control event is determined to be a down event.

In the display method according to the embodiments of the present disclosure, by setting the second angle threshold (i.e., the preset buffer angle), the problem of rapid movement of the focus caused by continuous responses of the UI due to constant switching between different control events because of situations such as slight jittering of the joystick on the gamepad can be avoided, and the user experience can be further improved.

In some examples, the up-throw time interval of the control events triggered by the joystick is very short (at the millisecond level), that is, the time interval for sending the trigger commands to the display is short. If the trigger command is sent upon a movement of the joystick occurs and beyond the first offset threshold (or the second offset threshold), the focus on the user interface displayed by the display will move too fast, and the experience for the user is poor.

Exemplarily, a sending time interval can be set, for example, the sending time interval can be a first preset trigger interval. If the time interval between the control event triggered at the current moment and the control event triggered at the previous moment reaches the first preset trigger interval, the trigger command corresponding to the control event triggered at the current moment can be sent to the display, and if the time interval does not reach the first preset trigger interval, the trigger command corresponding to the control event triggered at the current moment is not sent.

In some examples, the user can realize rapid movement of the focus corresponding to the control event by long-pressing the joystick of the gamepad. That is, the repeat mechanism corresponding to the control event is triggered.

Exemplarily, two preset trigger intervals can be set, such as a first preset trigger interval and a second preset trigger interval. The first preset trigger interval (e.g., T_first) can be greater than the second preset trigger interval (e.g., T_repeat). For example, the first preset trigger interval T_first can be 300 milliseconds and the second preset trigger interval T_repeat can be less than 300 milliseconds.

In some embodiments, when the first trigger command is sent to the display, the first timing is started. If the first joystick continuously triggers the first control event during the first timing duration reaches the first preset trigger interval, the first trigger command is sent to the display again and the second timing is started. From the start of the second timing, if the first joystick continuously triggers the first control event, the first trigger command is sent to the display one at every second preset trigger interval.

Exemplarily, when it is determined that the first joystick exceeds the first offset threshold for the first time, one first trigger command can be sent and the first timing can start. During the first timing, i.e., during the process of the first timing duration reaching the first preset trigger interval, if the first joystick continuously triggers the first control event, the first trigger command is sent again at the end of the first timing and it is determined that the repeat mechanism corresponding to the first control event is entered.

In some examples, the first joystick continuously triggering the first control event can include that the first joystick continuously triggers control events, during the first timing, and the plurality of control events triggered are all the same as the first control event. For example, the control events triggered by the first joystick during the first timing are all right events.

Exemplarily, after determining to enter the repeat mechanism corresponding to the first control event, a second timing for the first time is started. If the first joystick continuously triggers the first control events during the second timing, i.e., during the second timing duration reaching the second preset trigger interval, the first trigger command is sent again when the second timing for the first time reaches the second preset trigger interval; and the second timing for the second time is started and the above process is repeated in order to realize the repeat mechanism of the first control event. That is, the at least one processor can send the first trigger command to the display at every second preset trigger interval from the start of the second timing if the first joystick continuously triggers the first control event.

In some embodiments, when the first timing has not reached the first preset trigger interval, if the first joystick releases the first control event, the first timing corresponding to the first control event is stopped and the first release command is sent to the display. If the first joystick triggers the fourth control event from the start of the second timing, the second timing corresponding to the first control event is stopped, the trigger command corresponding to the fourth control event is sent to the display, and the first timing corresponding to the fourth control event is started; where the fourth control event is different from the first control event.

Exemplarily, the first timing is stopped when the first timing has not reached the first preset trigger interval and it is determined that the first joystick releases the first control event; or, the first timing is also stopped when the first timing has not reached the first preset trigger interval and the first joystick triggers the fourth control event. The fourth control event is different from the first control event. That is, if a release control event or a switch control event occurs during the first timing, the first timing is stopped and the repeat mechanism corresponding to the first control event is exited.

Exemplarily, after starting the second timing, if the first joystick releases the first control event or the first joystick triggers the fourth control event during any of the second timings, the second timing is stopped and the repeat mechanism corresponding to the first control event is exited.

In some examples, if during the first timing or any of the second timings, the first joystick triggers a different control event (e.g., the fourth control event), the timing is stopped and the first timing for the fourth control event is started, i.e., the repeat mechanism corresponding to the fourth control event is entered.

In the display method according to embodiments of the present disclosure, continuous control for a certain control event by the gamepad can be realized by setting the first preset trigger interval and the second preset trigger interval; meanwhile, it also realizes that the control event is up-thrown based on a reasonable time interval, i.e., the focus continues to move based on the reasonable time interval, which further improves the using experience of the user.

In some embodiments, the gamepad can contain, in addition to the joystick, an arrow key(s) and a menu key (e.g., a button”).

In some examples, the arrow keys can trigger an up event, a down event, a left event, and a right event. However, when the user presses an arrow key corresponding to each direction, at least one processor can determine a corresponding event based on the key value corresponding to the arrow key. Arrow keys are similar to joysticks in that they are both provided with a repeat mechanism.

In some examples, the button” is similar to the keys on the remote control, and a key-map table corresponding to the button” is provided in the at least one processor. In the key-map table, The key values corresponding to the keys can be mapped to the key values already supported by the remote control, respectively. For example, the button may not be provided with a repeat mechanism.

In some embodiments, in response to the arrow key sending a key control signal, if the arrow key triggers a fifth control event from the start of the first timing or the start of the second timing corresponding to the first control event, the first timing or the second timing corresponding to the first control event is stopped, and a key trigger command corresponding to the fifth control event is sent to the display.

Exemplarily, when the user presses the first joystick and the arrow key at the same time on the same one gamepad (e.g., the first gamepad), the first joystick can send the joystick control signal at a first moment and enters the repeat mechanism corresponding to the first control event. If the arrow key sends the key control signal and triggers the fifth control event from the start of the first timing or the second timing corresponding to the first control event, the first timing or the second timing corresponding to the first control event is stopped, and a key trigger command corresponding to the fifth control event is sent to the display to control the display to display the user interface corresponding to the fifth event. That is, the arrow key triggering the control event can abort the repeat mechanism corresponding to the control event of the joystick.

For example, the arrow key can also trigger the repeat mechanism corresponding to the control event. For example, a timing is started from the time the arrow key is pressed, a first key trigger command is sent after T_first, and then the key trigger command is sent after every T_repeat until that arrow key is released. It should be noted that the repeat mechanism of the arrow keys is similar to that of the joystick, which will not be repeated here in order to avoid repetition.

In some examples, when the user presses the joystick and the button at the same time on the same one gamepad (e.g., the first gamepad), since the button does not use the repeat mechanism, a key value of the button is sent, the joystick can trigger a control event as well as a repeat event corresponding to the control event based on the above method.

In some examples, when the user presses the arrow key and the button at the same time on the same one gamepad (e.g., the first gamepad), similar to pressing the joystick and the button at the same time as described above, the button can send only the key value of the button, and the arrow key can trigger the control event as well as the repeat event corresponding to the control event.

In the display method according to embodiments of the present disclosure, simultaneous operations of the joystick and different keys on the same one gamepad, as well as simultaneous operation of different keys can be supported, which further facilitates the user's operation and improves the user's experience.

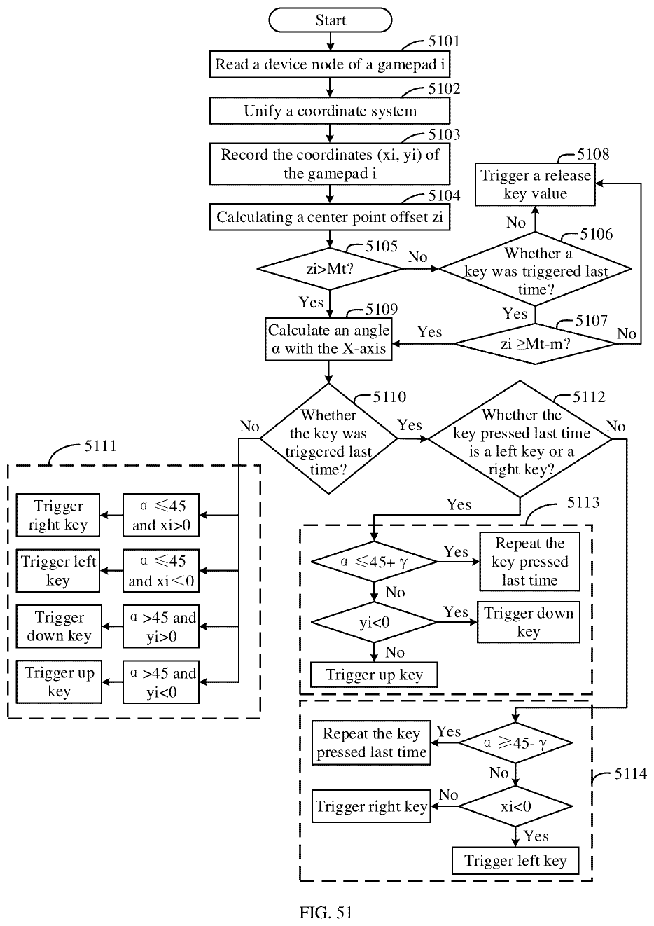

FIG. 51 is a schematic diagram of yet another display method according to some embodiments of the present disclosure. As shown in FIG. 51, the display method can include steps 5101 to steps 5114 shown below.

At step 5101, reading a device node of a gamepad.

The gamepad i is any one of a plurality of gamepads accessed in the television.

At step 5102, unifying a coordinate system.

For example, a coordinate system corresponding to the gamepad i is determined based on the device node of the gamepad i, and the current coordinates of the gamepad i are converted to the unified coordinate system.

At step 5103, recording the coordinates (xi, yi) of the gamepad.

Based on the coordinate system and the preset movement range corresponding to the gamepad i, the coordinates (xi, yi) of the gamepad i are determined.

At step 5104, calculating a center point offset zi.

For example, based on the coordinates (xi, yi) of the gamepad i and the formula for the distance between two points, the distance zi between the coordinates (xi, yi) and the coordinate origin (0, 0) is determined.

At step 5105, determining whether zi is greater than Mt.

If zi≤Mt, step 5106 is performed; and if zi>Mt, step 5109 is performed.

Mt is the first offset threshold in the above embodiments.

At step 5106, determining whether a key was triggered last time.

For example, it is determined whether the gamepad i triggered the key at a previous moment of the current moment, and the triggering key can be the gamepad i triggering the control event in the above embodiments.

If it is determined that the key was triggered last time, step 5107 is performed; and if it is determined that the key was not triggered last time, step 5108 is performed.

At step 5107, determining whether zi is greater than or equal to Mt−m.

If zi<Mt−m, step 5108 is performed; and if zi≥Mt−m, step 5109 is performed.

Mt−m is the second offset threshold in the above embodiments.

At step 5108, triggering a release key value.

Triggering the release key value can include releasing the triggered control event at the previous moment.

At step 5109, calculating an angle α with the X-axis.

For example, determining the angle α between the coordinates (xi, yi) and the X-axis.

At step 5110, determining whether the key was triggered last time.

If it is determined that the key was not triggered last time, step 5111 is performed; and if it is determined that the key was triggered last time, step 5112 is performed.

At step 5111, if α≤45 and xi>0, determining that the right key is triggered on the gamepad i; if α≤45 and xi<0, determining that the left key is triggered on the gamepad i; if α>45 and yi>0, determining that the up key is triggered on the gamepad i; and if α>45 and yi<0, determining that the down key is triggered on the gamepad i.

At step 5112, determining whether the key pressed last time is a left key or a right key.

If the key pressed last time is the left or right key, step 5113 is performed; and if the key pressed last time is not the left or right key, step 5114 is performed.

At step 5113, if α≤45+γ, determining that the key pressed last time on the gamepad i is repeated; if α>45+γ and yi<0, determining that the down key is triggered on the gamepad i; and if α>45+γ and yi>0, determining the up key is triggered on the gamepad i.

Repeating the last key on the gamepad i can be used to indicate that the key triggered on the gamepad i is the same as the key pressed last time, i.e., the left key or the right key is triggered on the gamepad i.

At step 5114, if α≥45−γ,determining that the key pressed last time on the gamepad i is repeated; and if α<45−γ and xi<0, determining that the left key is triggered on the gamepad i; and if α<45−γ and xi>0, determining that the right key is triggered on the gamepad i.

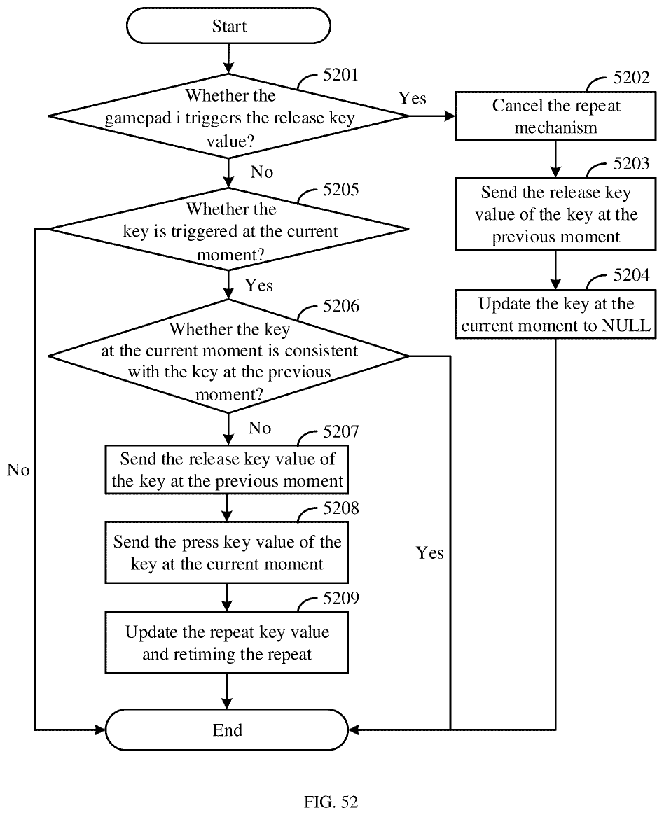

FIG. 52 is a schematic diagram of yet another display method according to embodiments of the present disclosure. As shown in FIG. 52, the display method can include steps 5201 to steps 5209 as shown below.

It should be noted that the display method shown in FIG. 52 can be complementary to the display method shown in FIG. 51, for example, step 5201 can be executed after step 5111, step 5113, or step 5114 in the above-described FIG. 51, i.e., step 5201 can be executed at one moment after the key is triggered on the gamepad i; and step 5202 can also be executed after step 5108 in the above-described FIG. 51, which will not be limited in the embodiments of the present disclosure.

At step 5201, determining whether the gamepad i triggers the release key value.

If the gamepad i triggers the release key value, step 5202 is executed; and if the release key value is not triggered on the gamepad i, step 5205 is executed.

At step 5202, canceling the repeat mechanism.

At step 5203, sending the release key value of the key at the previous moment.

At step 5204, updating the key at the current moment to NULL.

For example, if determining that the gamepad I triggers the release key value at the current moment, it can mean that the key at the previous moment is released on the gamepad i, and therefore, the key at the current moment can be updated to NULL.

At step 5205, determining whether the key is triggered at the current moment.

If the key is triggered at the current moment, step 5206 is executed, and if the key is not triggered at the current moment, it ends.

At step 5206, determining whether the key at the current moment is consistent with the key at the previous moment.

If the key at the current moment is not consistent with the key at the previous moment, step 5207 is executed; and if the key at the current moment is consistent with the key at the previous moment, it ends.

At step 5207, sending the release key value of the key at the previous moment.

At step 5208, sending the press key value of the key at the current moment.

At step 5209, updating the repeat key value and retiming the repeat.

For example, when the key triggered at the current moment on the gamepad i is inconsistent with the key triggered at the previous moment, it is necessary to send the release command, i.e., the release key value, of the previous moment; and then send the press command, i.e., the press key value, of the key at the current moment; and then enter into the repeat mechanism to start the re-timing.

It should be noted that the steps in the display methods provided in FIG. 51 and FIG. 52 have been illustrated accordingly in the above embodiments, and the effects achieved are consistent with the effects achieved by the display method in the above embodiments, so in order to avoid repetition, they will not be repeated here.

The embodiments of the present disclosure can divide the display apparatus 200 into functional modules according to the above examples in the method. For example, individual functional modules can be divided corresponding to individual functions, or two or more functions can be integrated in a single processing module. The above integrated modules can be implemented either in the form of hardware or in the form of software function modules. It should be noted that the division of the modules according to the embodiments of the present disclosure is schematic and is only a logical division of the functions, and there can be other ways of division when actually realized.

What is claimed is:

1. A display apparatus, comprising:
a display, configured to display an image or a user interface, wherein the user interface comprises an application interface and a text input interface;
a device interface, configured to be connected with an external device, wherein the external device comprises a first key which is configured to be able to switch a focus on the display and a second key which is configured to be not able to switch the focus on the display; and
at least one processor, in connection with the display and the device interface and configured to execute computer instructions to cause the display apparatus to perform:
in response to a text input command, obtaining a focus interface, wherein the focus interface is the user interface on which the focus is currently located;
based on that the focus interface is the application interface, listening to a first click event, wherein the first click event is generated by the first key of the external device;
based on that the focus interface is the application interface, obtaining a number of consecutive clicks on the first key based on the first click event;
obtaining a second click event sent from the external device based on the first click event, wherein the second click event is generated by the second key;
based on that the number of consecutive clicks is an odd number, switching the focus interface to the text input interface, controlling the text input interface to obtain the focus, generating the text data based on the second click event, and generating text data based on the second click event; and
controlling the display to show the text data on the text input interface above the application interface, and hiding the text data with a gradient effect after a preset time duration;
based on that the number of consecutive clicks is an even number, switching the focus interface to the application interface, generating application data on the application interface based on the second click event, and rendering for the application interface based on the application data.

2. The display apparatus according to claim 1, wherein the text input interface comprises a virtual keyboard pop-up window, the virtual keyboard pop-up window comprises a plurality of character keys, and the at least one processor is further configured to execute the computer instructions to cause the display apparatus to execute:
obtaining a number and order of clicks on the second key based on the second click event; and
generating the text data based on the number and order of clicks and a character correspondence relationship, wherein the character correspondence relationship is a correspondence relationship between the second key and a character key of the plurality of character keys, and the character correspondence relationship is set based on a key input rule of the external device.

3. The display apparatus according to claim 2, wherein the virtual keyboard pop-up window comprises a character focus, and the second key comprises arrow keys and selected keys, and the at least one processor is further configured to execute the computer instructions to cause the display apparatus to execute:
moving the character focus based on a number of clicks on the arrow key;
obtaining character data corresponding to the character focus based on a number of clicks on the selected key and the order of clicks; and
generating the text data based on the character data.

4. The display apparatus according to claim 3, wherein the virtual keyboard pop-up window further comprises a sending character, and the at least one processor is further configured to execute the computer instructions to cause the display apparatus to execute:
listening to a sending event of the virtual keyboard pop-up window, wherein the sending event is generated by a selected key when the character focus is on the sending character;
in response to the sending event, rendering the application interface based on the text data; and
controlling the display to display the application interface.

5. The display apparatus according to claim 4, wherein the at least one processor is further configured to execute the computer instructions to cause the display apparatus to execute:
controlling the display to hide the virtual keyboard pop-up window;
generating a focus switching task based on the text data;
in response to the focus switching task, controlling the application interface to obtain the focus;
generating application data based on the second click event; and
controlling the display to display the application data on the application interface.

6. The display apparatus according to claim 1, wherein the at least one processor is further configured to execute the computer instructions to cause the display apparatus to execute:
perform a zoom-in operation or a zoom-out operation on the text input interface according to the text data.

7. The display apparatus according to claim 2, wherein the at least one processor is further configured to execute the computer instructions to cause the display apparatus to execute:
obtaining a display state of the virtual keyboard pop-up window, wherein the display state comprises a displayed state and a non-displayed state, and an initial state of the display state is the non-displayed state;
based on that the virtual keyboard pop-up window is displayed on the text input interface, switching the display state to the displayed state; and
in the displayed state, generating the text data based on the second click event.

8. The display apparatus according to claim 7, wherein the displayed state is that the virtual keyboard pop-up window is displayed on the text input interface, and the non-displayed state is that no virtual keyboard pop-up window is displayed on the text input interface.

9. The display apparatus according to claim 7, wherein the at least one processor is further configured to execute the computer instructions to cause the display apparatus to execute:
based on that the virtual keyboard pop-up window is hidden, switching the display state to the non-displayed state;
generating a focus switching task based on the non-displayed state;
controlling the application interface to obtain the focus based on the focus switching task; and
generating application data on the application interface based on the second click event.

10. The display apparatus according to claim 7, wherein the at least one processor is further configured to execute the computer instructions to cause the display apparatus to execute:
based on that the display state is switched to the non-displayed state, generating a pop-up variable, wherein the pop-up variable comprises a variable generation time;
listening to an application key event based on the variable generation time, wherein the application key event is the second click event a generation time of which is later than the variable generation time; and
generating application data based on the application key event.

11. A control method for a display apparatus, comprising:
in response to a text input command, obtaining a focus interface, wherein the focus interface is a user interface on which a focus is currently located, wherein the user interface is displayed on a display of a display apparatus, and the user interface comprises an application interface and a text input interface;
based on that the focus interface is the application interface, listening to a first click event, wherein the first click event is generated by a first key of an external device, the external device is connected with a device interface of the display apparatus, and the external device comprises a first key which is configured to be able to switch a focus on the display and a second key which is configured to be not able to switch the focus on the display;
based on that the focus interface is the application interface, obtaining a number of consecutive clicks on the first key based on the first click event;
obtaining a second click event sent from the external device based on the first click event, wherein the second click event is generated by the second key;
based on that the number of consecutive clicks is an odd number, switching the focus interface to the text input interface, controlling the text input interface to obtain the focus, generating the text data based on the second click event, and generating text data based on the second click event; and
controlling the display to show the text data on the text input interface above the application interface, and hiding the text data with a gradient effect after a preset time duration;
based on that the number of consecutive clicks is an even number, switching the focus interface to the application interface, generating application data on the application interface based on the second click event, and rendering for the application interface based on the application data.

12. The control method according to claim 11, further comprising:
obtaining a number and order of clicks on the second key based on the second click event; and
generating the text data based on the number and order of clicks and a character correspondence relationship, wherein the character correspondence relationship is a correspondence relationship between the second key and a character keys of a plurality of character keys, and the character correspondence relationship is set based on a key input rule of the external device;
wherein the text input interface comprises a virtual keyboard pop-up window, and the virtual keyboard pop-up window comprises a plurality of character keys.

13. The control method according to claim 12, further comprising:
moving a character focus based on a number of clicks on the arrow key;
obtaining character data corresponding to the character focus based on a number of clicks on a selected key and the order of clicks; and
generating the text data according to the character data;
wherein the virtual keyboard pop-up window comprises the character focus, and the second key comprises the arrow keys and the selected keys.

14. The control method according to claim 13, further comprising:
listening to a sending event of the virtual keyboard pop-up window, wherein the sending event is generated by the selected key when the character focus is on a sending character;
in response to the sending event, rendering the application interface based on the text data; and
controlling the display to display the application interface;
wherein the virtual keyboard pop-up window further comprises the sending character.

15. The control method according to claim 14, further comprising:
controlling the display to hide the virtual keyboard pop-up window;
generating a focus switching task based on the text data;
in response to the focus switching task, controlling the application interface to obtain the focus;
generating application data based on the second click event; and
controlling the display to display the application data on the application interface.

16. The control method according to claim 11, further comprising:
perform a zoom-in operation or a zoom-out operation on the text input interface according to the text data.

17. The control method according to claim 12, further comprising:
obtaining a display state of the virtual keyboard pop-up window, wherein the display state comprises a displayed state and a non-displayed state, and an initial state of the display state is the non-displayed state;
based on that the virtual keyboard pop-up window is displayed on the text input interface, switching the display state to the displayed state; and
in the displayed state, generating the text data based on the second click event.

18. The control method according to claim 17, wherein the displayed state is that the virtual keyboard pop-up window is displayed on the text input interface, and the non-displayed state is that no virtual keyboard pop-up window is displayed on the text input interface.

19. The control method according to claim 17, further comprising:
based on that the virtual keyboard pop-up window is hidden, switching the display state to the non-displayed state;
generating a focus switching task based on the non-displayed state;
controlling the application interface to obtain the focus based on the focus switching task; and
generating application data on the application interface based on the second click event.

20. The control method according to claim 17, further comprising:
based on that the display state is switched to the non-displayed state, generating a pop-up variable, wherein the pop-up variable comprises a variable generation time;
listening to an application key event based on the variable generation time, wherein the application key event is the second click event a generation time of which is later than the variable generation time; and
generating application data based on the application key event.
